(19) United States
(12) Patent Application Publication
(10) Pub. No.: US 2010/0061826 A1
(43) Pub. Date: Mar. 11, 2010

(54) PAPER SHEET HANDLING DEVICE AND COIL FORMING DEVICE

(75) Inventors: Toru Yoshie, Gunma (JP); Kazuhiko Kishi, Gunma (JP)

Correspondence Address: CHERNOFF, VILHAUER, MCCLUNG & STENZEL, LLP, 601 SW Second Avenue, Suite 1600, Portland, OR, 97204, US

(73) Assignee: MAX CO., LTD., Tokyo (JP)

(21) Appl. No.: 12/528,791

(22) PCT Filed: Feb. 19, 2008
(86) PCT No.: PCT/JP2008/052774

§ 371 Date: Aug. 26, 2009

(30) Foreign Application Priority Data
Feb. 28, 2007 (JP) 2007-050271
Feb. 28, 2007 (JP) 2007-050275
Feb. 28, 2007 (JP) 2007-050276

(51) Int. Cl. B42B 5/12; B21F 45/00

(52) U.S. Cl. 412/33; 140/71 C

(57) ABSTRACT

A paper-sheet-handling apparatus 100, as shown in FIG. 1, is provided with a coil-forming mechanism 20 that forms a spiral coil 11 for binding the bundle of paper-sheets from a wire rod 1 drawn out of a wire rod cartridge 10, and a binding mechanism 40 that performs the binding processing on the bundle of paper-sheets by the spiral coil 11 obtained therefrom. The coil-forming mechanism 20 is provided with a main body part 21 that includes a wire rod insert port 274 and a coil discharge port 296, a coil-forming part 28 that includes plural species of sections each like an arc of a circle for setting diameters of the coils and is rotatably attached to the main body part 21, a wire-rod-dispatching part 22 that dispatches the wire rod 1 having a predetermined thickness from the wire rod insert port 274 with it coming into contact with any one of the sections each like the arc of the circle, and a pitch-adjusting mechanism 29, which is mounted near the coil discharge port of the main body part 21, that adjusts a pitch of the spiral coil 11 formed by the selected section like the arc of the circle and dispatched from the wire-rod-dispatching part 22.

### TECHNICAL FIELD

The present invention relates to a paper-sheet-handling apparatus and a coil-forming device, which are preferably applied to an apparatus that forms a spiral coil from a wire rod having a predetermined thickness, bundles sheets of recorded paper released from a copying machine, a printing machine or the like and performs any binding processing on them by the coil. It particularly relates to the ones which are provided with a pitch-adjusting mechanism that adjusts a pitch of the spiral coil formed and dispatched by one section like an arc of a circle, which is selected from sections each like an arc of a circle for setting a diameter of the coil, near a coil discharge opening in a main body portion, whereby allowing the coil pitch of the spiral coil to be limited to a fixed pitch and enabling the spiral coil having an unchanged pitch even if the diameter of the coil alters to be formed with good reproducibility.

### BACKGROUND ART

It has often performed in recent years that punched holes are perforated on paper-sheet on which an image is formed by a copying machine for black-and-white and colors, a printing machine or the like and a coil automatically passes through the holes of a plurality of the paper-sheets (a bundle of paper-sheets) thus perforated to prepare a booklet. This is because the booklet is made well looked as compared with a case where a corner of the bundle of paper-sheets is bound by hand using a stapler or the like.

For example, when automatically passing the coil through holes in a bundle of paper-sheets, the bundle of paper-sheets is first set on a predetermined position with the positions of the holes in the bundle of paper-sheets being aligned. The spiral coil with a pitch similar to a pitch between the holes of the paper-sheet is next formed so that the formed spiral coil is dispatched toward the bundle of paper-sheets while it is rotated. A forward end of the coil is then passed through holes in an end of the bundle of paper-sheets and by rotation of the coil, the coil moves forward and passes through the remained holes in the bundle of paper-sheets.

In connection with such a manufacturing function of the spiral coil, a coil-manufacturing device is disclosed in page 4 and FIG. 1 of Japanese Patent Application Publication No. S55-33897. In this device, it is configured to have a winding mandrel and an air motor. It is configured that the air motor drives the winding mandrel that is connected direct thereto and by this driving, a wire rod is wound on a cone-like coil-winding part thereof so that a spiral coil is formed. Configuring a spiral-coil-forming device as this allows a coil-winding portion thereof to be configured compact. A conventional paper-sheet-handling apparatus like one disclosed in Japanese Patent Application Publication No. S55-33897 (page 4 and FIG. 1 thereof) has problems as follows:

(i) The spiral coil for binder is formed by winding the wire rod on the mandrel member so that a work for a user to exchange the mandrel members each time is increased if plural different diameters of the coils are provided corresponding to a thickness of the bundle of paper-sheets. According to the above-mentioned paper-sheet-handling apparatus, because the wire rod is wound on the cone-like coil-winding part of the mandrel, there is a risk of pitch change of the diameter of the coil if the spiral coils having different diameters of the coils are formed corresponding to a thickness of the bundle of paper-sheets, so that it is difficult to form the spiral coils with good reproducibility. Accordingly, when passing the spiral coil therethrough, an action must be taken by preparing mandrel members or the like that have been adjusted in their pitches conforming to their diameter of the coil, adjusting a pitch of holes in the bundle of paper-sheets and the like. In this connection, it is conceivable how to form a spring by pressing a wire rod against a molding wall for the spring, but the apparatus is apprehended so as to be large-sized, and there is a problem such that multiplicity of use in the apparatus is lost when forming spiral coils having different diameters of the coils.

(ii) For example, when performing a binding processing on the bundle of paper-sheets by the spiral coil obtained from the winding mandrel, a mechanism thereof is often split into a coil-forming part and a binding processing part and they are installed. In this case, the coil-forming part occupies the majority of space so that there is a risk of a large scale of the system itself. In this connection, when taking on a form such that a linking part is set between the coil-forming part and a coil binding part and in this linking part, positions of a feed roller of the coil-binding part and a screw guider are fixed based on a diameter of the coil, a configuration such that the mandrel member in the coil-forming part is exchanged to another each time must be adopted in order to correspond to plural diameters of the coils. Accordingly, when preparing booklets by performing an automatic binding processing on the bundles of paper-sheets each having a desired thickness with the spiral coils having different diameters of the coils, a problem is remained such that a mechanism for selecting the mandrel member automatically is made large, thereby resulting in difficulty of making the apparatus compact.

(iii). Further, when building in an image-forming system combining a coil-manufacturing device as a finisher with a copy machine, a multifunction device or the like and forming a spiral coil having a diameter of the coil corresponding to the thickness of the bundle of paper-sheets to perform an automatic binding processing, the above-mentioned problem (ii) occurs so that there is a problem such that it is difficult to make the finisher compact and reduce costs thereof. Such a problem occurs in a similar way even in a case when building in an image-forming system by configuring a coil-manufacturing device as a separated coil binder in a stand-alone manner, not connecting the coil-manufacturing device as a finisher or the like of a copy machine, a multifunction device or the like.

### DISCLOSURE OF THE INVENTION

A first paper-sheet-handling apparatus of the present invention is a paper-sheet-handling apparatus that forms a spiral coil from a wire rod having a predetermined thickness and performs a binding processing on the plural holes continuously set on a bundle of paper-sheets by the coil. The apparatus is provided with a coil-forming mechanism that forms the spiral coil for binding the bundle of paper-sheets from the wire rod drawn out of a wire-rod-supplying part, and a binding mechanism that performs the binding processing on the bundle of paper-sheets by the spiral coil obtained from the coil-forming mechanism. The coil-forming mechanism comprises a main body part that includes a wire rod insert port and a coil discharge port, a wire-rod-dispatching part that dispatches the wire rod to a predetermined direction, the wire-rod-dispatching part being attached to the main body part, a coil-forming part that includes a section like an arc of a circle for setting a diameter of the coil and forms the wire rod dispatched from the wire-rod-dispatching part into the spiral coil along the section like the arc of the circle, and a pitch-adjusting mechanism that adjusts a pitch of the spiral coil formed by the section like the arc of the circle and drawn out of the coil-discharging port, the pitch-adjusting mechanism being mounted near the coil discharge port of the main body part. It is characterized in that the wire-rod-dispatching part dispatches the wire rod having the predetermined thickness from the wire rod insert port with it coming into contact with the section like the arc of the circle.

According to the first paper-sheet-handling apparatus of the present invention, there is provided with the coil-forming device according to the invention so that when binding the bundle of paper-sheets having the predetermined thickness, the coil-forming mechanism forms, for example, the spiral coil having a diameter of the coil for binding the bundle of paper-sheets corresponding to the thickness of the paper-sheets and with a fixed pitch. On an assumption of this, the binding mechanism binds the bundle of paper-sheets with the spiral coil having the predetermined diameter of the coil and the fixed pitch, which is obtained from the coil-forming device. Accordingly, in a case or the like where punched holes on the record paper have the same pitch and the bundles of paper-sheets have different thicknesses, the spiral coils having desired diameters corresponding to the thickness thereof can be formed so that the binding processing using the spiral coil is allowed to be performed with good reproducibility. This enables the paper-sheet-handling apparatus, to which the coil-forming device having a simple configuration is applied, to be provided.

A second paper-sheet-handling apparatus of the present invention is a paper-sheet-handling apparatus that forms a spiral coil from a wire rod having a predetermined thickness and performs a binding processing on a bundle of paper-sheets by the coil. It is characterized in that the paper-sheet-handling apparatus is provided with a wire-rod-supplying part, to which the wire rod is wound, that can be mounted on the apparatus, a coil-forming mechanism that forms the wire rod drawn out of this wire-rod-supplying part into the spiral coil for binding the bundle of paper-sheets, a binding mechanism that performs the binding processing on the bundle of paper-sheets by the spiral coil obtained from the coil-forming mechanism, and a cutting part that cuts, at a predetermined position, the spiral coil for the bundle of paper-sheets on which the binding mechanism performs the binding processing.

According to the second paper-sheet-handling apparatus of the present invention, when forming the spiral coil from the wire rod having the predetermined thickness and binding the bundle of paper-sheets by the coil, the wire-rod-supplying part, on which the wire rod is wound, is mounted on the paper-sheet-handling apparatus. The coil-forming mechanism forms the wire rod drawn out of this wire-rod-supplying part into the spiral coil for binding the bundle of paper-sheets. For example, in the coil-forming mechanism, the driving part is driven so as to select one section like an arc of a circle from the plural species of the sections each like an arc of a circle. The wire-rod-dispatching part dispatches the wire rod for the coil from the wire rod insert port of the main body part to the coil-forming part selected by the driving part so that it comes into contact with the section like the arc of the circle. The pitch-adjusting mechanism, which is mounted near the coil discharge port of the main body part, adjusts a pitch of the spiral coil formed by the selected section like the arc of the circle and dispatched from the section like the arc of the circle. On an assumption of this, the binding mechanism performs the binding processing on the bundle of paper-sheets by the spiral coil obtained from the coil-forming mechanism. The cutting part is configured so as to cut, at a predetermined position, the spiral coil for the bundle of paper-sheets on which the binding mechanism performs the binding processing. Accordingly, it is possible to prepare a booklet in which the binding processing is performed on the bundle of paper-sheets have a desired thickness by the spiral coil. This enables the paper-sheet-handling apparatus to be sufficiently applied to a finisher (post-processing apparatus) which performs the binding processing on pieces of the record paper released from a copying machine for black-and-white and colors, a printing machine or the like.

A third paper-sheet-handling apparatus of the present invention is a paper-sheet-handling apparatus that forms a spiral coil from a wire rod having a predetermined thickness and performs a binding processing on the plural holes continuously set on a bundle of paper-sheets by the coil. The apparatus is provided with a coil-forming mechanism that includes plural species of sections each like an arc of a circle for setting a diameter of the coil and forms the spiral coils, a binding mechanism that performs the binding processing on the bundle of paper-sheets with the spiral coil formed by the coil-forming mechanism, a detection part that detects the bundle of paper-sheets and outputs information on the paper-sheets, and a selection mechanism that selects one section like an arc of a circle corresponding to the thickness of the bundle of paper-sheets from the plural species of the sections each like an arc of a circle for setting a diameter of the coil, based on the information on the paper-sheets output from the detection part. It is characterized in that the coil-forming mechanism pushes the wire rod into the section like an arc of a circle selected by the selection mechanism to form the spiral coil.

According to the third paper-sheet-handling apparatus of the present invention, when forming the spiral coil from the wire rod having the predetermined thickness and performing a binding processing on the plural holes continuously set on a bundle of paper-sheets by the coil, the detection part detects thickness of the bundle of paper-sheets and outputs information on the paper-sheets to the selection mechanism. The coil-forming mechanism includes plural species of the sections each like an arc of a circle for setting a diameter of the coil and forms the spiral coils. On an assumption of this, the selection mechanism selects one section like an arc of a circle corresponding to the thickness of the bundle of paper-sheets from the plural species of the sections each like an arc of a circle for setting a diameter of the coil, based on the information on the paper-sheets output from the detection part. The coil-forming mechanism pushes the wire rod into the section like an arc of a circle selected by the selection mechanism to form the spiral coil. The binding mechanism performs the binding processing on the bundle of paper-sheets with the spiral coil formed by the coil-forming mechanism. Accordingly, it is possible to perform an automatic binding processing on the bundle of paper-sheets by the spiral coil having a diameter of a coil automatically selected corresponding to the thickness of the bundle of paper-sheets. This enables it to be sufficiently applied to a post-processing apparatus which performs binding processing on pieces of the record paper distributed from a copying machine for black-and-white and colors, a printing machine or the like with them being bundled. It is also possible to construct an image-forming system, which is consistent from the image-forming apparatus to the post-processing apparatus, including a coil-binding function that a general user can use.

A fourth paper-sheet-handling apparatus of the present invention is a paper-sheet-handling apparatus that forms a spiral coil from a wire rod having a predetermined thickness and performs a binding processing on a bundle of paper-sheets by the coil. The apparatus is provided with a coil-forming mechanism that includes plural species of sections each like an arc of a circle for setting a diameter of the coil and forms the spiral coils, a binding mechanism that performs the binding processing on the bundle of paper-sheets by the spiral coil formed by the coil-forming mechanism, and a manipulation part that is manipulated so as to select one section like an arc of a circle corresponding to the thickness of the bundle of paper-sheets from the plural species of the sections each like an arc of a circle for setting a diameter of the coil. It is characterized in that the coil-forming mechanism pushes the wire rod into the section like an arc of a circle selected by the manipulation part to form the spiral coil. Paper-sheet-handling apparatus.

According to the fourth paper-sheet-handling apparatus of the present invention, it is configured that when forming the spiral coil from the wire rod having the predetermined thickness and performing a binding processing on a bundle of paper-sheets by the coil, the manipulation part is manipulated so as to select one section like an arc of a circle corresponding to the thickness of the bundle of paper-sheets from the plural species of the sections each like an arc of a circle for setting a diameter of the coil. The coil-forming mechanism includes plural species of sections each like an arc of a circle for setting a diameter of the coil and forms the spiral coils. On an assumption of this, the coil-forming mechanism pushes the wire rod into the section like an arc of a circle selected by the manipulation part to form the spiral coil. The binding mechanism performs the binding processing on the bundle of paper-sheets by the spiral coil formed by the coil-forming mechanism. Accordingly, it is made possible to perform an automatic binding processing on the bundle of paper-sheets by the spiral coil having a diameter of a coil specified by the user corresponding to the thickness of the bundle of paper-sheets. This enables to be constructed the image-forming system including a coil-binding function that a general user can use, which is similar to the third paper-sheet-handling apparatus.

A paper-sheet-handling apparatus of the present invention using any of the first through fourth controls has a control method of the paper-sheet-handling apparatus that forms the spiral coil from the wire rod having the predetermined thickness and performs a binding processing on a bundle of paper-sheets by the coil, characterized in that the method includes a step of selecting one section like an arc of a circle corresponding to the thickness of the bundle of paper-sheets from the plural species of the sections each like an arc of a circle for setting a diameter of the coil, before the binding processing, a step of pushing the wire rod into the selected section like an arc of a circle to form the spiral coil, and a step of performing the binding processing on the bundle of paper-sheets by the formed spiral coil.

According to the paper-sheet-handling apparatus of the present invention using any of the first through fourth controls, when forming the spiral coil from the wire rod having the predetermined thickness and performing a binding processing on a bundle of paper-sheets by the coil, it is made possible to perform an automatic binding processing on the bundle of paper-sheets by the spiral coil having a diameter of a coil automatically selected corresponding to the thickness of the bundle of paper-sheets or the spiral coil having a diameter of a coil specified by the user corresponding to the thickness of the bundle of paper-sheets. This enables it to be sufficiently applied to a post-processing apparatus which performs the binding processing on pieces of the record paper distributed from a copying machine for black-and-white and colors, a printing machine or the like with them being bundled. It is also made possible to construct an image-forming system, which is consistent from the image-forming apparatus to the post-processing apparatus, including a coil-binding function that a general user can use.

A paper-sheet-handling apparatus of the present invention constituting a first image-forming system is provided with an image-forming device that forms an image on each predetermined paper-sheet and releases it and a post-processing apparatus that bundles the paper-sheets released from the image-forming apparatus, forms the spiral coil from the wire rod having the predetermined thickness and performs a binding processing on the plural holes continuously set on the bundle of paper-sheets by the coil, the post-processing apparatus comprising the coil-forming mechanism including plural species of the sections each like an arc of a circle for setting a diameter of the coil to form the spiral coils, a binding mechanism that performs the binding processing on the bundle of paper-sheets by the spiral coil formed by the coil-forming mechanism, a detection part that detects the bundle of paper-sheets and outputs information on the paper-sheets, and a selection mechanism that selects one section like an arc of a circle corresponding to the thickness of the bundle of paper-sheets from the plural species of the sections each like an arc of a circle for setting a diameter of the coil, based on the information on the paper-sheets output from the detection part, characterized in that the coil-forming mechanism pushes the wire rod into the section like an arc of a circle selected by the selection mechanism to form the spiral coil.

According to the paper-sheet-handling apparatus of the present invention constituting the first image-forming system, since there is provided with any of the first through the fourth paper-sheet-handling apparatuses according to the invention, it is made possible to provide the image-forming system that is provided with the post-processing apparatus with an automatic selection function of diameters of the coils, which bundles pieces of record paper released from an image-forming apparatus such as a copy machine, a printing machine and the like and performs a binding processing thereon by the coil.

A paper-sheet-handling apparatus of the present invention constituting a second image-forming system is provided with an image-forming device that forms an image on each predetermined paper-sheet and releases it and a post-processing apparatus that bundles the paper-sheets released from the image-forming apparatus, forms the spiral coil from the wire rod having the predetermined thickness and performs a binding processing on the plural holes continuously set on the bundle of paper-sheets by the coil, the post-processing apparatus comprising the coil-forming mechanism including plural species of the sections each like an arc of a circle for setting a diameter of the coil to form the spiral coils, a binding mechanism that performs the binding processing on the bundle of paper-sheets by the spiral coil formed by the coil-forming mechanism, and a manipulation mechanism that is manipulated so as to select one section like an arc of a circle corresponding to the thickness of the bundle of paper-sheets from the plural species of the sections each like an arc of a circle for setting a diameter of the coil, characterized in that the coil-forming mechanism pushes the wire rod into the section like an arc of a circle selected by the manipulation mechanism to form the spiral coil.

According to the paper-sheet-handling apparatus of the present invention constituting the second image-forming system, since there is provided with any of the first through the fourth paper-sheet-handling apparatuses according to the invention, it is made possible to provide the image-forming system that is provided with the post-processing apparatus with a manual selection function of diameters of the coils, which bundles pieces of record paper released from an image-forming apparatus such as a copy machine, a printing machine and the like and performs the binding processing thereon by the coil.

A coil-forming device according to the invention is provided with a main body part that includes a wire rod insert port and a coil discharge port, a wire-rod-dispatching part that dispatches the wire rod to a predetermined direction, the wire-rod-dispatching part being attached to the main body part, a coil-forming part that includes a section like an arc of a circle for setting a diameter of the coil and forms the wire rod dispatched from the wire-rod-dispatching part into the spiral coil along the section like the arc of the circle, and a pitch-adjusting mechanism that adjusts a pitch of the spiral coil formed by the section like the arc of the circle and drawn out of the coil-discharging port, the pitch-adjusting mechanism being mounted near the coil discharge port of the main body part. It is characterized in that the wire-rod-dispatching part dispatches the wire rod having the predetermined thickness from the wire rod insert port with it coming into contact with the section like the arc of the circle.

According to the coil-forming device according to the invention, when forming the spiral coil from the wire rod having the predetermined thickness, the wire-rod-dispatching part dispatches the wire rod having the predetermined thickness from the wire rod insert port with it coming into contact with the section like the arc of the circle. On an assumption of this, the coil-forming part forms the wire rod dispatched from the wire-rod-dispatching part to the spiral coil along the section like an arc of a circle. The pitch-adjusting mechanism mounted near the coil discharge port of the main body part adjusts a pitch of the spiral coil formed by the section like the arc of the circle and drawn out of the coil-discharging port.

Accordingly, since it is possible to limit the coil pitch of the spiral coil to a fixed pitch, it is possible to the spiral coil for binding the bundle of paper-sheets with good reproducibility so that the pitch cannot change even if the diameter of the coil changes. This enables the coil-forming device to be sufficiently applied to the paper-sheet-handling apparatus or the like that selects the spiral coil having the desired diameter of the coil corresponding to the thickness thereof and performs the binding processing thereon under a case or the like where the pitch of the punched holes in the record paper is identical and the thicknesses of the bundles of the paper-sheets are different.

### BRIEF DESCRIPTION OF THE DRAWINGS

FIG. 1 is a perspective view showing a configuration example of a paper-sheet-handling apparatus 100 as an embodiment to which a coil-forming device according to the invention is applied.

FIG. 2A is a perspective view of a bundle of paper-sheets 3 for showing a function example of the paper-sheet-handling apparatus 100.

FIG. 2B is a perspective view of a binding step for showing the function example of the paper-sheet-handling apparatus 100.

FIG. 2C is a completed view of a booklet 90 for showing the function example of the paper-sheet-handling apparatus 100.

FIG. 3 is a perspective view showing a configuration example of a coil-forming mechanism 20.

FIG. 4 is a perspective view showing an assembling example (part one) of the coil-forming mechanism 20.

FIG. 5 is a perspective view showing the assembling example (part two) of the coil-forming mechanism 20.

FIG. 6A is a front view showing a pushing-out example (part one) of a wire rod when a coil is formed.

FIG. 6B is a cross-sectional view taken along lines A-A of FIG. 6A.

FIG. 7A is a front view showing the pushing-out example (part two) of the wire rod when the coil is formed.

FIG. 7B is a cross-sectional view taken along lines A-A of FIG. 7A.

FIG. 8A is a front view showing the pushing-out example (part three) of the wire rod when the coil is formed.

FIG. 8B is a cross-sectional view taken along lines A-A of FIG. 8A.

FIG. 9A is a front view showing the pushing-out example (part four) of the wire rod when the coil is formed.

FIG. 9B is a cross-sectional view taken along lines A-A of FIG. 9A.

FIG. 10A is a cross-sectional view taken along lines A-A of FIG. 9A for showing the pushing-out example (part five) of the wire rod when forming the coil having a diameter of a coil of 8 mm.

FIG. 10B is a cross-sectional view taken along lines A-A of FIG. 9A for showing the pushing-out example of the wire rod when forming the coil having a diameter of a coil of 11 mm.

FIG. 10C is a cross-sectional view taken along lines A-A of FIG. 9A for showing the pushing-out example of the wire rod when forming the coil having a diameter of a coil of 14 mm.

FIG. 11 is a perspective view showing a configuration example of a binding mechanism 40.

FIG. 12 is a perspective view showing a configuration example of a linking part 30 and its peripheral mechanism.

FIG. 13 is an exploded perspective view showing an assembled example of main parts of the binding mechanism 40 at a side of the linking part.

FIG. 14A is a sectional view showing a functional example of the linking part 30 when the coil is advanced.

FIG. 14B is a sectional view showing a functional example of the linking part 30 when the coil is limited.

FIG. 14C is a sectional view showing a functional example of the linking part 30 when the coil is derived.

FIG. 15A is a sectional view showing a functional example of the linking part 30 in relation to a case where the diameter of the coil is 11 mm.

FIG. 15B is a sectional view showing a functional example of the linking part 30 in relation to a case where the diameter of the coil is 14 mm.

FIG. 16A is a configuration example of convex teeth 46b of a screw guide 46a.

FIG. 16B is a top view showing a configuration example of a guide projection portion 49b of a screw guide 49.

FIG. 17A is a perspective view showing a supporting example of a spiral coil 11b having a middle diameter.

FIG. 17B is a front view showing a configuration example of the spiral coil 11b shown in FIG. 17A as indicated from a direction of an arrow P2.

FIG. 18 is an explanation view showing an example of a clearance between a spiral coil 11c having a large diameter and a punched hole 3a of a bundle of paper-sheets 3.

FIG. 19A is a top view showing a supporting example of a spiral coil 11a having a small diameter.

FIG. 19B is a top view showing a supporting example of the spiral coil 11b having the middle diameter.

FIG. 19C is a top view showing a supporting example of the spiral coil 11c having the large diameter.

FIG. 20 is a side view showing an operation example of the binding mechanism 40 at a period of standby time.

FIG. 21 is a side view showing an operation example of the binding mechanism 40 when setting a position of the spiral coil 11a having the small diameter.

FIG. 22 is a side view showing an operation example of the binding mechanism 40 when setting a position of the spiral coil 11b having the middle diameter.

FIG. 23 is a side view showing an operation example of the binding mechanism 40 when setting a position of the spiral coil 11c having the large diameter.

FIG. 24A is a top view showing a configuration example of a paper-sheet-aligning guide 41 shown in FIG. 12.

FIG. 24B is a front view showing the paper-sheet-aligning guide 41 shown in FIG. 24A as indicated from an X-direction.

FIG. 25A is a top view showing a function example of the paper-sheet-aligning guide 41 when aligning the paper-sheets.

FIG. 25B is a cross-sectional view of the paper-sheet-aligning guide 41 taken along lines X-X shown in FIG. 25A.

FIG. 26A is a front view showing an example of a state before an insertion of the spiral coil 11b having the middle diameter into the paper-sheet-aligning guide 41.

FIG. 26B is a front view showing an example of a state after the insertion of the spiral coil 11b having the middle diameter into the paper-sheet-aligning guide 41.

FIG. 27A is a front view showing a function example when inserting the spiral coil 11a having the small diameter into the paper-sheet-aligning guide 41.

FIG. 27B is a front view showing a function example when inserting the spiral coil 11c having the large diameter into the paper-sheet-aligning guide 41.

FIG. 28A is a perspective view showing a configuration example of a cutting-and-bending mechanism 75.

FIG. 28B is a perspective view showing an enlarged configuration example of a cutting-and-bending mechanism 75 indicated in a circle shown by dashed line in FIG. 28A.

FIG. 29 is a perspective view showing an assembling example of the cutting-and-bending mechanism 75.

FIG. 30A is a top view showing an operation example of the cutting-and-bending mechanism 75 in the screw guider 49 at a period of stand-by time.

FIG. 30B is an enlarged view showing an operation example of the cutting-and-bending mechanism 75 indicated in a circle shown by dashed line in FIG. 30A.

FIG. 30C is a perspective view showing an operation example of the cutting-and-bending mechanism 75 shown in FIG. 30B.

FIG. 31A is a top view showing an operation example of the cutting-and-bending mechanism 75 when cutting the coil.

FIG. 31B is an enlarged view showing an operation example of the cutting-and-bending mechanism 75 indicated in a circle shown by dashed line in FIG. 31A.

FIG. 31C is a perspective view showing an operation example of the cutting-and-bending mechanism 75 shown in FIG. 31B.

FIG. 32A is a top view showing an operation example of the cutting-and-bending mechanism 75 when bending the coil.

FIG. 32B is an enlarged view showing an operation example of the cutting-and-bending mechanism 75 indicated in a circle shown by dashed line in FIG. 32A.

FIG. 32C is a perspective view showing an operation example of the cutting-and-bending mechanism 75 shown in FIG. 32B.

FIG. 33 is a perspective view showing a configuration example of the spiral coil 11c, an end of which has been processed.

FIG. 34 is a partially broken sectional view showing a configuration example of a wire rod cartridge 10 and its peripheral mechanism.

FIG. 35 is a diagram showing a mounting example of the wire rod cartridge 10.

FIG. 36A is a partially broken front view showing a detection example of the wire rod in the wire rod cartridge 10 when the wire rod is present therein.

FIG. 36B is a partially broken front view showing a detection example of the wire rod in the wire rod cartridge 10 when the wire rod is not present therein.

FIG. 37 is a diagram showing another disposition example of the wire rod cartridge 10 and a configuration example of another wire rod detection sensor 65′.

FIG. 38A is a block diagram showing a detection example of the wire rod in a wire rod tension mechanism 15 when a tension roller stays at an uppermost position thereof.

FIG. 38B is a block diagram showing a detection example of the wire rod in a wire rod tension mechanism 15 when a tension roller presses.

FIG. 38C is a block diagram showing a detection example of the wire rod in a wire rod tension mechanism 15 when a tension roller stays at a lowermost position thereof.

FIG. 39 is a block diagram showing a configuration example of a control system for the paper-sheet-handling apparatus 100.

FIG. 40 is a block diagram showing a configuration example of an image-forming system 101 as a first embodiment.

FIG. 41 is a flowchart showing an operation example of the paper-sheet-handling apparatus 100 in the image-forming system 101.

FIG. 42 is a perspective view showing a configuration example of a coil binder 102 as a second embodiment.

FIG. 43A is a perspective view showing a handling example of the coil binder 102 when inserting the bundle of paper-sheets thereinto.

FIG. 43B is a perspective view showing a handling example of the coil binder 102 when performing the binding processing on the bundle of paper-sheets.

FIG. 43C is a perspective view showing a handling example of the coil binder 102 when taking out the booklet.

FIG. 44 is a flowchart showing a control example of the coil binder 102.

### BEST MODE FOR CARRYING OUT THE INVENTION

It is a first object of the present invention to provide a coil-forming device and a paper-sheet-handling apparatus by which a coil pitch of a spiral coil can be limited to a fixed pitch and the spiral coil can be formed with a good reproducibility so that the pitch is not remained unchanged even if the diameter of the coil changes.

It is also a second object of the present invention to provide a paper-sheet-handling apparatus that can create booklets by performing a binding processing on bundles of paper-sheets having desired thicknesses with spiral coils having different diameters of the coils.

Further, it is a third object of the present invention to provide a paper-sheet-handling apparatus that can perform an automatic binding processing with a spiral coil having a diameter of a coil corresponding to a thickness of the bundle of paper-sheets and by which a general-user-usable coil-binding system can be constructed.

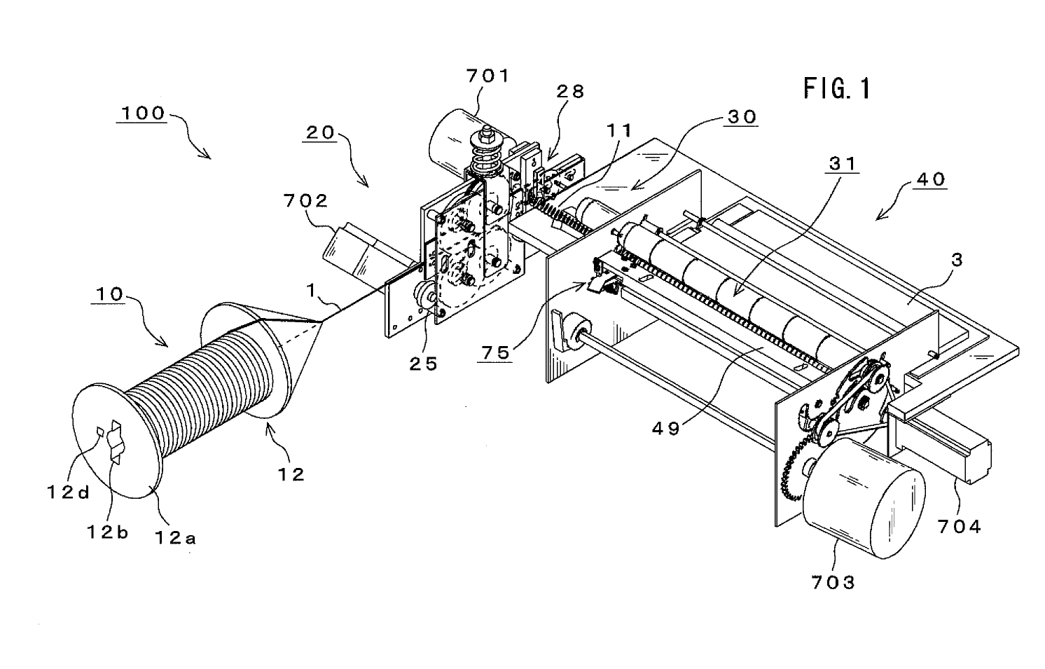

A description will be given of the paper-sheet-handling apparatus and the coil-forming device in accordance with embodiments of the present invention with reference to the drawings. The paper-sheet-handling apparatus 100 shown in FIG. 1, to which the coil-forming device according the invention is applied, is configured so as to be provided with a wire rod cartridge 10, a coil-forming mechanism 20, a linking part 30 and a binding mechanism 40, and binds a bundle of paper-sheets 3 by winding a spiral coil (hereinafter, referred to as “spiral coil 11”) thereon to constitute a coil-binding apparatus.

The wire rod cartridge 10 constitutes a function of a wire-rod-supplying part and is wound by the wire rod for forming the spiral coil 11. The wire rod cartridge 10 has a drum 12 on which the wire rod 1 (consumables) is wound. The drum 12 has a bobbin 12a that is portable (can be carried) and at the bobbin 12a, a winding shaft 12b and an opening 12d for mounting are provided.

On the drum 12, for example, a vinyl-covered iron-core wire of around 500 through 1000 m is wound. A diameter of the wire rod 1 is around 0.8 through 1.2 mm. A waste amount of the wire rod 1 is around 2.1 min a case of a coil having the large diameter of the coil of 14 mm if a paper-sheet has an A size, on which there are 49 punched holes. Similarly, it is around 1.6 min a case of a coil having the middle diameter of the coil of 11 mm. It is around 1.2 m in a case of a coil having the small diameter of the coil of 8 mm.

The coil-forming mechanism 20 is provided at a downstream side of the wire rod cartridge 10 and operates to form the spiral coil 11 having a set diameter of the coil for binding the bundle of paper-sheets. To the coil-forming mechanism 20, the coil-forming device according to the invention is applied. The coil-forming mechanism 20 is configured to have a coil-forming part 28, motors 701, 702 and the like, to set the diameter of the coil and to drive a wire-rod-dispatching mechanism. In this example, it is designed that three species of diameters of the coils, a large diameter of the coil of 14 mm, a middle diameter of the coil of 11 mm and a small diameter of the coil of 8 mm, can be formed. The linking part 30 is provided at a downstream side of the coil-forming mechanism 20 and operates to guide the spiral coil 11 formed corresponding to a previously set diameter of the coil so as to lead to the binding mechanism 40.

The binding mechanism 40 constituting the binding mechanism is provided at a downstream side of the linking part 30 and is configured to draw thereinto the spiral coil 11 having the predetermined diameter of the coil, which has been formed in the coil-forming mechanism 40, through the linking part 30 and to bind the bundle of paper-sheets 3 by winding the spiral coil 11 thereon. It is configured that the binding mechanism 40 has a feed roller 31, the screw guider 49 of a movable adjustment side, motors 703, 704 and the like, sets positions of the feed roller 31, the screw guider 49 and the like corresponding to the diameter of the coil and drives the feed roller 31.

A cutting-and-bending mechanism 75 constituting the cutting part is provided at an upstream side of the screw guider 49 and is configured to bend an end of the spiral coil 11 that has been inserted into the bundle of paper-sheets 3 after the end thereof has been cut. The paper-sheet-handling apparatus 100 having such a configuration can create booklets by performing a binding processing on the bundles of paper-sheets 3 with the spiral coils 11.

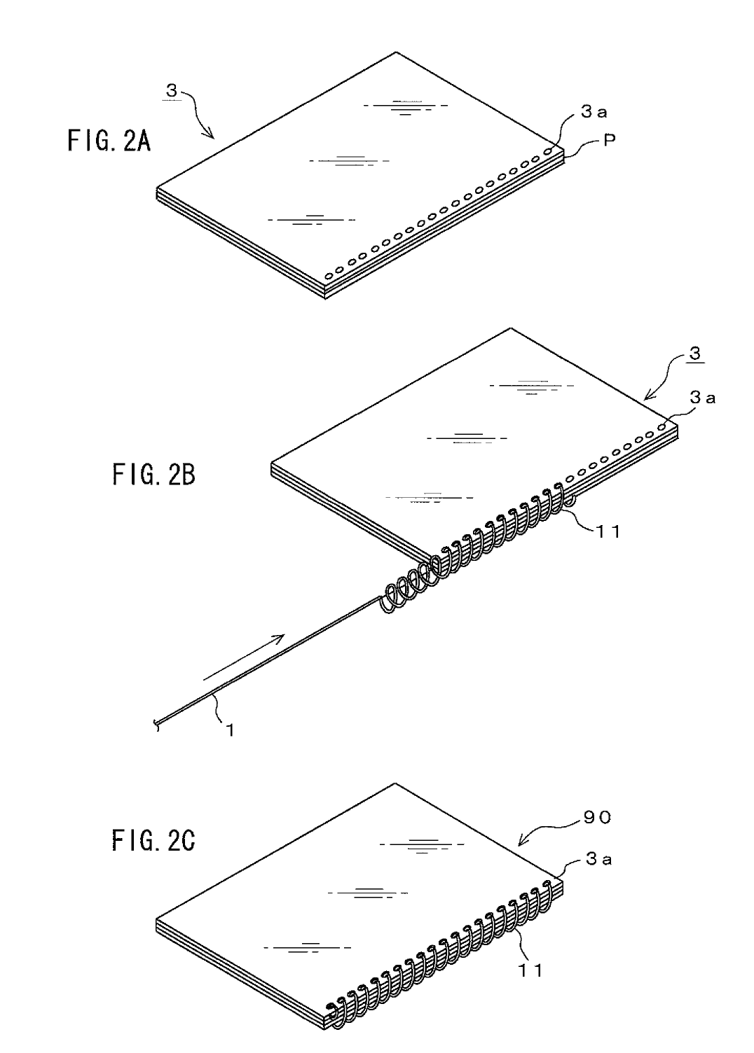

The following describe a paper-sheet-handling method according to the invention with reference to FIGS. 2A through 2C. The bundle of paper-sheets 3 shown in FIG. 2A is applied to the paper-sheet-handling apparatus 100 and any punched holes 3a have been already perforated at predetermined positions on each paper-sheet. It is configured that the binding processing is performed at a period of coil binding time after opening positions of the punched holes 3a in the bundle of paper-sheets 3 have been aligned. The punched holes 3a may be perforated with a predetermined pitch by means of an automatic punching processing or may be perforated with a predetermined pitch by means of a manual puncher. The punched holes 3a may be perforated at either method if disposition pitch in the punched holes 3a is in correspondence with a pitch of formed coil.

Next, according to the binding step shown in FIG. 2B, it is configured that the binding processing is performed on the bundle of paper-sheets 3 with the spiral coil 11 formed by the paper-sheet-handling apparatus 100 on a real-time basis. In this example, it is configured that the spiral coil 11 formed by the coil-forming mechanism 20 shown in FIG. 1 is inserted into the punched holes 3a of the bundle of paper-sheets 3 and is wound in cooperation with the linking part 30 and the binding mechanism 40. A rear end of the spiral coil 11 is then cut and a forward end and the rear end thereof are bent. This enables a booklet 90, into which the spiral coil 11 is wound, shown in FIG. 2C to be obtained.

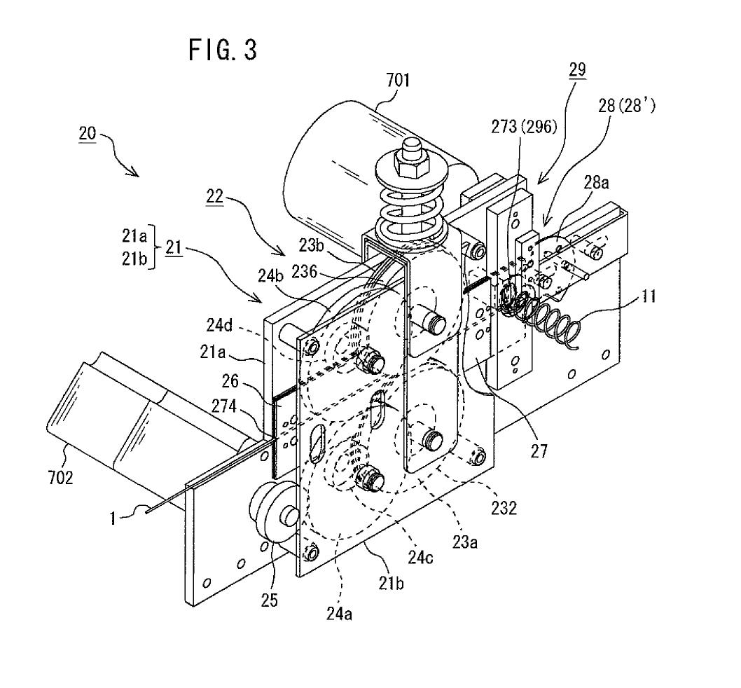

Next, a description will be given of a configuration example of the coil-forming mechanism 20 with reference to FIG. 3. The coil-forming mechanism 20 shown in FIG. 3 forms the spiral coil 11 for binding the bundle of paper-sheets 3 and is configured to have a main body part 21, a wire-rod-dispatching mechanism 22, the coil-forming part 28 and a pitch-adjusting mechanism 29 to form the spiral coil 11 based on the wire rod 1 dispatched from, for example, the predetermined drum 12 shown in FIG. 1.

The main body part 21 is configured to have a convex board 21a and a rectangular board 21b (shown in a partially broken state in the figure). The boards 21a, 21b are constituted of metal boards each having a predetermined thickness and both are used in their stand postures. For the metallic boards, for example, iron boards, aluminum boards or the like are used. To the main body part 21, the wire-rod-dispatching mechanism 22 constituting a function of the wire-rod-dispatching part is attached. The wire-rod-dispatching mechanism 22 has dispatching rollers 23a, 23b for forcing the wire rod, a wire-rod-inserting guide part 26 and a wire-rod-pushing-out guide part 27.

It is configured that the wire-rod-inserting guide part 26 is provided at an upstream side of the dispatching rollers 23a, 23b and a wire rod insertion port 274 is provided in the wire-rod-inserting guide part 26, to which the wire rod 1 is inserted (supplied). The wire rod insertion port 274 is a portion to which the wire rod 1 is supplied and constitutes a port to which one wire rod can advance. For the wire rod 1, a vinyl-covered iron-core wire is used. Of course, it is not limited thereto: an aluminum wire, a plating aluminum-core wire, a plating iron-core wire or the like may be used for the wire rod 1.

The dispatching rollers 23a, 23b are provided between the wire-rod-inserting guide part 26 and the wire-rod-pushing-out guide part 27. The dispatching rollers 23a, 23b each has an R-groove (a groove having a curved section of almost an arc of a circle) corresponding to a diameter of the wire rod 1. The dispatching roller 23a has a large diameter gear 232 and the dispatching roller 23b has a large diameter gear 236.

The wire-rod-pushing-out guide part 27 is provided at a downstream side of the dispatching rollers 23a, 23b and is configured that the wire rod 1 inserted from the wire insertion port 274 is guided (supplied) into the coil-forming part 28. The wire-rod-pushing-out guide part 27 has an opening 273 for mounting a pitch-fine-adjusting block. The wire-rod-dispatching mechanism 22 having such a configuration enables the wire rod 1 having the predetermined thickness to be fitted with the R-grooves of the dispatching rollers 23a, 23b so that it is possible to force the wire rod 1 from the wire-rod-inserting guide part 26 into the coil-forming part 28 through the wire-rod-pushing-out guide part 27 without receiving any wound to the wire rod 1 and slipping the wire rod 1.

The dispatching rollers 23a, 23b are configured so as to rotate through up-and-down interlocking large diameter gears 24a, 24b for deceleration, which constitute a driving part. A motor gear 25 is meshed with the large diameter gear 24a. The motor gear 25 is attached to a shaft of a motor 702. The lower large diameter gear 24a and the upper large diameter gear 24b are meshed with each other at their outer circumferences by their gears. The large diameter gear 24a has a small diameter gear 24c.

The small diameter gear 24c is meshed with a large diameter gear 232 of the dispatching roller 23a. The large diameter gear 24b has a small diameter gear 24d. The small diameter gear 24d is meshed with a large diameter gear 236 of the dispatching roller 23b. In this example, when the motor 702 rotates, the large diameter gears 24a, 24b rotate through the motor gear 25 so that the lower dispatching roller 23a and the upper dispatching roller 23b rotate through the small diameter gears 24c, 24d.

To the main body part 21 in which the wire-rod-dispatching mechanism 22 is provided, the coil-forming part 28 is attached. In this example, the coil-forming part 28 has a selection mechanism 28′. In the selection mechanism 28′, a forming adapter 28a is provided. The forming adapter 28a is rotatably attached to the main body part 21 and is configured that one section like an arc of a circle can be selected from three sections, #Ø14, #Ø11, #Ø8, each like an arc of a circle.

Here, the section #Ø14 like an arc of a circle is an internal shape that forms a coil having a large diameter (a diameter of the coil) of 14 mm; similarly, the section #Ø11 like an arc of a circle is an internal shape that forms a coil having a middle diameter (a diameter of the coil) of 11 mm; and the section #Ø8 like an arc of a circle is an internal shape that forms a coil having a small diameter (a diameter of the coil) of 8 mm. The sections, #Ø14, #Ø11, #Ø8, each like an arc of a circle respectively have a pick-up function when advancing the wire rod. For example, by attaching the wire rod 1 to any of the sections, #Ø14, #Ø11, #Ø8, each like an arc of a circle having different diameters so as to lie along inside them, it is configured that the diameter of the coil is set to have a diameter of 14 mm, 11 mm or 8 mm. Since the configuration such that the wire rod 1 is wound around a core member is not taken in this example, it is made possible to simplify a configuration of the coil-forming device without any necessary for changing parts or the like, as compared with a conventional system.

A motor 701 for setting a diameter of a coil is connected with the forming adapter 28a and drives so as to select one section like an arc of a circle from the three sections, #Ø14, #Ø11, #Ø8, each like an arc of a circle. For the motor 701, a stepping motor is used. The above-mentioned wire-rod-dispatching mechanism 22 dispatches the wire rod 1 having a predetermined thickness from the wire rod insertion port 274 to, for example, the section #Ø14 like an arc of a circle, which is selected by the motor 701, with it being attached to the section #Ø14 like an arc of a circle.

The pitch-adjusting mechanism 29 is provided in the main body part 21 so as to put an end of the forming adapter 28a therebetween and is configured that a pitch of the spiral coil 11 dispatched from the section #Ø14 like an arc of a circle is adjusted. The pitch-adjusting mechanism 29 has a coil discharge port 296 that is provided so as to come into continuous contact with the opening 273 of the wire-rod-pushing-out guide part 27.

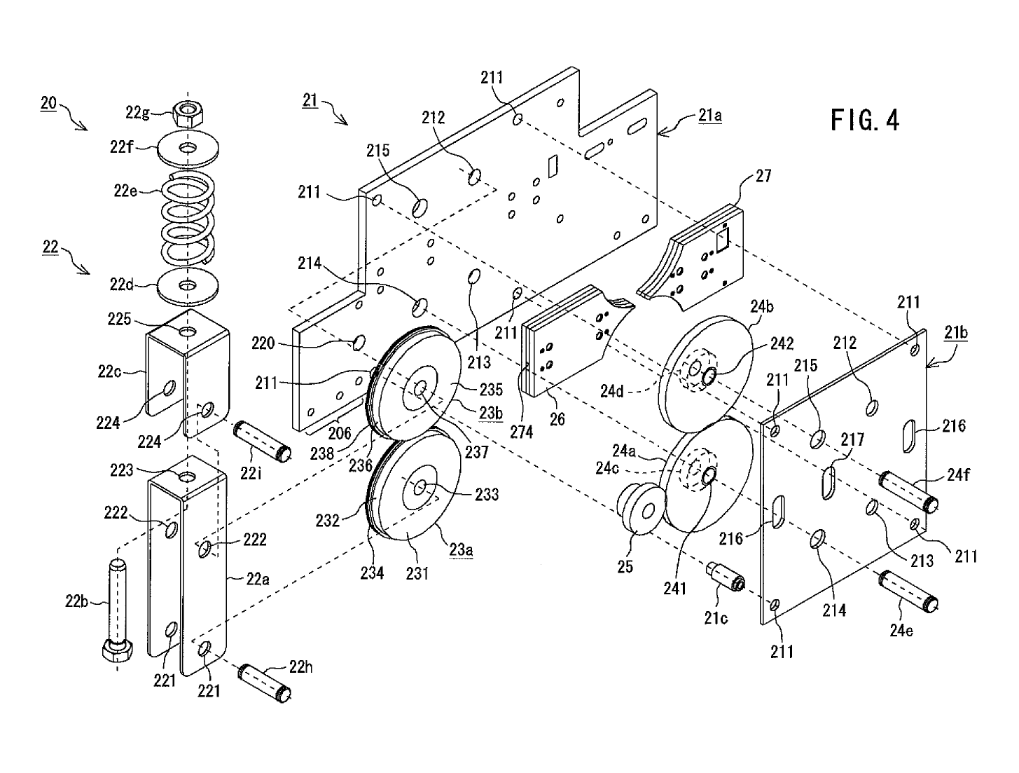

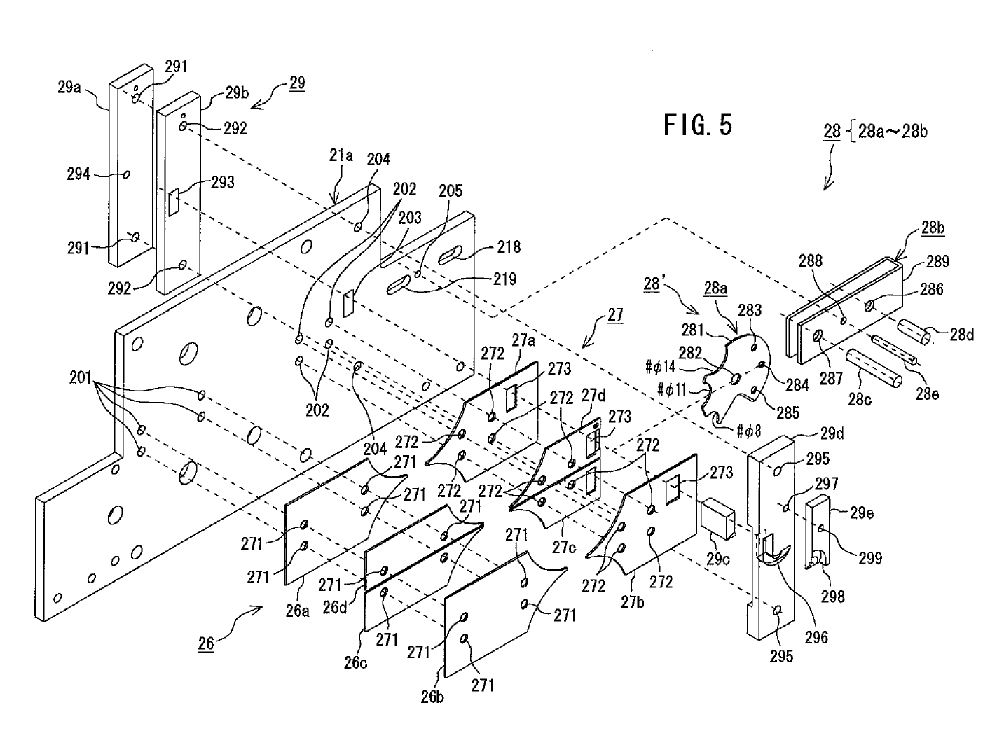

Next, a description will be given of an assembling example (part one and two) of the coil-forming mechanism 20 with reference to FIGS. 4 and 5. In this example, the description will be given with it classifying the coil-forming mechanism 20 into 2 parts, the wire-rod-dispatching mechanism 22 and the coil-forming part 28, which constitute the coil-forming mechanism 20.

According to the coil-forming mechanism 20 shown in FIG. 4, an anterior half thereof is configured so that the wire-rod-dispatching mechanism 22 is attached to the main body part 21. The main body part 21 is configured to have the convex board 21a and the rectangle board 21b. The convex board 21a has shaft holes 212, 213 and 220 and holes 206 for mounting the motor and the rectangle board 21b has shaft holes 212, 213 and long holes 216, 217 for checking.

The wire-rod-dispatching mechanism 22 has a long U frame 22a having an inverse U-shape. The U frame 22a is formed by, for example, performing a bending process on a rectangular iron plate into a U-shape. The U frame 22a respectively has shaft holes 221, 221 at lower portions of its side surfaces, has shaft holes 222, 222 at upper portions of its side surfaces, and has an engaging hole 223 for inserting a bolt thereinto at its upper top surface.

On the long U frame 22a having the inverse U-shape, a short U frame 22c having an inverse U-shape is mounted. The U frame 22c is formed by, for example, performing a bending process on a rectangular iron plate into a U-shape. The U frame 22c respectively has shaft holes 224, 224 at lower portions of its side surfaces, and has an engaging hole 225 for inserting a bolt thereinto at its upper top surface.

It is configured that the bolt 22b is inserted into the engaging hole 225 via the engaging hole 223 of the U frame 22a and into the bolt 22b, a washer 22d, a coil spring 22e and a washer 22f are fitted, and then they are fixed by a nut 22g.

The wire-rod-dispatching mechanism 22 has circular dispatching rollers 23a, 23b. The dispatching roller 23a has a main body part 231 and a shaft hole 233 and also has a large diameter gear 232 on a peripheral portion of the main body part 231. The R-groove (a groove having a curved section of almost an arc of a circle) is provided so as to be adjacent to the large diameter gear 232. Similarly, the dispatching roller 23b has a main body part 235 and a shaft hole 237 and also has a large diameter gear 236 on a peripheral portion of the main body part 235. The R-groove 238 is provided so as to be adjacent to the large diameter gear 236.

The R-groove 234 of the large diameter gear 232 and the R-groove 238 of the large diameter gear 236 are formed corresponding to an outer diameter of the wire rod 1. It is thus made possible to dispatch the wire rod 1 so as to be wrapped with its outer diameter so that the coil forming can be carried out more stably as compared with a case where the large diameter gears 232, 236 are constituted of V-grooves.

The dispatching roller 23a is inserted into a lower portion of an inverse U-shaped portion in the U-frame 22a and is rotatably mounted by a lower shaft pin 22h through shaft holes 221 in the U-frame 22a. Ring grooves are processed on both ends of the shaft pin 22h. The dispatching roller 23b is inserted into an upper portion of the inverse U-shaped portion in the U-frame 22a and is rotatably mounted by an upper shaft pin 22i through shaft holes 222 in the U-frame 22a. Ring grooves are processed on both ends of the shaft pin 22i, which is similar to the shaft pin 22h.

The wire-rod-dispatching mechanism 22, both ends of the shaft pin 22h are put into the shaft hole 213 of the board 21a and the shaft hole 213 of the board 21b and a C-clip, not shown, is fixed (locked) onto the ring groove thereof. Both ends of the shaft pin 22i are put into the shaft hole 212 of the board 21a and the shaft hole 212 of the board 21b and a C-clip, not shown, is fixed onto the ring groove thereof.

The wire-rod-dispatching mechanism 22 has the up-and-down interlocking large diameter gears 24a, 24b for deceleration, which constitute a driving part. The lower large diameter gear 24a and the upper large diameter gear 24b are meshed with each other at their outer circumferences by their gears. The large diameter gear 24a has a small diameter gear 24c and a shaft hole 241. The large diameter gear 24a is inserted between the boards 21a, 21b, and is rotatably mounted with the shaft pin 24e being reached to the shaft hole 241 and the shaft hole 214 of the board 21a through the shaft hole 214 of the board 21b. Ring grooves are also processed on both ends of the shaft pin 24e. The small diameter gear 24c is meshed with the large diameter gear 232 in the dispatching roller 23a.

The large diameter gear 24b has a small diameter gear 24d and a shaft hole 242. The large diameter gear 24b is inserted into an upper portion that is between the boards 21a, 21b, and is rotatably mounted with the shaft pin 24f being reached to the shaft hole 242 and the shaft hole 215 of the board 21a through the shaft hole 215 of the board 21b. Ring grooves are also processed on both ends of the shaft pin 24f. The small diameter gear 24d is meshed with the large diameter gear 236 in the dispatching roller 23b. The motor gear 25 is meshed with the above-mentioned large diameter gear 24a. The motor gear 25 is connected with the motor 702 through the shaft hole 220 of the board 21a (see FIG. 1). The motor 702 is mounted using the holes 206 for mounting the motor on the board 21a.

The wire-rod-inserting guide part 26 is provided at one side of the dispatching rollers 23a, 23b and the wire-rod-pushing-out guide part 27 is provided at the other side of the dispatching rollers 23a, 23b. The above-mentioned motor gear 25 is mounted on the shaft of the motor 702 shown in FIG. 1. When the motor 702 rotates, the large diameter gear 24a rotates through the motor gear 25 and the large diameter gear 24b also rotates. When the large diameter gear 24a rotates, its small diameter gear 24c rotates the dispatching roller 23a through the large diameter gear 232. At the same time, when the large diameter gear 24b rotates, its small diameter gear 24d rotates the dispatching roller 23b through the large diameter gear 236. This enables the wire rod 1 pinched by the R-grooves 234, 238 to be dispatched (see FIG. 1).

The wire rod 1 is drawn into the wire-rod-inserting guide part 26 and is pushed out of the dispatching rollers 23a, 23b so that it is inserted into the wire-rod-pushing-out guide part 27 and is attached to one of the sections, #Ø14, #Ø11, #Ø8, each like an arc of a circle, in the forming adapter 28a shown in FIG. 5.

According to the coil-forming mechanism 20 shown in FIG. 5, it is configured that the coil-forming part 28 and the pitch-adjusting mechanism 29 at its posterior half are attached to the main body part 21 shown in FIG. 4. The wire-rod-inserting guide part 26 shown in FIG. 5 is configured to have guide boards 26a, 26b, 26c and 26d. The guide boards 26a and 26b are constituted of metal plates each like a point of a sword. A part thereof like a point of a sword is formed so as to be reflective of an arc of a circle on an outer configuration of each of the dispatching rollers 23a and 23b. The guide boards 26a and 26b have respectively four mounting holes 271. The guide boards 26c and 26d have thickness that is set to one that is slightly thicker than a diameter of the wire rod. The guide boards 26c and 26d respectively have two mounting holes 271. The guide boards 26c and 26d are configured to have a size set to one that is slightly smaller than a size shared fifty-fifty with the guide board 26a, 26b or the like in a longitudinal direction thereof.

The wire-rod-inserting guide part 26 is assembled so that the guide boards 26c and 26d are pinched by the guide board 26a and the guide board 26b. In this example, the guide boards 26c and 26d are opposed to each other in the longitudinal direction thereof in order to keep an insertion path of the wire rod 1 so as to set a gap that has a size which is slightly larger than the diameter of the wire rod 1. Under this condition, mounting screws, not shown, are respectively mounted onto four screw holes 201 of the board 21a through the four holes 271 of the guide board 26b, the two holes 271 for each of the guide boards 26c and 26d and the four holes 271 of the guide board 26a. This enables the wire-rod-inserting guide part 26 to be fixed to the board 21a.

The wire-rod-pushing-out guide part 27 is configured to have guide boards 27a, 27b, 27c and 27d. The guide boards 27a and 27b are constituted of metal plates each like a point of a sword, which are shorter than those of the wire-rod-inserting guide part 26. A part thereof like a point of a sword is formed based on the reason similar to that of the wire-rod-inserting guide part 26. The guide boards 27a and 27b have respectively four mounting holes 272. Further, rectangular openings 273 are provided at predetermined positions of the guide boards 27a and 27b at positions opposed to the parts each like the point of the sword thereof.

The guide boards 27c and 27d have thickness that is set to one that is slightly thicker then a diameter of the wire rod 1. The guide boards 27c and 27d respectively have two mounting holes 272. The guide boards 27c and 27d are configured to have a size set to one that is slightly smaller than a size shared fifty-fifty with the guide board 27a or 27b in a longitudinal direction thereof. Rectangular openings 273 are provided at sides of the guide boards 27c and 27d opposed to the parts each like the point of the sword thereof. In this example, the rectangular opening 273 of the guide board 27c may be omitted but the guide board 27c and the guide board 27d have interchangeability on parts.

The wire-rod-pushing-out guide part 27 is assembled so that the guide boards 27c and 27d are pinched by the guide board 27a and the guide board 27b. In this example, the guide boards 27c and 27d are opposed to each other in the longitudinal direction thereof, which is similar to the guide boards 26c and 26d, in order to keep a pushing-out path of the wire rod, so as to set a gap that has a size which is slightly larger than the diameter of the wire rod 1. Further, the opening 273 of the guide board 27a, the opening 273 of the guide board 27d and the opening 273 of the guide board 27b are aligned so as to correspond to each other. Under this condition, mounting screws, not shown, are respectively mounted onto four screw holes 202 of the board 21a through the four holes 272 of the guide board 27b, the two holes 272 for each of the guide boards 27c and 27d and the four holes 272 of the guide board 27a. This enables the wire-rod-pushing-out guide part 27 to be fixed to the board 21a.

A pin hole 205, a long aperture 218 and a long aperture 219 are provided in the above-mentioned board 21a and the coil-forming part 28 is attached using these apertures and hole. The coil-forming part 28 is configured to have the forming adapter 28a, U frame 28b and an engaging pin 28d. The forming adapter 28a is used which has a main body portion 281 on which a shaft-engaging hole 282 and pin-engaging holes 283 through 285 are provided and on which cut-away portions #Ø14, #Ø11, #Ø8 for setting a diameter of the coil are provided. For example, the forming adapter 28a forms the three semicircle sections #Ø14, #Ø11, #Ø8, each like an arc of a circle, by cutting its periphery of the circular metallic main body portion 281 into different sized ones.

The U frame 28b has a long inverse U-shaped main body portion 289. Pin holes 286 for fixing the main body portion 289, shaft holes 287 and pin holes 288 for fixing the forming adapter 28a are provided on the main body portion 289. In this example, the U frame 28b is attached to the board 21a while the forming adapter 28a is inserted into the U frame 28b. For example, a rotation shaft 28c for mounting a motor shaft is inserted into one of the shaft holes 287 of the U frame 28b, is then fitted into the shaft-engaging hole 282, is next inserted into the long aperture 219 of the board 21a and is further inserted into the other shaft hole 287 of the U frame 28b. The engaging pin 28d is inserted into the pin hole 286 and the long aperture 218 of the board 21a and both end thereof are fixed by C clamp members.

An end of the rotation shaft 28c is retained at an outside of the U frame 28b and the other end thereof is attached to the shaft of the motor 701 shown in FIG. 1, for example, at an outside of the board 21a. The motor 701 selects one section like an arc of a circle from the three sections #Ø14, #Ø11, #Ø8, each like an arc of a circle for setting a diameter of the coil. This enables a selection mechanism 28′ including the forming adaptor 28a rotatably attached to the main body part 21 to be configured.

Further, a pin 28e for fixation is inserted into one of the pin holes 288 of the U frame 28b, is further inserted into anyone of the pin-engaging holes 283 through 285, is next inserted into the pin hole 205 and is then inserted into the other pin hole 288 of the U frame 28b. The pin 28e for fixation is configured so as to be able to be taken out and put in. For example, it is configured that the pin 28e is provided with a solenoid and the pin 28e is made free when selecting any of the sections #Ø14, #Ø11, #Ø8, each like an arc of a circle for setting a diameter of the coil and the pin 28e is inserted into the pin hole 205 and the pin holes 288 to lock the forming adapter 28a when selecting the diameter of the coil. It is to be noted that by taking out the pin 28e, the forming adapter 28a can move along the long aperture 218 or 219 with it being inseparable from the U frame 28b, thereby making any alteration of the diameter of the coil easy.

The pitch-adjusting mechanism 29 other than the coil-forming part 28 is attached to the above-mentioned board 21a. The above-mentioned board 21a is provided with an opening 203 for attaching the pitch-adjusting mechanism and a screw hole 204. The pitch-adjusting mechanism 29 is configured to have a cover board 29a, a guide board 29b, a block 29c for making fine pitch adjustment (hereinafter, referred to as “fine adjustment part”) and an adjustment board 29d. The cover board 29a is constituted of a rectangular sheet metal having a predetermined thickness and has two screw holes 291, 291 for attachment at predetermined positions. A screw hole 294 for performing fine adjustment of the coil pitch is provided on the cover board 29a at a predetermined position.

The guide board 29b is constituted of a rectangular sheet metal having a size and a thickness, which are similar to those of the cover board 29a, and has two screw holes 292, 292 at predetermined positions. The guide board 29b is provided with a rectangular opening 293 at a predetermined position. Into the opening 293, the fine adjustment part 29c is fitted. The opening 293 is positioned at a position from which the screw hole 294 of the cover board 29a is seen. This is because by a screw (male screw) for fine adjustment, not shown, to be engaged with the screw hole 294, the fine adjustment part 29c is moved.

The adjustment board 29d is constituted of a rectangular sheet metal having a size which is almost similar to that of the cover board 29a or the guide board 29b and a thickness thereof is configured of a member being thicker than the cover board 29a, the guide board 29b or the like. In this example, the adjustment board 29d has a recessed portion that covers the openings 273 of the wire-rod-pushing-out guide part 27.

The adjustment board 29d has the coil discharge port 296 and a screw hole 297 for engagement. The coil discharge port 296 is formed like around J shape (like a fishing hook) obtained by combining into a single unit the rectangular opening for inserting the fine adjustment part 29c thereinto and a crescent-shaped opening. In this example, it is configured to draw the spiral coil 11 having a diameter of a coil of 8 mm, 11 mm, 14 mm or the like from the coil discharge port 296.

It is configured that the above-mentioned fine adjustment part 29c constitutes a function of a pitch adjustment correction part and adjusts a discharge position of the spiral coil 11. The fine adjustment part 29c has, for example, a rectangular shape having a predetermined thickness and is assembled so that it can move among the opening 293 of the guide board 29b, the opening 203 of the board 21a, the openings 273 of the wire-rod-pushing-out guide part 27 and the coil discharge port 296 of the adjustment board 29d.

The openings or port 293, 203, 273 and 296 form a hollow portion (a tunnel) in which the fine adjustment part 29c can be moved. This hollow portion is provided for enabling the coil pitch to be finely adjusted by allowing the fine adjustment part 29c to be moved back and forth on the carriage direction of the spiral coil 11. This enables a pitch of the spiral coil 11 adjusted by the pitch-adjusting mechanism 29 to be corrected by the fine adjustment part 29c corresponding to any tensile strength of the wire rod 1 having a predetermined thickness.

A stepped pitch-adjusting part 29e is mounted onto the adjustment board 29d above this coil discharge port 296 with around J shape. The pitch-adjusting part 29e has a dispatch guide portion 298 at a corner of a rectangular metal sheet having a predetermined thickness. The dispatch guide portion 298 is formed to have stepped shapes each like a quarter of an arc of a circle, along which plural species of the spiral coils having diameters of a coil of 8 mm, 11 mm, 14 mm and the like are moved. The pitch-adjusting part 29e also has a screw hole 299. The pitch-adjusting part 29e is attached to the screw hole 297 of the adjustment board 29d by a male screw, not shown, via the screw hole 299.

The adjustment board 29d has two screw holes 295 for engagement at predetermined positions. The adjustment board 29d is fixed to the board 21a by inserting a bolt, not shown, through the screw hole 295, the screw hole 204 of the board 21a, the screw hole 292 of the guide board 29b and the screw hole 291 of the cover board 29a and fastening it with a nut or the like at an outside of the cover board 29a. In connection with the other screw hole 295, it is fixed thereto in a similar manner. This enables the pitch-adjusting mechanism 29 to be incorporated into the board 21a.

It is to be noted that a case where four screw holes 201 and four screw holes 202 in the board 21a are formed as female screws by tapping the board 21a is shown. Of course, it is not limited thereto: if the board 21a can not maintain an enough thickness, the wire-rod-inserting guide part 26 and the wire-rod-pushing-out guide part 27 may be fixed by steel screws or a bolt-and-nut.

Further, the boards 21a and 21b shown in FIG. 4 are attached to each other via four space member 21c (only one member shown in the figure). For example, the space member 21c shown in the figure is sandwiched between each of the four screw holes 211 provided in the board 21a at predetermined positions and each of the four screw holes 211 provided in the board 21b at predetermined positions and they are fixed by a screw, not shown. It is configured that when a female screw is provided for the space member 21c, the female screw is fixed with a male screw, not shown. It is configured that when using a pipe shaped member as the space member 21c, a long bolt is used to be passed through from the board 21a to the board 21b via a pipe shaped space member to fix the boards 21a and 21b. These enable the coil-forming mechanism 20 to be assembled.

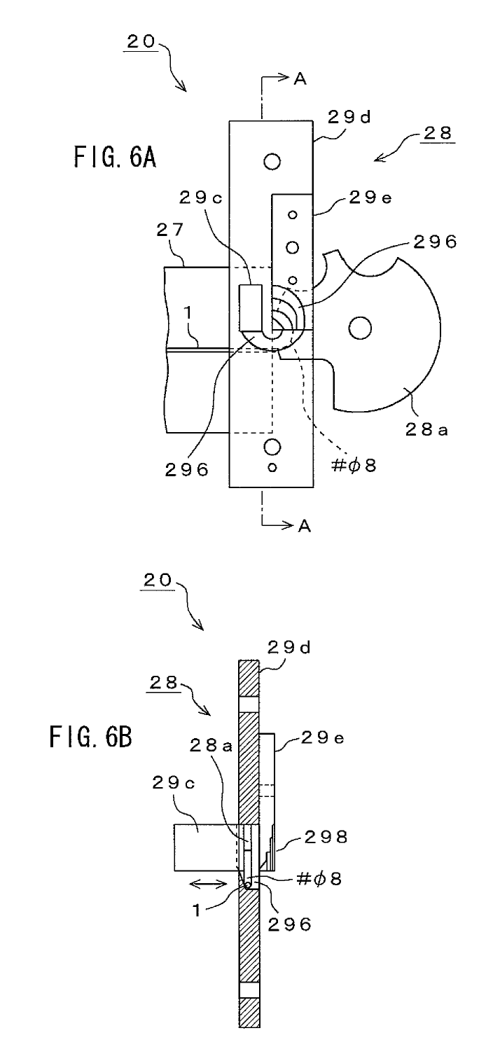

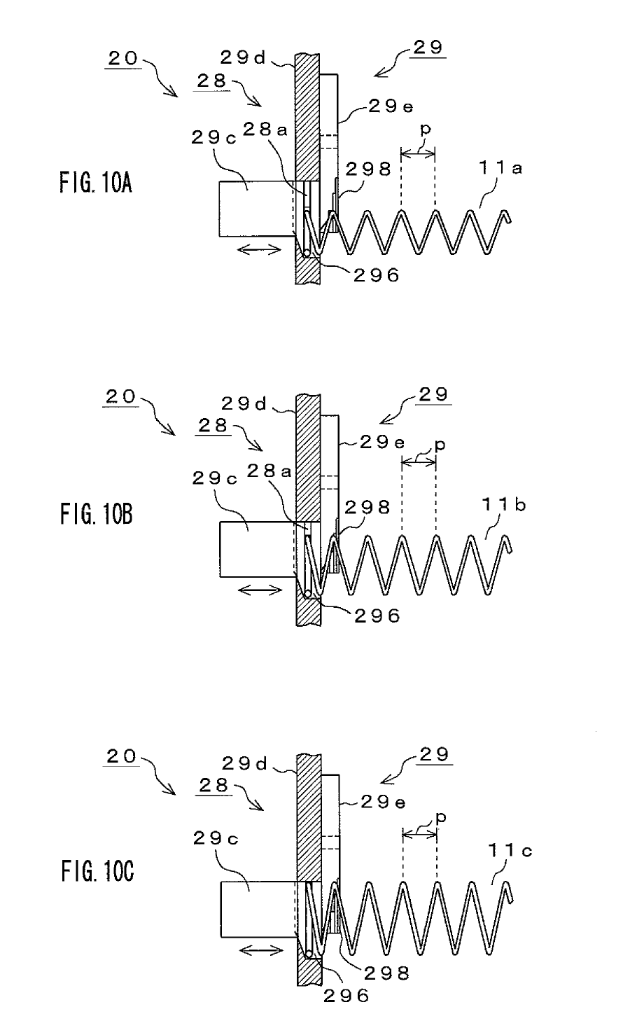

The following will describe a coil-forming example (part one to part five) according to the invention with reference to FIGS. 6 and 10. In FIGS. 6 through 9, their figures B respectively show sections taken along lines A-A of their FIG. A. In this example, the sections, #Ø14, #Ø11, #Ø8, each like an arc of a circle respectively have a pick-up function when the wire rod advances and a case where the section #Ø8 like an arc of a circle in the forming adapter 28a is selected in the coil-forming part 28 is illustrated.

The wire rod 1 pushed out of the wire-rod-pushing-out guide part 27 shown in FIG. 6A comes into contact with the section #Ø8 like an arc of a circle in the forming adapter 28a shown in the same figure. At this moment, the wire rod 1 comes into contact with a lower end of the section #Ø8 like an arc of a circle shown in FIG. 6B. This lower end is designed to act a start end when it is encircled along a circle having a diameter of 8 mm.

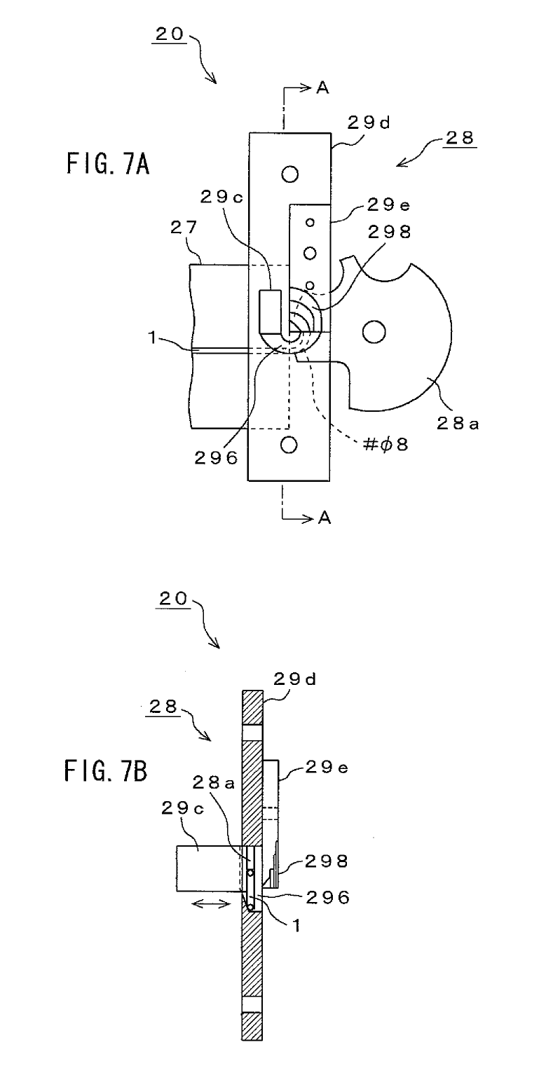

Further, when the wire rod 1 is pushed out of the wire-rod-pushing-out guide part 27 via the wire-rod-dispatching mechanism 22, the wire rod 1 shown in FIG. 7A advances so as to rotate along an inside of the section #Ø8 like an arc of a circle in the forming adapter 28a. At this moment, the wire rod 1 alters its posture to a spiral state by moving along the arc of the circle of the section #Ø8 like the arc of the circle shown in FIG. 7B. An advanced direction of the wire rod 1 at this moment is an almost reverse direction of its insertion direction.

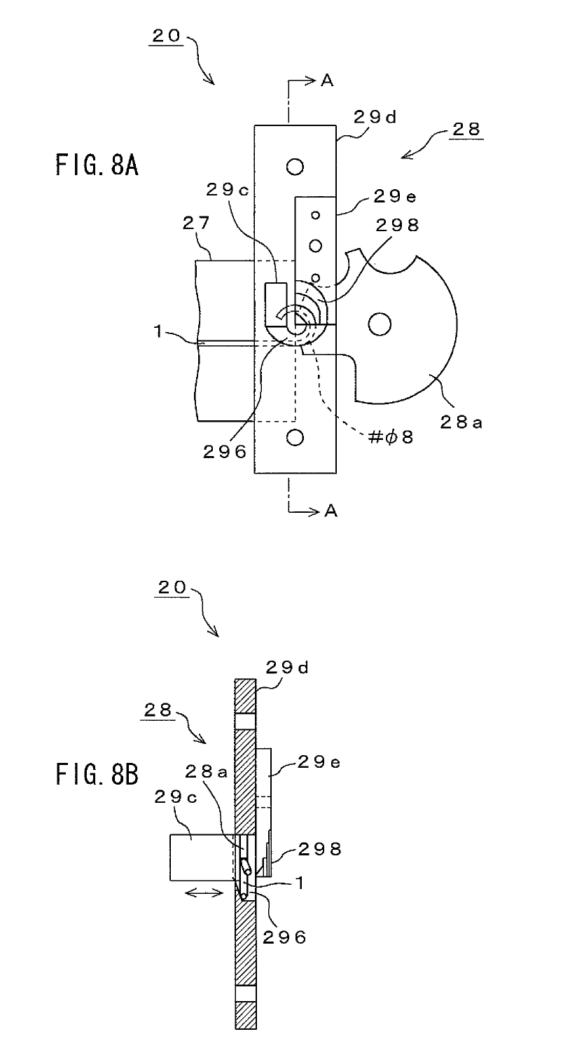

When the wire rod 1 is further pushed out of the wire-rod-pushing-out guide part 27 via the wire-rod-dispatching mechanism 22, the wire rod 1 shown in FIG. 8A rotates along the inside of the section #Ø8 like an arc of a circle in the forming adapter 28a so that a forward end portion of the wire rod 1 altered to the spiral state by the section #Ø8 like an arc of a circle is limited by a forward end of the fine adjustment part 29c shown in FIG. 8B to change its advanced direction.

At this moment, the fine adjustment part 29c is designed to adjust a discharged position of the spiral coil 11. In this example, a male screw, not shown, for pitch-fine-adjustment-correction, which is screwed with a female screw, not shown, of the cover board 29a, is adjusted so that a forward end of this male screw pushes out the fine adjustment part 29c. The fine adjustment part 29c moves inside the hollow portion consisting of the openings or port 293, 203, 273 and 296 shown in FIG. 5. In this example, when the wire rod 1 having a predetermined thickness has a strong tensile strength, the fine adjustment part 29c is adjusted so that the pitch of the spiral coil 11 can be corrected so as to be expanded. On the contrary, when the wire rod 1 having a predetermined thickness has a weak tensile strength, the pitch of the spiral coil 11 is corrected so as to be restricted.

This enables the coil pitch to be made fine adjustments. Accordingly, it is possible for fine adjustment part 29c to correct the pitch of the spiral coil 11a or the like adjusted by the pitch-adjusting mechanism 29 in correspondence with the tensile strength of the wire rod 1 having a predetermined thickness. As the result thereof, it is possible to make fine adjustments of the pitch of the spiral coil 11 (pitch adjustment correction part).

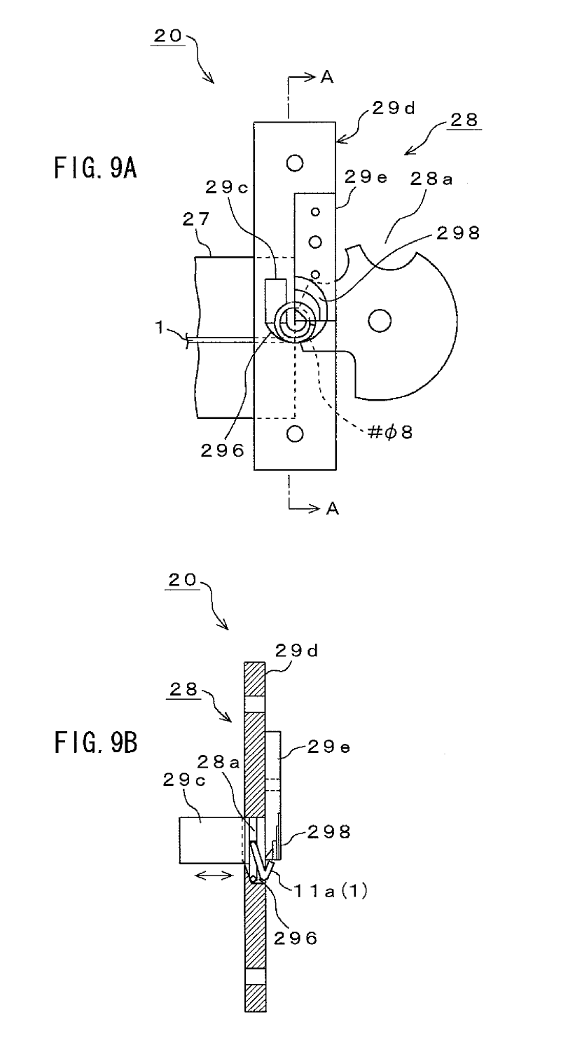

In the coil-forming mechanism 20, the spiral coil 11a is discharged to a direction (hereinafter, referred to as “coil-discharged direction”) perpendicular to the advanced direction (the insertion direction) of the wire rod 1. When the wire rod 1 is further pushed out of the wire-rod-pushing-out guide part 27 via the wire-rod-dispatching mechanism 22, the wire rod 1 shown in FIG. 9A is made discharged from the coil-discharging port 296 of the adjustment board 29d to the coil-discharged direction while it rotates (along a circle). At this moment, the wire rod 1 altered to the spiral state becomes the spiral coil 11a. The forward end thereof moves to the dispatch guide portion 298 of the pitch-adjusting part 29e shown in FIG. 9B. At this moment, the spiral coil 11a moves along the stepped shape like a quarter of an arc of a circle of the dispatch guide portion 298 for the diameter of the coil of 8 mm.

This enables the spiral coil 11a with the diameter of the coil of 8 mm to be discharged from the coil-discharging port 296 shown in FIG. 10A. It is to be noted that when selecting the section #Ø11 like an arc of a circle in the forming adapter 28a, the spiral coil 11b moves along the stepped shape like a quarter of an arc of a circle of the dispatch guide portion 298 for the diameter of the coil of 11 mm so that the spiral coil 11b having a diameter of the coil of 11 mm can be discharged from the coil-discharging port 296 shown in FIG. 10B. Similarly, when selecting the section #Ø14 like an arc of a circle in the forming adapter 28a, the spiral coil 11c moves along the stepped shape like a quarter of an arc of a circle of the dispatch guide portion 298 for the diameter of the coil of 14 mm so that the spiral coil 11c having a diameter of the coil of 14 mm can be discharged from the coil-discharging port 296 shown in FIG. 10C. This enables the coil pitch to be almost fixed.

Thus, no configuration to wind the wire rod 1 around a core member is taken in the coil-forming mechanism 20 so that it is possible to make a coil-forming configuration simplified as compared with a conventional system. In the pitch-adjusting mechanism 29, the pitch-adjusting part 29e is also provided with the dispatch guide portion 298 so that it is possible to dispatch the spiral coil 11 along the dispatch guide portion 298 from the coil-discharging port 296 of the adjustment board 29d. It is also possible to form the spiral coil 11a, 11b, 11c or the like, a pitch of which is not changed even if the diameter of the coil is changed, with a good reproducibility. Accordingly, it is possible to provide the paper-sheet-handling apparatus 100 that performs the binding processing with the pitch of the spiral coil 11 corresponding to a pitch (a pitch for bookbinding machinery) of the punched holes in the bundle of paper-sheets 3 (first paper-sheet-handling apparatus).

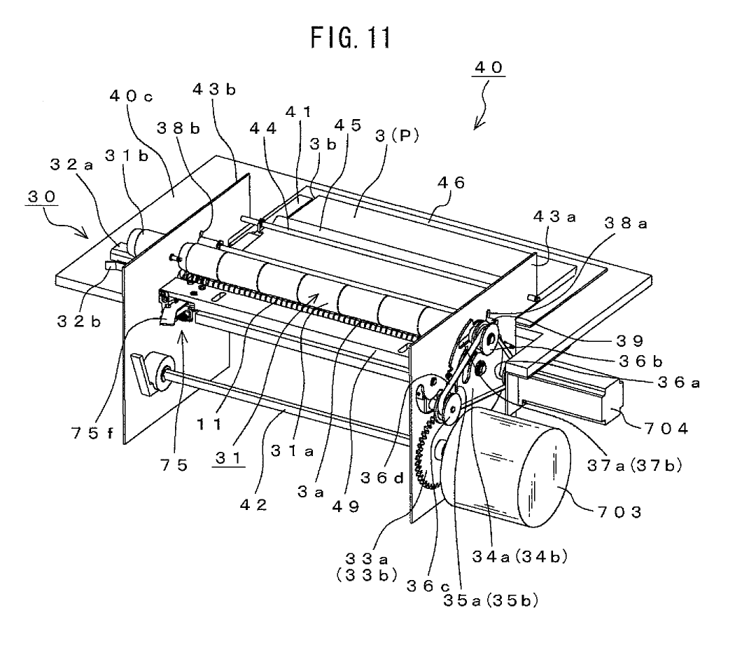

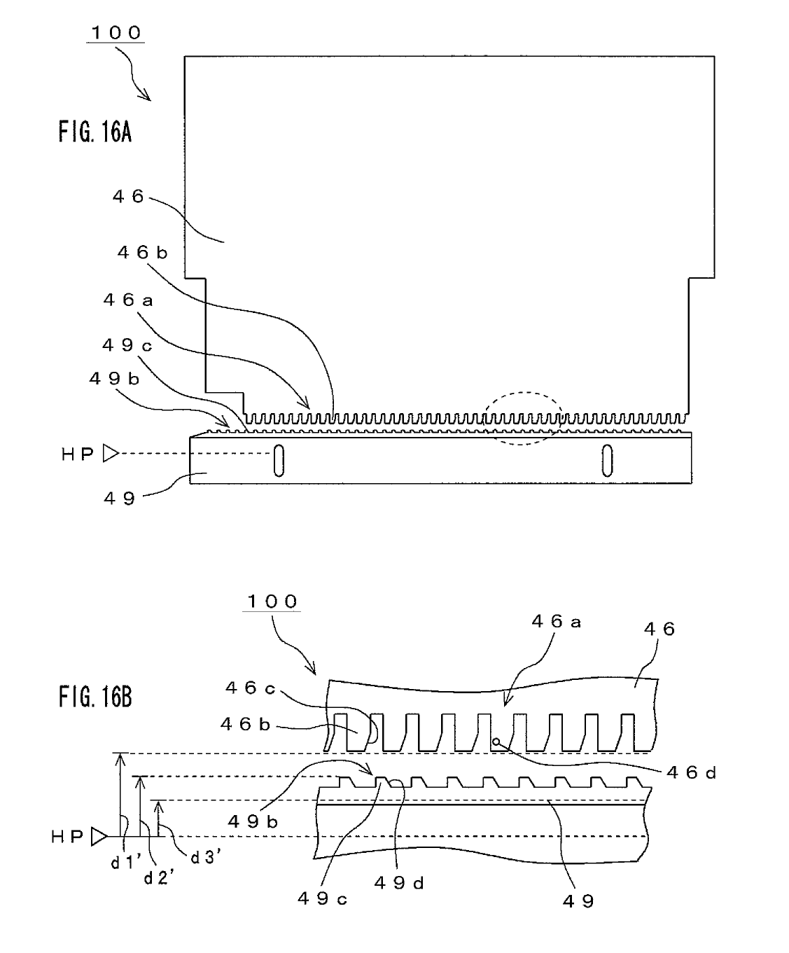

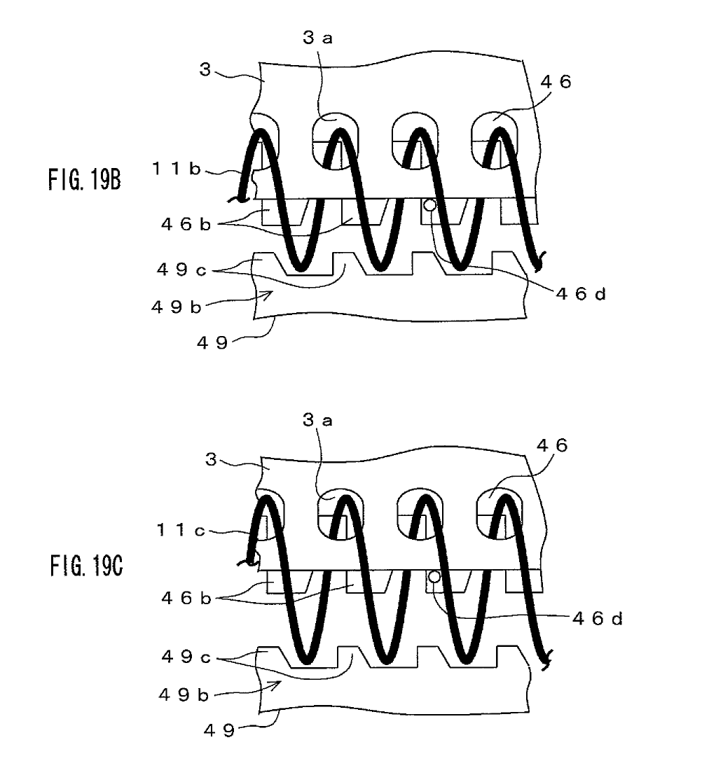

The following will describe a configuration example of the binding mechanism 40 with reference to FIG. 11. The binding mechanism 40 shown in FIG. 11 constitutes an example of the binding mechanism and has a function to receive the spiral coil 11 formed by the coil-forming mechanism 20, to guide the spiral coil 11 to the punched holes 3a of the bundle of paper-sheets 3 set on the binding mechanism 40 and to pass it therethrough. In order to realize this function, the binding mechanism 40 is provided with a feed roller 31, a main body chassis portion 40c, a paper-sheet-aligning guide 41, side surface plates 43a, 43b, a paper-sheet clamp 45, a paper-sheet-mounting base 46, a paper-sheet-attaching pin 46d (see FIG. 16B and FIG. 19), a guide 49 (hereinafter, referred to as “screw guide”) for screw adjustment, the cutting-and-bending mechanism 75 and the motors 703, 704.

An outline of the binding mechanism 40 is such that the main body chassis portion 40c is disposed almost horizontally and the side surface plate 43a and the side surface plate 43b are vertically mounted on this main body chassis portion 40c at predetermined positions, for example, a right side for side surface plate 43a and a left side for the side surface plate 43b with a predetermined space while being opposed to each other. The side surface plate 43a and the side surface plate 43b have an almost same shape. Between the side surface plate 43a and the side surface plate 43b, the paper-sheet-aligning guide 41, the paper-sheet clamp 45, the paper-sheet-mounting base 46 and the paper-sheet-attaching pin 46d (see FIG. 16B and FIG. 19) are disposed.

It is designed that these paper-sheet-mounting base 46, paper-sheet-aligning guide 41 and paper-sheet-attaching pin 46d align a plurality of paper-sheets P each having the punched holes 3a respectively to a predetermined position and the paper-sheet clamp 45 clamps the bundle of paper-sheets 3. In this example, the paper-sheet-mounting base 46 has a predetermined thickness and is disposed on the main body chassis portion 40c with it being sandwiched between the side surface plates 43a and 43b.

The paper-sheet-attaching pin 46d constitutes an example of a first paper-sheet-aligning part and is mounted on a forward end portion of the screw guide 46a of the paper-sheet-mounting base 46 at the fixed side to limit the bundle of paper-sheets 3 mounted on the paper-sheet-mounting base 46 so as to align an end at the punched hole side of each of the paper-sheets P.

The paper-sheet-aligning guide 41 constitutes an example of a second paper-sheet-aligning part and is mounted on one side of the paper-sheet-mounting base 46. In this example, assuming that a portion of the paper-sheet P in which the punched holes 3a are perforated is a forward end thereof and a portion of the paper-sheet P which is perpendicular to this forward end is a side edge 3b thereof, the paper-sheet-aligning guide 41 limits the bundle of paper-sheets 3 on the paper-sheet-mounting base 46, which has been limited by the paper-sheet-attaching pin 46d, so as to align the side edge 3b of each of the paper-sheets P.

The paper-sheet clamp 45 is supported by a supporting rod 44 at a paper-sheet-receiving side thereof and the supporting rod 44 is attached to the side surface plates 43a, 43b. The paper-sheet clamp 45 is also attached to the side surface plates 43a, 43b at its paper-sheet-pressing side that is opposed to the paper-sheet-receiving side with a linking rod 39 being able to move up and down. For example, when the paper-sheet P advances to the paper-sheet-mounting base 46, the paper-sheet clamp 45 moves the linking rod 39 to an upper direction (an anti-vertical direction) with the supporting rod 44 being a rotation axis thereof and moves the linking rod 39 to a lower direction (a vertical direction) after the paper-sheet advances thereto, thereby clamping the paper-sheet P.

It is to be noted that a multi-puddle rotation member, not shown, may be used for aligning, for example, the forward end and the side end of the paper-sheet P to a reference position when the paper-sheet P advances to the paper-sheet-mounting base 46. Applying such a rotation member enables the paper-sheet P to be forced to move to a rotation direction thereof. Thus, the side edge 3b of the paper-sheet P having the punched holes 3a is collided with the paper-sheet-aligning guide 41 and the side at the punched holes 3a of the paper-sheet P is collided with the paper-sheet-attaching pin 46d so that the paper-sheet P can be aligned to the reference position thereof.

In this example, the motor 703 functioning as an example of the driving part is mounted on a predetermined left lower position of the side surface plate 43a. To a driving shaft of the motor 703, a gear 33a is connected; with the gear 33a, a guide-switching cam 34a is engaged; and with the guide-switching cam 34a, an end of the feed roller 31 functioning as an example of a rotation guide part and an end of the screw guide 49 configuring an example of the contact guide part are engaged.

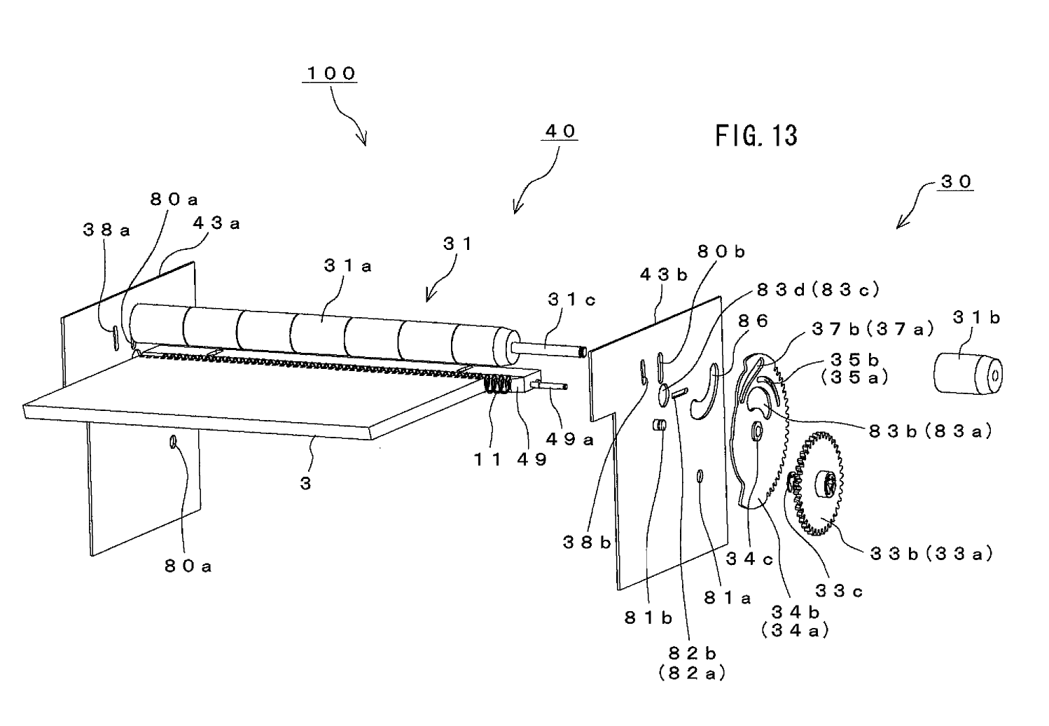

The screw guide 49 has a movement that is limited by curved long cam openings 35a, 35b provided in the guide-switching cams 34a, 34b and horizontal long openings 82a, 82b provided in the side surface plates 43a, 43b (see FIG. 13). By rotating the guide-switching cams 34a, 34b, the screw guide 49 has a movement direction that is limited on the horizontal direction thereof by the horizontal long openings 82a, 82b and moves back and forth along cam surfaces of the curved long cam openings 35a, 35b.

The feed roller 31 is constituted of a pressing roller 31a and a pick-up roller 31b. The pressing roller 31a is rotatably supported between the side surface plate 43a of the right side and the side surface plate 43b of the left side. The pressing roller 31a is provided along the advanced direction of the spiral coil 11 and is mounted so as to bridge the side surface plates 43a, 43b of the right and left sides.

The feed roller 31 has a movement that is limited by long cam openings 37a, 37b provided in the guide-switching cams 34a, 34b and second vertical long openings 80a, 80b provided in the side surface plates 43a, 43b (see FIG. 13). Any force is always applied to the feed roller 31 toward the vertical direction by a belt 36d passing around a driven pulley 36b attached to a forward end of the feed roller 31. By rotating the guide-switching cams 34a, 34b, the feed roller 31 moves up and down along cam surfaces of the long cam openings 37a, 37b while the movement direction thereof is limited by the vertical long openings 80a, 80b on the vertical direction.

Further, to a shaft core of the gear 33a, an end of a rectangular link rod 42 is connected. To the other end of the rectangular link rod 42, a shaft core of the gear 33b is connected; with this gear 33b, the guide-switching cam 34b is engaged; and with the guide-switching cam 34b, the other end of the feed roller 31 and the other end of the screw guide 49 are engaged.

In this example, when rotating the motor 703, the guide-switching cams 34a, 34b rotate through the gears 33a, 33b. By rotating the guide-switching cams 34a, 34b, positions of the feed roller 31 and the screw guide 49, both ends of which are engaged with the guide-switching cams 34a, 34b, are adjusted.

The motor 704 functioning as an example of driving part is mounted onto the side surface plate 43a at a predetermined right lower position thereof. To a driving shaft of the motor 704, a pulley 36a is connected and the belt 36d passes around the pulley 36a. This belt 36d passes around the driven pulleys 36b, 36c. To the driven pulley 36b, the feed roller 31 is connected. By rotating the motor 704, the pulley 36a connected to the driving shaft of the motor 704 rotates so that the belt 36d passing around the pulley 36a rotates and the driven pulley 36b rotates. This rotates the feed roller 31 connected to the driven pulley 36b.

The feed roller 31 dispatches the spiral coil 11 to the punched holes 3a of the bundle of paper-sheets 3 mounted on the paper-sheet-mounting base 46 with it rotating and guides the spiral coil 11 to the punched holes 3a of the bundle of paper-sheets 3. For example, it is configured that the feed roller 31 is constituted of the cylinder-shaped pressing roller 31a and a rotation shaft rod 31c and contacts the spiral coil 11 so that the spiral coil 11 rotates to a fixed direction.

The pressing roller 31a constitutes an example of rotation member and is attached to the rotation shaft rod 31c. Assuming that a side of the paper-sheet P relating to a portion of the paper-sheet P in which the punched holes 3a are provided is a length of the paper-sheet, the pressing roller 31a has a length longer than the length of the paper-sheet. It is to be noted that it may have one that is slightly shorter than the length of paper-sheet if it has almost same length as the length of the paper-sheet. The pressing roller 31a is disposed with them being sandwiched between the side surface plates 43a, 43b to guide the spiral coil 11 received from the pick-up roller 31b of the linking part 30 to the punched holes 3a of the paper-sheet P of the spiral coil 11.

For example, the pressing roller 31a comes into contact with a part of an outer circumference of the spiral coil 11 to rotate and guide the spiral coil 11 with it being pressed onto the paper-sheet-mounting base 46. It is to be noted that for the pressing roller 31a and the pick-up roller 31b, any material having large frictional force with respect to the spiral coil 11 such as silicon rubber and natural rubber is used. These structures and parts enable the binding mechanism 40 to be configured. It is to be noted that the pressing roller 31a may be one long rod-like roller or one in which short rollers each partitioned to have a fixed length are arranged in series.

Further, according to the binding mechanism 40 shown in FIG. 11, there is a state where the bundle of paper-sheets 3 is mounted on the paper-sheet-mounting base 46 and the spiral coil 11 is passed through the bundle of paper-sheets 3. In order to reach this state, the paper-sheet clamp 45 first clamps paper-sheets of predetermined numbers. For example, the paper-sheets are received to mount them on the paper-sheet-mounting base 46 while the linking rod 39 of the paper-sheet clamp 45 that is inserted into the first vertical long openings 38a, 38b provided in the side surface plates 43a, 43b is lifted by the cam surfaces of the guide-switching cams 34a, 34b to the anti-vertical direction, namely, a paper-sheet-pressing side of the paper-sheet clamp 45 is lifted up.

Next, by driving the motor 703 after the paper-sheets of predetermined numbers are mounted thereon, the guide-switching cams 34a, 34b rotate via the gears 33a, 33b so that the linking rod 39 of the paper-sheet clamp 45 lifted by the cam surfaces of the cams falls down by limiting its movement direction by the vertical long openings 38a, 38b. Accordingly, the paper-sheet-pressing side of the paper-sheet clamp 45 moves to a vertical direction and the paper-sheet clamp 45 comes into contact with the bundle of paper-sheets 3 at a predetermined position to clamp the bundle of paper-sheets 3 by pressing it on the paper-sheet-mounting base 46 with weight of the paper-sheet clamp 45. It is to be noted that if the bundle of paper-sheets 3 is clamped, any force of a spring or the like may be acted thereto and the bundle of paper-sheets 3 may be pressed by the force applied by the spring in addition to the weight of the paper-sheet clamp 45.

Thus, according to the feed roller 31 and the screw guide 49 shown in FIG. 11, they are configured so as to be adjusted to a position corresponding to the diameter of the spiral coil 11 passing through the bundle of paper-sheets 3. At the adjusted position, it is configured that the spiral coil 11 is limited on its movement direction and supported by three points of the pressing roller 31a of the feed roller 31, the screw guide 49 and the main body chassis portion 40c.

It is configured that the binding mechanism 40 is provided with the cutting-and-bending mechanism 75, which constitutes an example of a function of cutting part, that cuts the spiral coil 11 of the bundle of paper-sheets 3 on which the binding mechanism 40 performs the binding processing, at a predetermined position thereof. The cutting-and-bending mechanism 75 is mounted on a predetermined position of the binding mechanism 40, for example, near the side surface plate 43b and under an end of the screw guide 49 and has a cutting-and-bending function to bend an end of the spiral coil 11 cut at this position.

The cutting-and-bending mechanism 75 has a lever 75f and cuts a rear end of the spiral coil 11 by moving this lever 75f to a predetermined direction. Under the existing circumstance, a mechanism such that the lever 75f is acted by hand is introduced. Of course, the lever 75f may be acted by a cam, not shown, or the like. Providing the binding mechanism 40 with such a cutting-and-bending mechanism 75 does not only make a foreign matter difficult to be caught by the end of the spiral coil 11 but also make the cut portion thereof be well attractive (second paper-sheet-handling apparatus).

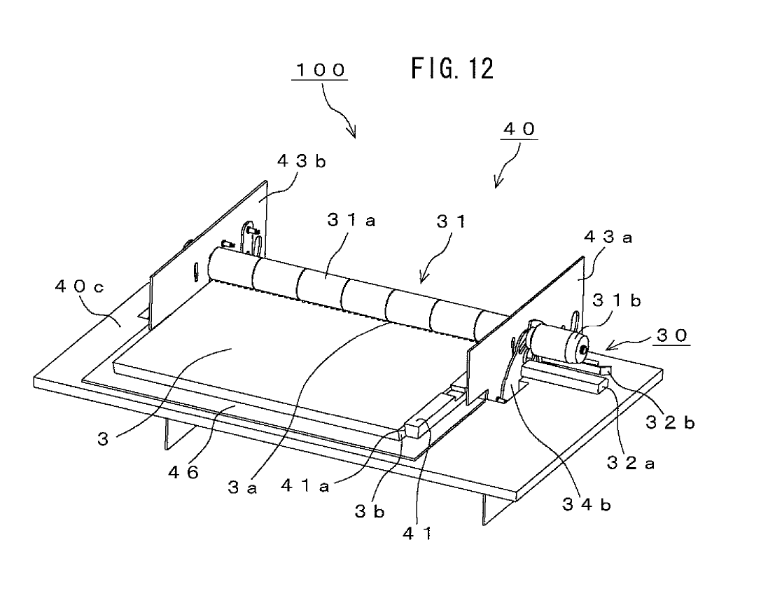

Next, a description will be given of a configuration example of the linking part 30 and its peripheral mechanism in the paper-sheet-handling apparatus 100 with reference to FIGS. 12 through 15. The linking part 30 shown in FIG. 12 is a part linking the coil-forming mechanism 20 with the binding mechanism 40 shown in FIG. 1. The linking part 30 is configured to have the pick-up roller 31b, an introduction guide section 32a and a coil-introducing wall 32b. The linking part 30 has a coil-introducing port (opening) 83d shown in FIG. 13. The coil-introducing port 83d is provided on a side surface of the binding mechanism 40. In this example, the coil-forming mechanism 20 and the binding mechanism 40 are assembled so that a coil-advancing direction of the coil-forming mechanism 20 corresponds to an opening center of the coil-introducing port 83d provided on the binding mechanism 40.

The above-mentioned pick-up roller 31b is attached to an end of the pressing roller 31 of the feed roller 31 in the binding mechanism 40 and is configured to rotate to a direction that is identical with that of the pressing roller 31a and to move up and down to a direction that is identical with that of the pressing roller 31a. For the pick-up roller 31b, a roller member having the same quality of material as that of the pressing roller 31a of the binding mechanism 40 is used. The pick-up roller 31b is also processed so that its end surface is shaped to a truncated cone, which is similar to the pressing roller 31a of the binding mechanism 40. In this example, the pick-up roller 31b, an external form of which is one size smaller than the pressing roller 31a of the binding mechanism 40, is used. This is because the pick-up of the spiral coil 11a or the like is facilitated.

The introduction guide section 32a and the coil-introducing wall 32b are disposed with them being opposed to each other on the main body chassis portion 40c under the pick-up roller 31b. For the introduction guide section 32a, for example, a plastic molding in which an edge thereof that is opposite to the coil-introducing wall 32b is planed off is used. For the coil-introducing wall 32b, a sheet metal processed item in which an edge thereof that is opposite to the coil-forming mechanism 20 is processed so as to be bent into the shape of an unfolded fan is used. This is because the pick-up of the spiral coil 11a or the like is facilitated, which is similar to the pick-up roller 31b.

The paper-sheet-aligning guide 41 shown in FIG. 12 is mounted on the paper-sheet-mounting base 46 at a predetermined position by screws or the like. The paper-sheet-aligning guide 41 has a paper-sheet-aligning surface 41a with a designated inclination with respect to a surface of the paper-sheet-mounting base 46, on which the paper-sheets P are mounted, and is configured to limit a side end of the bundle of paper-sheets 3 obliquely along the inclination of the paper-sheet-aligning surface 41a. Making the paper-sheet-aligning surface 41a inclined is because a forward end of the spiral coil 11 faces obliquely and advances in the punched holes 3a on a structure of the spiral coil 11 when the spiral coil 11 passes through the punched holes 3a of the bundle of paper-sheets 3 with it rotating so that the punched holes 3a of the bundle of paper-sheets 3 are aligned in accordance with the inclination when the forward end of the spiral coil 11 advances (see FIG. 24).

Here, a description will be given of an assembled example of main parts of a side of the linking part 30 of the binding mechanism 40 with reference to FIG. 13. The binding mechanism 40 shown in FIG. 13 shows only the main parts in order to make understanding of parts configuration thereof easy. These main parts are the feed roller 31, the screw guide 49, the side surface plates 43a, 43b, the guide-switching cam 34b and the gear 33b. In addition to these main parts, the spiral coil 11 and the bundle of paper-sheets 3 are disposed.

When assembling these main parts, for the side surface plate 43a, an end of the rotation shaft rod 31c inserted into the pressing roller 31a of the feed roller 31 is first inserted into the vertical long opening 80a of the side surface plate 43a and an end of a shaft rod 49a provided on the screw guide 49 is inserted into the horizontal opening 82a of the side surface plate 43a. Similarly, for the side surface plate 43b, the other end of the rotation shaft rod 31c of the pressing roller 31a is inserted into the vertical long opening 80b of the side surface plate 43b and the other end of the shaft rod 49a provided on the screw guide 49 is inserted into the horizontal opening 82b of the side surface plate 43b.

Next, for the side surface plate 43b, an engaging portion 33c of the gear 33b is engaged with an hole 81a of the side surface plate 43b and an engaging portion 34c of the guide-switching cam 34b is engaged with a projection portion 81b of the side surface plate 43b. At this moment, the rotation shaft rod 31c inserted into the vertical long opening 80b is engaged with the cam opening 37b of the guide-switching cam 34b and the shaft rod 49a inserted into the horizontal opening 82b is engaged with the curved long cam opening 35b. Similarly, for the side surface plate 43a, the guide-switching cam 34a and the gear 33a are engaged. The pressing roller 31a of the linking part 30 is then press-fitted and fixed to the rotation shaft rod 31c of the feed roller 31.

By thus assembling the main parts of the binding mechanism 40 at the side of linking part 30 and rotating the guide-switching cams 34a, 34b with the gears 33a, 33b, the feed roller 31 moves vertically corresponding to shapes of the vertical long openings 80a, 80b and the screw guide 49 moves horizontally corresponding to shapes of the horizontal long openings 82a, 82b. It is to be noted that with the vertical long openings 38a, 38b, the linking rod 39 of the paper-sheet clamp 45 shown in FIG. 11 is engaged. With an opening portion 86 of the side surface plate 43b, the driven pulley 36c shown in FIG. 11 is engaged.

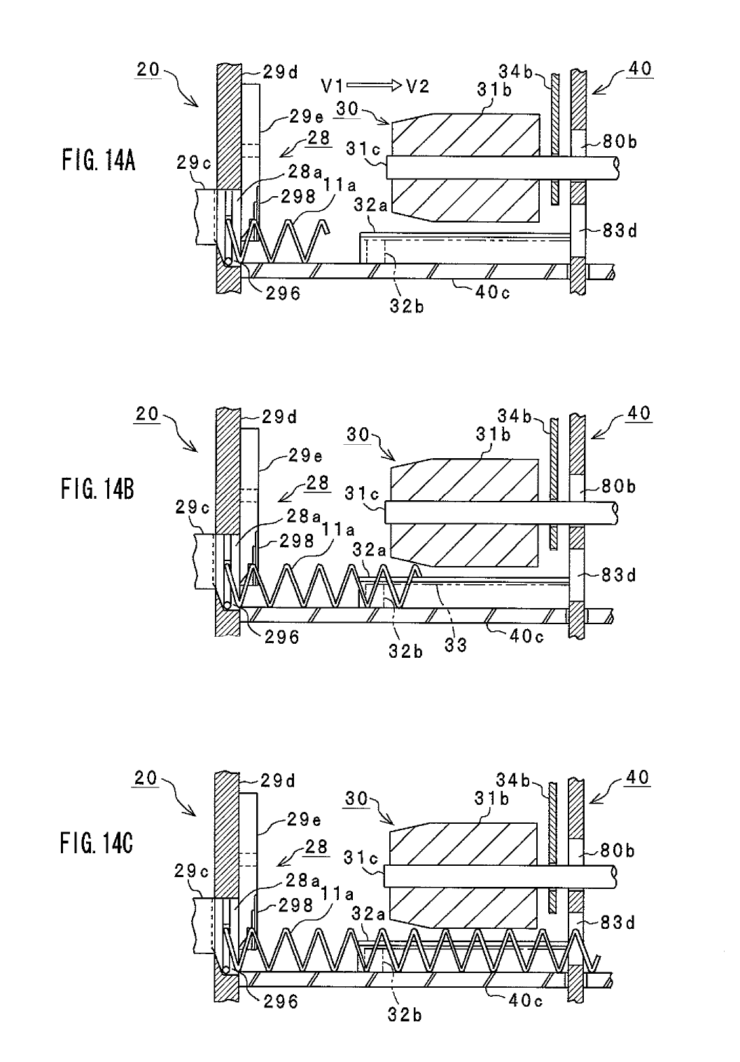

Next, a description will be given of a function example of the linking part 30 of the paper-sheet-handling apparatus 100 with reference to FIGS. 14A through 14C. In this example, a case where the spiral coil 11a having the diameter of the coil of 8 mm is formed in the coil-forming mechanism 20 is taken. In this case, the binding mechanism 40 sets (makes) the pressing roller 31a (fall) to a corresponding position of the diameter of the coil of 8 mm.

The spiral coil 11a formed in the coil-forming mechanism 20 shown in FIG. 14A moves to the coil-advancing direction with it rotating clockwise. At this moment, the pick-up roller 31b rotates counter-clockwise, which is similar to that of the pressing roller 31a of the binding mechanism 40. Assuming that a rotation speed of the spiral coil 11 dispatched from the coil-forming part 28 is V1 and a rotation speed of the spiral coil 11 in the binding mechanism 40 is V2, it is set to V1<V2. This speed setting is performed so that the spiral coil 11 passes through the punched holes 3a of the bundle of paper-sheets 3 smoothly.

When the spiral coil 11a formed in the coil-forming mechanism 20 shown in FIG. 14B is further pushed out, the spiral coil 11a keeps on moving to the coil-advancing direction with it rotating clockwise. In this example, it is configured that early in the coil introduction, the main body chassis portion 40c limits a vibration onto a lower portion of the spiral coil 11a and the introduction guide section 32a and the coil-introducing wall 32b limit a vibration onto right and left of the spiral coil 11a. It is configured that a part of the pick-up roller 31b, which has a truncated cone shape, limits a vibration onto an upper portion of the spiral coil 11a gradually.

When the spiral coil 11a formed in the coil-forming mechanism 20 shown in FIG. 14C is further pushed out, the spiral coil 11a keeps on moving to the coil-advancing direction with it rotating clockwise. In this example, it is configured that late in the coil introduction, an outer peripheral part of the pick-up roller 31b, the introduction guide section 32a and the coil-introducing wall 32b respectively limit a vibration onto the upper portion of the spiral coil 11a and a vibration onto right and left thereof. Under this limited condition, the forward end of the spiral coil 11a is inserted into an opening on a side surface of the binding mechanism 40.

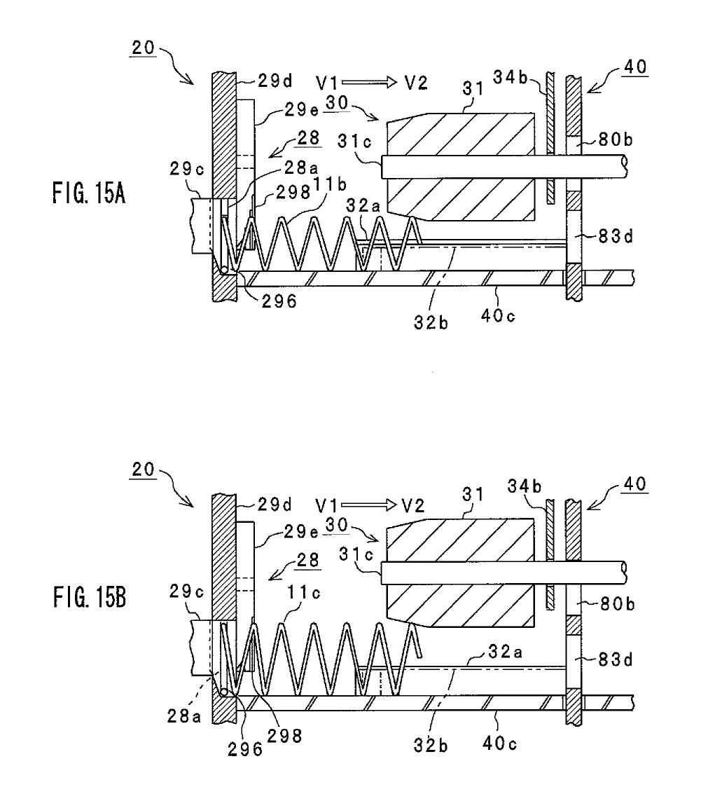

Here, a description will be given of a function example of the linking part 30 of the paper-sheet-handling apparatus 100 for other diameters of the coils with reference to FIGS. 15A and 15B. According to the linking part 30 shown in FIG. 15A, a case where the spiral coil 11b having a diameter of the coil of 11 mm is formed in the coil-forming mechanism 20 is illustrated. In this case, the binding mechanism 40 sets the pressing roller 31a to a corresponding position of the diameter of the coil of 11 mm. In this example, it is also configured that early in the coil introduction, the main body chassis portion 40c limits a vibration onto a lower portion of the spiral coil 11b and the introduction guide section 32a and the coil-introducing wall 32b limit a vibration onto right and left of the spiral coil 11b. It is configured that late in the coil introduction, an outer peripheral part of the pick-up roller 31b, the introduction guide section 32a and the coil-introducing wall 32b respectively limit upward and downward or right and left vibrations on the spiral coil 11b.

According to the linking part 30 shown in FIG. 15B, a case where the spiral coil 11c having a diameter of the coil of 14 mm is formed in the coil-forming mechanism 20 is illustrated. In this case, the binding mechanism 40 sets the pressing roller 31a to a corresponding position of the diameter of the coil of 14 mm. In this example, it is also configured that early in the coil introduction, the main body chassis portion 40c limits a vibration onto a lower portion of the spiral coil 11c and the introduction guide section 32a and the coil-introducing wall 32b limit a vibration onto right and left of the spiral coil 11c. It is configured that late in the coil introduction, an outer peripheral part of the pick-up roller 31b, the introduction guide section 32a and the coil-introducing wall 32b respectively limit upward and downward or right and left vibrations on the spiral coil 11c.

Thus, it is configured that the linking part 30 is provided between the coil-forming mechanism 20 and the binding mechanism 40 and the spiral coil 11a or the like having a predetermined diameter of the coil dispatched from the coil-forming mechanism 20 is guided to the opening of the binding mechanism 40 with its upward and downward and/or right and left movements being gradually limited corresponding to its configuration. In this example, it is designed that the forward end of the spiral coil 11a or the like is picked up by the pick-up roller 31b, the introduction guide section 32a and the coil-introducing wall 32b so that even if there is the spiral coil 11c (having a large diameter), the spiral coil 11b (having a middle diameter) or the spiral coil 11a (having a small diameter), having different diameters of the coils, each of which is selected based on the thickness of the bundle of paper-sheets 3 and formed, it is possible to introduce the spiral coil 11a, 11b or 11c having a desired diameter of the coil, which is dispatched from the coil-forming mechanism 20, to the binding mechanism 40 with a good reproducibility.

Next, a description will be given of a configuration example of convex teeth 46b of a screw guide 46a (fixed side) and a guide projection portion 49b of the screw guide 49 (movable adjustment side) with reference to FIGS. 16A and 16B. It is configured that the screw guide 46a shown in FIG. 16A constitutes a function of a second screw guide part and is provided on a side of the paper-sheet-mounting base 46 on the main body chassis portion 40c (see FIG. 12), so that this side is processed to become like comb-teeth. This screw guide 46a has plural convex teeth 46b and forms the comb-teeth shape along a width-direction of the bundle of paper-sheets 3. Each of the convex teeth 46b is disposed so as to fit an opening pitch of the 49 punched holes 3a in the bundle of paper-sheets 3. The screw guide 46a limits a left side of each of the plural kinds of the spiral coils 11 along their advanced directions. It is to be noted that the convex teeth 46b forming like the comb-teeth are processed so as to be inclined for adjustment of the advanced direction thereof in order to guide the forward end of the spiral coil 11 smoothly. This enables the spiral coil 11 to be smoothly guided.

In this example, a coil (spiral) pitch of the spiral coil 11 is formed so as to fit the opening pitch of the punched holes 3a. The spiral coil 11 advances by one pitch for every turn. The one pitch of the spiral coil 11 is around 6 mm regardless of the diameter of the coil. This is because the opening pitch of the punched holes 3a is fixed regardless of the diameter of the coil. Therefore, it is configured that the bundle of paper-sheets 3 is aligned obliquely and the inclination thereof is made fixed without being influenced by the thickness of the paper. In other words, it is configured so as to align the punched holes 3a obliquely.

The screw guide 49 is movably attached to a position that faces the screw guide 46a of the paper-sheet-mounting base 46 and adjusts the advanced direction of the spiral coil 11 in accordance with the plural diameters of the coils. In this example, it is configured that the screw guide 49 limits a right side of the spiral coil 11 along the advanced direction thereof with its wall. The screw guide 49 has the guide projection portion 49b that forms short comb-teeth along a width direction of the bundle of paper-sheets 3, which is similar to the screw guide 46a.

The guide projection portion 49b is provided at portions of the screw guide 49 with which the spiral coil 11 comes in to contact. The guide projection portion 49b has plural projections 49c corresponding to the coil pitch of the spiral coil 11 and guides the spiral coil 11 with it contacting between the projection 49c and the projection 49c. In this example, an inclination process for adjustment of the advanced direction is performed in order to guide the forward end of the spiral coil 11 smoothly. For the screw guide 49, a piece of metal that has predetermined length and thickness and is processed to become the short comb-teeth is used.

In this example, the screw guide 49 is designed to have a thickness thicker than that of the screw guide 46a in order to make a wall surface at a right side along the advanced direction of the spiral coil 11. For example, the thickness of the screw guide 49 is set so as to be two through seven times as thick as the thickness of the screw guide 46a. The screw guide 49 moves right or left corresponding to the coil diameter of the spiral coil 11. Home position HP is prescribed in the screw guide 49 which is configured to change its position from the home position HP corresponding to the diameter of the coil. In this example, it changes its position to three stages (three postures) corresponding to the diameters of the coils of 8 mm, 11 mm and 14 mm.

This enables the spiral coil 11 to be supported by three points of the pressing roller 31a, the screw guide 46a and the screw guide 49. The pressing roller 31a operates to rotate the spiral coil 11, to allow the coil to be moved through the punched holes of the bundle of paper-sheets 3 so that it sews the bundle of paper-sheets 3 and to dispatch it from one end of the bundle of paper-sheets to the other end thereof (on the width direction thereof). As a result of this operation, it is made possible to perform the binding processing on the bundle of paper-sheets 3 by the spiral coils 11 having plural diameters of the coils with stability by the spiral coil 11.

FIG. 16B is an enlarged view showing a configuration example of the screw guide 46a (fixed side) and the guide projection portion 49b, which stay in a dashed line circle shown in FIG. 16A. The convex-teeth 46b shown in FIG. 16B are formed as a board shape having cut-away portions 46c. These cut-away portions 46c are provided along the advanced direction of the spiral coil 11. This is because the spiral coil 11 is prevented from being contacted with the convex-teeth 46b when the spiral coil 11 enters into the screw guide 46a.

The projections 49c of the guide projection portion 49b are formed so that each of them has a sectional trapezoidal shape including an inclined section 49d. This inclined section 49d is provided along the advanced direction of the spiral coil 11. This is because the spiral coil 11 is prevented from being contacted with the projections 49c when the spiral coil 11 enters into the guide projection portion 49b.

Although for the screw guide 46a (fixed side), the all-in-one parts in which an end of the paper-sheet-mounting base 46 having predetermined size and thickness is processed so as to become the comb-teeth has been described in this example, it is not limited thereto: a single part processed so as to become the comb-teeth separately from the main body chassis 40c and combined therewith may be used. For example, a part in which a plurality of partitioned boards each having a set length, a side of which is processed so as to become short comb-teeth, is arranged in series may be used.

In this example, when setting a position of the spiral coil 11a having a small diameter, the screw guide 49 moves from the home position HP to a direction in which it comes close to the punched holes 3a of the bundle of paper-sheets 3 by a first distance d1'; when setting a position of the spiral coil 11b having a middle diameter, the screw guide 49 similarly moves to a direction of the punched holes 3a of the bundle of paper-sheets 3 by a second distance d2′; and when setting a position of the spiral coil 11 having a large diameter, the screw guide 49 similarly moves to a direction of the punched holes 3a of the bundle of paper-sheets 3 by a first distance d3′ (d1′>d2′>d3′). This enables the binding mechanism 40 to adjust the position of the screw guide 49 after the clamping.

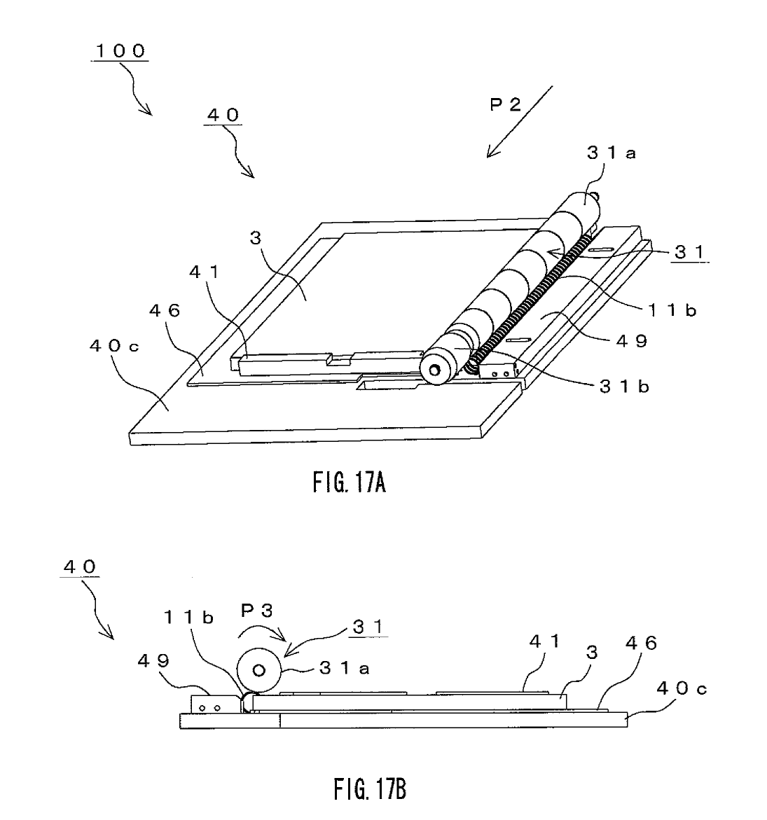

The following will describe a supporting example of the spiral coil 11b having a middle diameter with reference to FIGS. 17 through 19. It is configured that the spiral coil 11b shown in FIG. 17A passes through the punched holes 3a of the bundle of paper-sheets 3 and is supported by three points of the pressing roller 31a, the screw guide 49 and the main body chassis portion 40c.

FIG. 17B is a configuration view showing a supporting example of the spiral coil 11b shown in FIG. 17A as seen from a direction of an arrow P2. The spiral coil 11b shown in FIG. 17B comes into contact with the pressing roller 31a of the feed roller 31 on its upper end portion, the lower end portion of the spiral coil 11b is supported by the main body chassis 40c and the forward end of the spiral coil 11b is supported by the screw guide 49.

By rotating the feed roller 31 to a direction of an arrow P3, the spiral coil 11b with which the pressing roller 31 of the feed roller 31 comes into contact rotates to a direction opposite to the direction of the arrow P3 with it being supported by the screw guide 49 and the main body chassis 40c and advances toward the posterior punched holes 3a to passes through all of the punched holes 3a of the bundle of paper-sheets 3 mounted on the paper-sheet-mounting base 46 of the main body chassis portion 40c. Although the supporting example of the spiral coil 11b having the middle diameter has been described in this example, the spiral coils 11a, 11c having small and large diameters are also supported similarly.

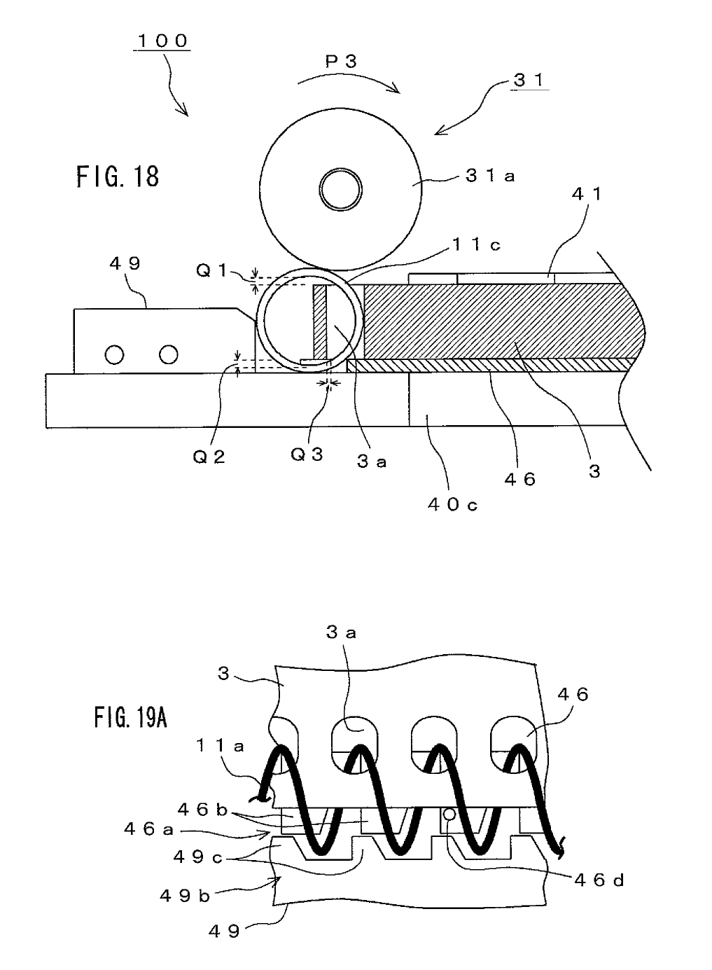

Next, a description will be given of clearance examples between the spiral coil 11c having the large diameter and each of the punched holes 3a of the bundle of paper-sheets 3 with reference to FIG. 18. According to the supporting example of the spiral coil 11c having the large diameter shown in FIG. 18, there shows a state in which it passes through the punched holes 3a of the bundle of paper-sheets 3 of around 71 through 100 sheets. In this state, it is assumed that a space between an upper end portion of the bundle of paper-sheets 3 and an upper end portion of an inside diameter of the spiral coil 11c is a clearance Q1 and a space between a lower end portion of the bundle of paper-sheets 3 and a lower end portion of the inside diameter of the spiral coil 11c is a clearance Q2. Further, a space between an outer circumference of an opening of each of the punched holes 3a of the bundle of paper-sheets 3 and the spiral coil 11c is assumed at a clearance Q3.

In this example, it is most difficult to keep the clearances Q1 through Q3 when the spiral coil 11c having the large diameter passes through the punched holes 3a of the bundle of paper-sheets 3 of around 71 through 100 sheets. It is configured that the clearances Q1 through Q3 can be kept at this moment, such that the spiral coil 11c can pass through the punched holes 3a of the bundle of paper-sheets 3 even if any variations of paper alignment, a common difference in a part plan, forming variations when forming the coil and the like are added.

The spiral coil 11c having the large diameter, in which it is most difficult to keep the clearances Q1 through Q3, can pass through the punched holes 3a so that the spiral coils 11a, 11b having middle and small diameters also can pass through the punched holes 3a. It is to be noted that a thickness of the paper-sheet-mounting base 46 is designed so as to keep the clearances Q1, Q2 having same extent. In this example, the thickness of the paper-sheet-mounting base 46 is about 2 mm.

Next, a description will be given of supporting examples of the spiral coils 11a through 11c with reference to FIGS. 19A through 19C. In this example, it indicates functions of the paper-sheet-mounting base 46 and the coil-supporting part (the screw guide 46a and projections 49c) in the screw guide 49. The bundle of paper-sheets 3 constituted of paper-sheets of 40 sheets or less is mounted on the paper-sheet-mounting base 46 shown in FIG. 19A and the spiral coil 11a having the small diameter passes through the punched holes 3a of this bundle of paper-sheets 3.

Thus, in order to pass the spiral coil 11a through each of the punched holes 3a, the screw guide 49 and the feed roller 31 shown in FIG. 18 are first disposed at predetermined positions thereof. For example, the position of the screw guide 49 is disposed on the position (the distance d1′ shown in FIG. 16B) in which it comes into contact with the spiral coil 11a. It is to be noted that the position of the paper-sheet-mounting base 46 is fixed.

The feed roller 31 next dispatches the spiral coil 11a with it rotating into the punched holes 3a of the bundle of paper-sheets 3 mounted on the paper-sheet-mounting base 46. The dispatched spiral coil 11a passes through between the projections 49c of the guide projection portion 49b of the screw guide 49. At this moment, the spiral coil 11a is guided by each projection 49c of the guide projection portion 49b so that it passes through between the convex teeth 46b of the screw guide 46a (fixed side) of the paper-sheet-mounting base 46, thereby limiting its advanced direction.

It is configured that the spiral coil 11a then passes through between the convex teeth 46b of the screw guide 46a and is inserted into the punched holes 3a. It is configured that after the insertion into the punched holes 3a, the spiral coil 11a is again guided by the guide projection portion 49b so that it passes through between the convex teeth 46b of the screw guide 46a, thereby limiting its advanced direction, and passes through between the convex teeth 46b so as to insert into the punched holes 3a. This enables the spiral coil 11a to be securely inserted into each punched hole 3a of the bundle of paper-sheets 3.

The bundle of paper-sheets 3 constituted of paper-sheets of 41 through 70 sheets is mounted on the paper-sheet-mounting base 46 shown in FIG. 19B and the spiral coil 11b having the middle diameter passes through each of the punched holes 3a of this bundle of paper-sheets 3. Thus, in order to pass the spiral coil 11b through each of the punched holes 3a, the screw guide 49 and the feed roller 31 shown in FIG. 18 are first disposed at predetermined positions thereof. For example, the position of the screw guide 49 is disposed on the position (the distance d2′ shown in FIG. 16B) in which it comes into contact with the spiral coil 11b. In this case, a space between the projection 49c of the screw guide 49 and the convex teeth 46b of the paper-sheet-mounting base 46 is made broader than the space shown in FIG. 19A.

The feed roller 31 next dispatches the spiral coil 11b with it rotating in the punched holes 3a of the bundle of paper-sheets 3 mounted on the paper-sheet-mounting base 46. The dispatched spiral coil 11b passes through between the projections 49c of the guide projection portion 49b of the screw guide 49. At this moment, the spiral coil 11b is limited by the guide projection portion 49b on its advanced direction so that it passes through between the convex teeth 46b of the screw guide 46a (fixed side) of the paper-sheet-mounting base 46.

It is configured that the spiral coil 11b then passes through between the convex teeth 46b of the screw guide 46a and passes through the punched holes 3a. It is configured that after the passage through the punched holes 3a, the spiral coil 11b is again limited by the guide projection portion 49b on its advanced direction so that it passes through between the convex teeth 46b of the screw guide 46a, and passes through between the convex teeth 46b so as to pass through the punched holes 3a. This enables the spiral coil 11b having the middle diameter to pass through each punched hole 3a of the bundle of paper-sheets 3 securely.

The bundle of paper-sheets 3 constituted of paper-sheets of 71 through 100 sheets is mounted on the paper-sheet-mounting base 46 shown in FIG. 19C and the spiral coil 11c having the large diameter passes through each of the punched holes 3a of this bundle of paper-sheets 3. Thus, in order to pass the spiral coil 11c through each of the punched holes 3a, the screw guide 49 and the feed roller 31 are first disposed at predetermined positions thereof. For example, the position of the screw guide 49 is disposed on the position (the distance d3′ shown in FIG. 16B) in which it comes into contact with the spiral coil 11c. In this case, a space between the projection 49c of the screw guide 49 and the convex teeth 46b of the paper-sheet-mounting base 46 is made broader than the spaces shown in FIGS. 19A and 19B.

The feed roller 31 next dispatches the spiral coil 11b with it rotating in the punched holes 3a of the bundle of paper-sheets 3 mounted on the paper-sheet-mounting base 46. The dispatched spiral coil 11b passes through between the projections 49c of the guide projection portion 49b of the screw guide 49. At this moment, the spiral coil 11c is limited by the guide projection portion 49b on its advanced direction so that it passes through between the convex teeth 46b of the screw guide 46a of the paper-sheet-mounting base 46.

It is configured that the spiral coil 11c then passes through between the convex teeth 46b of the screw guide 46a and passes through the punched holes 3a. It is configured that after the passage through the punched holes 3a, the spiral coil 11c is again limited by the guide projection portion 49b on its advanced direction so that it passes through between the convex teeth 46b of the screw guide 46a, and passes through between the convex teeth 46b so as to pass through the punched holes 3a. This enables the spiral coil 11c having the large diameter to pass through each punched hole 3a of the bundle of paper-sheets 3 securely.

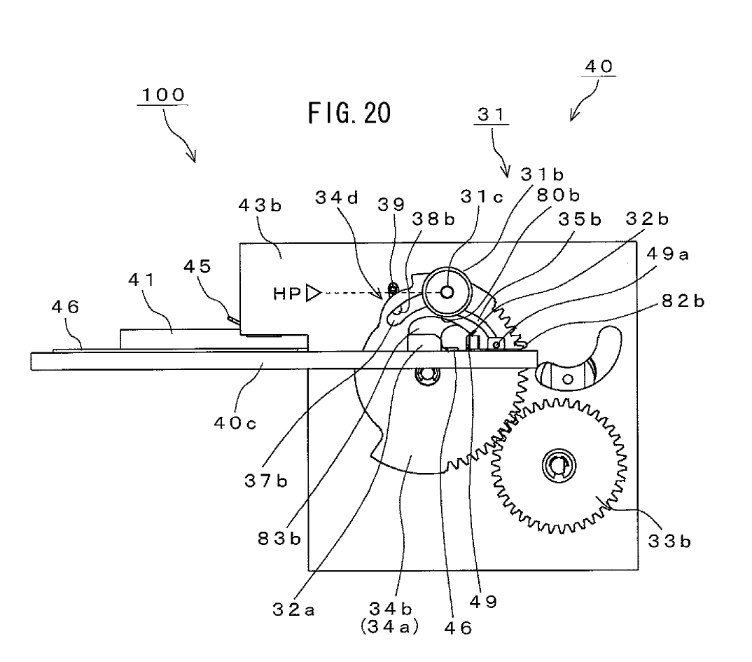

The following will describe operation examples of the binding mechanism 40 when setting the position corresponding to the diameter of the coil with reference to FIGS. 20 through 23. The binding mechanism 40 shown in FIGS. 20 through 23 is the binding mechanism 40 shown in FIG. 12 seen from a side thereof.

In this example, the description will be performed dividing it into four examples such as a feed-roller-stand-by example, a small-diameter-coil-position-setting example, a middle-diameter-coil-position-setting example and a large-diameter-coil-position-setting example. The feed roller 31 obliquely moves up and down corresponding to the diameter of the coil. It is configured that the feed roller 31 stands by at the home position HP thereof and changes its position from the home position HP corresponding to the diameters of the coils. The feed roller 31 changes its position to three stages corresponding to the diameters of the coils of 8 mm, 11 mm and 14 mm. The feed roller 31 is driven so that it presses the spiral coil 11 from an oblique direction to the screw guide 49.

Here, a description will be given of an operation example of the binding mechanism 40 in case of stand-by time with reference to FIG. 20. In this example, a description will be given of operation example of only the guide-switching cam 34b, the gear 33b and their related parts on the side surface plate 43b. It is to be noted that a description of operation example of the guide-switching cam 34a, the gear 33a and their related parts on the side surface plate 43a will be omitted because they perform functions similar to those of parts on the side surface plate 43b.

According to the binding mechanism 40 shown in FIG. 20, a state is such that the feed roller 31, the screw guide 49 and the paper-sheet clamp 45 stand by and the feed roller 31 and the paper-sheet clamp 45 stay at their uppermost position. Hereinafter, this state is referred to as a stand-by state of the binding mechanism 40. It is because maximum number of paper-sheets to be bound can be received to provide such a stand-by state thereof. In order to move to this stand-by state, the motor 703 shown in FIG. 1 rotates the gear 33b by a predetermined extent clockwise with respect to a surface of figure. By this rotation of the gear 33b, the guide-switching cam 34b meshed with the gear 33b rotates counter-clockwise. By the rotation of this guide-switching cam 34b and the respective openings or holes perforated in the side surface plate 43b, the positions of the feed roller 31, the screw guide 49 and the paper-sheet clamp 45 are fixed at the same time.

For example, the feed roller 31 moves up and down along the cam surface of the long cam opening 37b with its movement direction being limited vertically by the vertical long opening 80b. In order to set this feed roller 31 to the stand-by state thereof, it is set so that the feed roller 31 is positioned at an end of the long cam opening 37b. Thus, the feed roller 31 is lifted up by the cam surface of the long cam opening 37b so that it is positioned at the uppermost of the vertical long opening 80b.

The screw guide 49 moves right and left along the cam surface of the curved long cam opening 35b with a movement direction of the shaft rod 49a of the screw guide 49 being limited horizontally by the horizontal long opening 80b. In this example, the screw guide 49 is positioned at an end side of the curved long cam opening 35b and is positioned at a right side of the horizontal long opening 82b with respect to the surface of the figure.

The linking rod 39 of the paper-sheet clamp 45 moves up and down along an outer circumferential cam surface 34d of the guide-switching cam 34b with a movement direction of the paper-sheet clamp 45 being limited on an almost vertical direction by the vertical long opening 38b. In order to set this paper-sheet clamp 45 to the stand-by state thereof, it is set so that the linking rod 39 of the paper-sheet clamp 45 is lifted up by the outer circumferential cam surface 34d and the paper-sheet clamp 45 is positioned at the uppermost of the vertical long opening 38b. This enables the positions of the feed roller 31, the screw guide 49 and the paper-sheet clamp 45 to be set in their stand-by state.

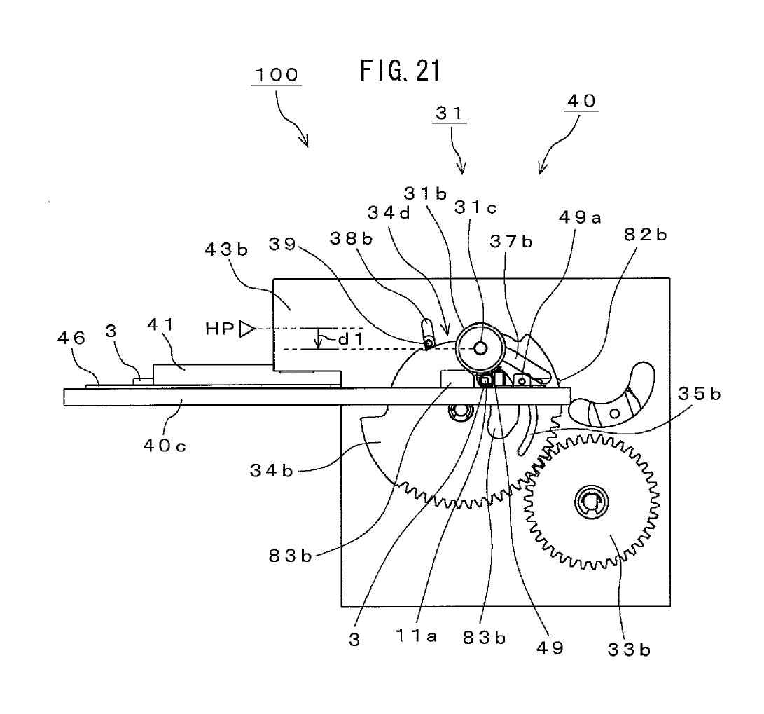

Next, a description will be given of an operation example of the binding mechanism 40 when setting a position of the spiral coil 11a having the small diameter with reference to FIG. 21. In this example, the feed roller 31 is moved by a first distance d1 on the vertical direction when setting the position of the spiral coil 11a having the small diameter. According to the binding mechanism 40 shown in FIG. 21, a state is such that the feed roller 31, the screw guide 49 and the paper-sheet clamp 45 stay when setting the position of the spiral coil 11a having the small diameter. This state is a case where the number of the paper-sheets is 40 sheets or less and the spiral coil 11a having the small diameter passes therethrough. When the spiral coil 11a passes therethrough, the gear 33b rotates clockwise by a predetermined extent with respect to a surface of figure from the stand-by state shown in FIG. 20. By this rotation of the gear 33b, the guide-switching cam 34b meshed with the gear 33b rotates counter-clockwise.

By the rotation of this guide-switching cam 34b, the feed roller 31 positioned at the uppermost of the vertical long opening 80b (see FIG. 13) of the side surface plate 43b moves from the above-mentioned end of the long cam opening 37b of the guide-switching cam 34b to the other end thereof to fall down so that it moves on a vertical direction from the uppermost of the vertical long opening 80b to the lowermost thereof. This enables the feed roller 31 to be set to a position where it comes into contact with the top surface of the spiral coil 11a.

By the rotation of this guide-switching cam 34b, the screw guide 49 positioned at a right side of the horizontal long opening 82b with respect to the surface of the figure in the above-mentioned stand-by state moves from the above-mentioned end of the curved long cam opening 35b of the guide-switching cam 34b to the other end thereof to fall back (come close to the spiral coil 11a) so that it moves on a horizontal direction from the right side of the horizontal long opening 82b to the left side thereof. This enables the screw guide 49 to be set to a position where it comes into contact with the front surface of the spiral coil 11a having the small diameter.

By the rotation of this guide-switching cam 34b, the paper-sheet clamp 45 positioned at the uppermost of the vertical long opening 38b at the above-mentioned stand-by state moves from the uppermost of the vertical long opening 38b to the lowermost thereof on an almost vertical direction because the linking rod 39 of the paper-sheet clamp 45 is fallen down by the outer circumferential cam surface 34d. This enables the paper-sheet clamp 45 to be set to a position where it clamps the bundle of paper-sheets 3 constituted of paper-sheets of 40 sheets or less.

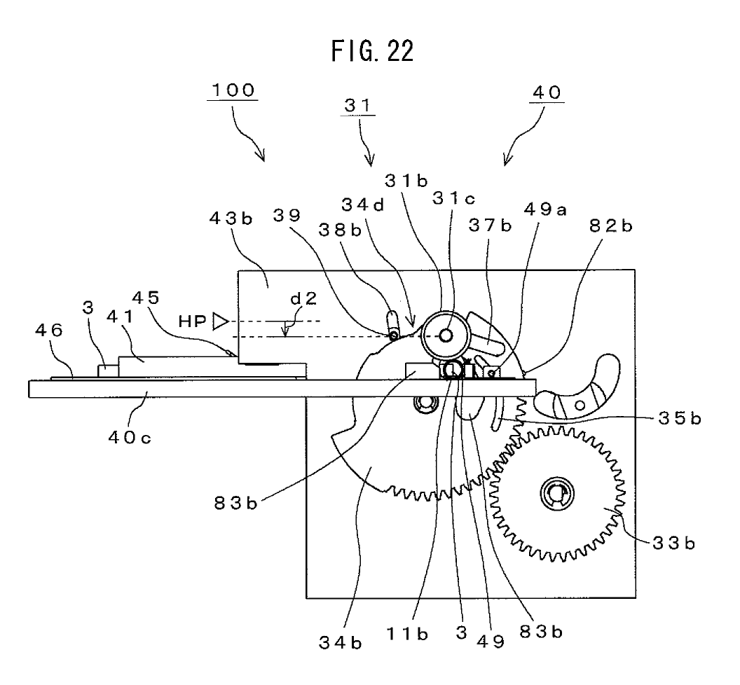

A description will be given of an operation example of the binding mechanism 40 when setting a position of the spiral coil 11b having the middle diameter with reference to FIG. 22. In this example, the feed roller 31 is moved by a second distance d2 on the vertical direction when setting the position of the spiral coil 11b having the middle diameter. According to the binding mechanism 40 shown in FIG. 22, a state is such that the feed roller 31, the screw guide 49 and the paper-sheet clamp 45 stay when setting the position of the spiral coil 11b having the middle diameter. This state is a case where the number of the paper-sheets is 41 through 70 sheets and the spiral coil 11b having the middle diameter passes therethrough. When the spiral coil 11b passes therethrough, the gear 33b rotates clockwise by a predetermined extent from the stand-by state shown in FIG. 20 with respect to a surface of figure. By this rotation of the gear 33b, the guide-switching cam 34b meshed with the gear 33b rotates counter-clockwise.

By the rotation of this guide-switching cam 34b, the feed roller 31 positioned at the uppermost of the vertical long opening 80b (see FIG. 13) of the side surface plate 43b moves from the end of the long cam opening 37b of the guide-switching cam 34b to a position thereof that is about a quarter of the opening length thereof to fall down slightly so that it moves on a vertical direction from the uppermost of the vertical long opening 80b to the middle portion thereof. This enables the feed roller 31 to be set to a position where it comes into contact with the top surface of the spiral coil 11b having the middle diameter.

By the rotation of this guide-switching cam 34b, the screw guide 49 positioned at a right side of the horizontal long opening 82b with respect to the surface of the figure in the above-mentioned stand-by state moves from the above-mentioned end of the curved long cam opening 35b of the guide-switching cam 34b to a position thereof that is about two third of the opening length thereof to fall back slightly (come close to the spiral coil 11b) so that it moves on a horizontal direction from the right side of the horizontal long opening 82b to the left side thereof. This enables the screw guide 49 to be set to a position where it comes into contact with the front surface of the spiral coil 11b having the middle diameter.

By the rotation of this guide-switching cam 34b, the paper-sheet clamp 45 positioned at the uppermost of the vertical long opening 38b in the above-mentioned stand-by state moves from the uppermost of the vertical long opening 38b to the middle thereof on an almost vertical direction because the linking rod 39 of the paper-sheet clamp 45 is slightly fallen down by the outer circumferential cam surface 34d. This enables the paper-sheet clamp 45 to be set to a position where it clamps the bundle of paper-sheets 3 constituted of paper-sheets of 41 through 70 sheets.

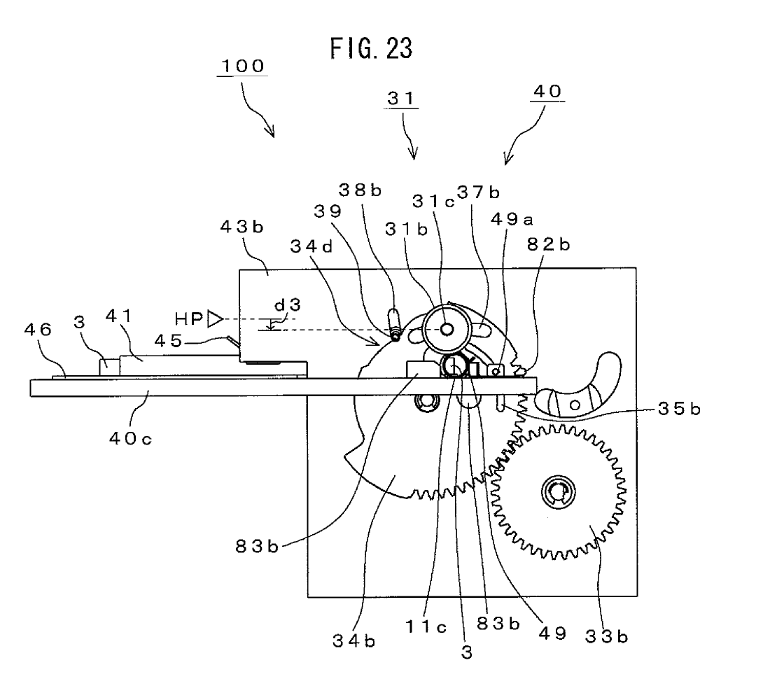

Next, a description will be given of an operation example of the binding mechanism 40 when setting a position of the spiral coil 11c having the large diameter with reference to FIG. 23. In this example, the feed roller 31 is moved by a third distance d3 (d1>d2>d3) on the vertical direction when setting the position of the spiral coil 11c having the large diameter. This enables the position of the feed roller 31 to be adjusted by the binding mechanism 40 after the clamping.

According to the binding mechanism 40 shown in FIG. 23, a state is such that the feed roller 31, the screw guide 49 and the paper-sheet clamp 45 stay when setting the position of the spiral coil 11c having the large diameter. This state is a case where the number of the paper-sheets is 71 through 100 sheets and the spiral coil 11c having the large diameter passes therethrough. When the spiral coil 11c passes therethrough, the gear 33b rotates clockwise by a predetermined extent with respect to a surface of figure from the stand-by state shown in FIG. 20. By this rotation of the gear 33b, the guide-switching cam 34b meshed with the gear 33b rotates counter-clockwise.

By the rotation of this guide-switching cam 34b, the feed roller 31 positioned at the uppermost of the vertical long opening 80b of the side surface plate 43b moves from the end of the long cam opening 37b of the guide-switching cam 34b to a position thereof that is about a half of the opening length thereof to fall down slightly so that it moves on a vertical direction from the uppermost of the vertical long opening 80b to the upper portion thereof. This enables the feed roller 31 to be set to a position where it comes into contact with the top surface of the spiral coil 11c having the large diameter.

By the rotation of this guide-switching cam 34b, the screw guide 49 positioned at a right side of the horizontal long opening 82b with respect to the surface of the figure in the above-mentioned stand-by state moves from the end of the curved long cam opening 35b of the guide-switching cam 34b to a position thereof that is about half of the opening length thereof to fall back slightly (come close to the spiral coil 11c) so that it moves on a horizontal direction from the right side of the horizontal long opening 82b to the left side thereof. This enables the screw guide 49 to be set to a position where it comes into contact with the front surface of the spiral coil 11c having the large diameter.

By the rotation of this guide-switching cam 34b, the paper-sheet clamp 45 positioned at the uppermost of the vertical long opening 38b in the above-mentioned stand-by state moves from the uppermost of the vertical long opening 38b to the middle thereof on an almost vertical direction because the linking rod 39 of the paper-sheet clamp 45 is slightly fallen down by the outer circumferential cam surface 34d. This enables the paper-sheet clamp 45 to be set to a position where it clamps the bundle of paper-sheets 3 constituted of paper-sheets of 71 through 100 sheets.

Thus, according to the operation examples of the binding mechanism 40 when setting the positions corresponding to the diameters of coils, it is configured that four patterns of the feed roller 31, the screw guide 49 and the paper-sheet clamp 45 such as a pattern of the stand-by time thereof, patterns when setting the positions of the spiral coils of the small diameter, the middle diameter and the large diameter are separately set. Accordingly, it is possible to guide the respective spiral coils 11a, 11b and 11c having different diameters of the coils to the punched holes 3a of the bundle of paper-sheets 3 at the positions corresponding to the diameters of coils thereof. This enables the respective spiral coils 11a, 11b and 11c to pass through the punched holes 3a of the bundle of paper-sheets 3 stably.

The following will describe a configuration example and a functional example of a paper-sheet-aligning guide 41 of the binding mechanism 40 with reference to FIGS. 24 through 27. FIG. 24A is a top view showing a configuration example of the paper-sheet-aligning guide 41 shown in FIG. 12. In this example, a case is shown where the paper-sheet-aligning guide (slide guide wall) 41 having a sectional inverse trapezoid shape is provided on the paper-sheet-mounting base 46 which is at a upstream side of the advance of the spiral coil 11 and at a right angle of the advanced direction of the above-mentioned spiral coil 11 as shown in FIG. 12.

The paper-sheet-aligning guide 41 shown in FIG. 24A has a paper-sheet-aligning surface 41a, first and second recess portions 41b and 41c. In this example, assuming that an angle consisting of the paper-sheet-aligning surface 41a of the paper-sheet-aligning guide 41 and a paper-sheet-mounting surface of the paper-sheet-mounting base 46 is an inclined angle θ as shown in FIG. 24B, the inclined angle θ is set so as to become less than 90 degrees. Namely, the paper-sheet-aligning surface 41a of the paper-sheet-aligning guide 41 has the inclined angle θ that is almost the same as the coil advance angle. The paper-sheet-aligning guide 41 aligns the side edge 3b of the bundle of paper-sheets 3 obliquely corresponding to the inclination of the paper-sheet-aligning surface 41a. It is thus configured that the bundle of paper-sheets 3 is obliquely aligned in the paper-sheets thereof.

The paper-sheet-aligning surface 41a is formed as to have the inclined angle θ of about 80 degrees with respect to the paper-sheet-mounting surface of the paper-sheet-mounting base 46 shown in FIG. 12. In addition, it is preferable to become θ=75 through 80 degrees in a case where a pitch of the coil is about 6 through 6.5 mm and an inner diameter of the coil is about 8 through 20 mm. With the recess portion 41b, the supporting rod 44 of the paper-sheet clamp 45 shown in FIG. 11 is engaged. With the recess portion 41c, the linking rod 39 of the paper-sheet clamp 45 shown in FIG. 11 is engaged.

Thus, by aligning the bundle of paper-sheets 3 obliquely corresponding to the inclination of the paper-sheet-aligning surface 41a, the punched holes 3a of the bundle of the paper-sheets 3 are also aligned corresponding to the inclination of the paper-sheet-aligning surface 41a. Accordingly, when the spiral coil 11 advances into the punched holes 3a of the bundle of the paper-sheets 3 having a predetermined inclination with it rotating, the punched holes 3a of the bundle of the paper-sheets 3 are obliquely adjusted in their open positions corresponding to the inclination so that the spiral coil 11 can pass trough the punched holes 3a stably.

FIG. 24B is a front view showing the paper-sheet-aligning guide 41 shown in FIG. 24A as indicated from an X-direction. The paper-sheet-aligning guide 41 shown in FIG. 24B is set such that the paper-sheet-aligning surface 41a is about 80 degrees in the inclined angle θ with respect to the paper-sheet-mounting surface. It is configured that by the paper-sheet-aligning surface 41a formed so as to have this inclined angle of 80 degrees, the side edge 3b of the bundle of paper-sheets 3 is aligned (see FIG. 12).

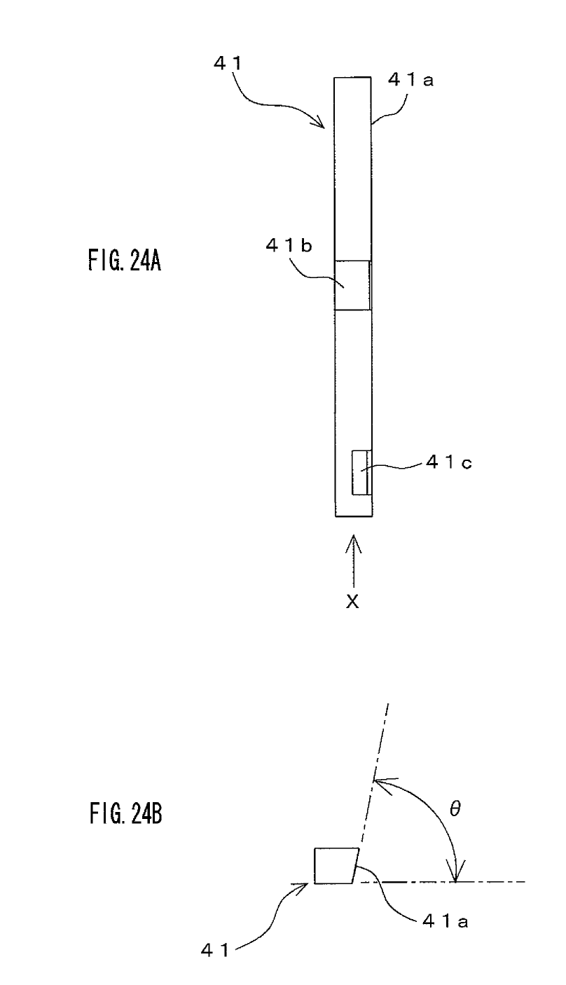

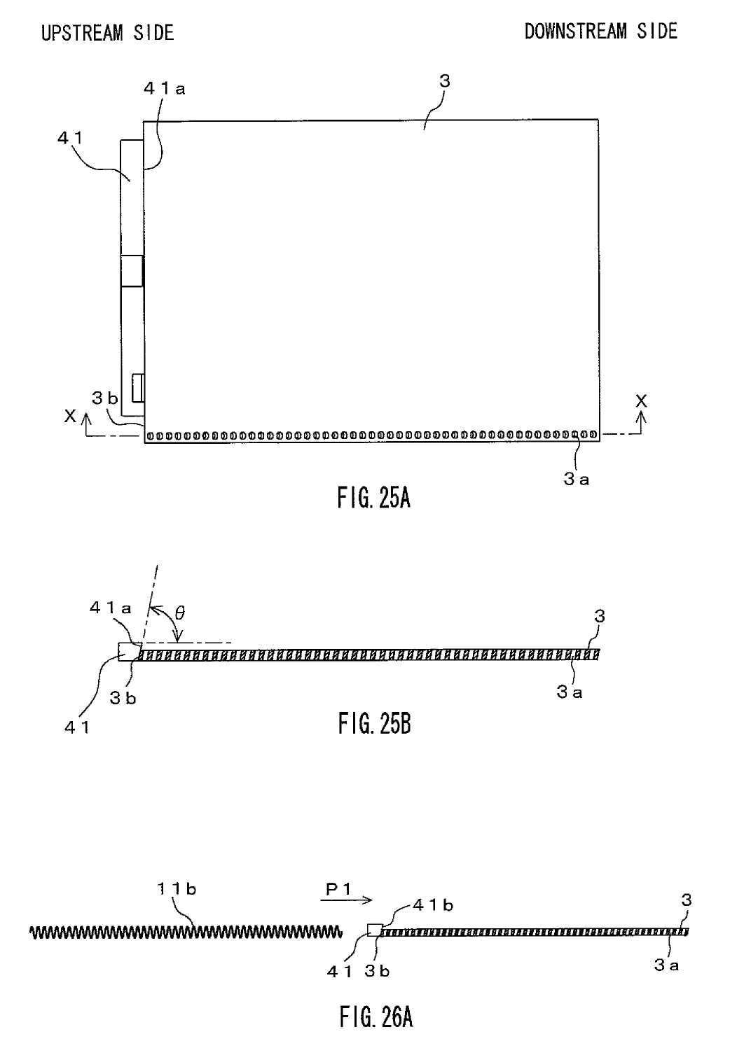

The following will describe a function example (part one) of the paper-sheet-aligning guide 41 with reference to FIGS. 25A and 25B. FIG. 25A is a top view showing a function example of the paper-sheet-aligning guide 41 when aligning the paper-sheets and FIG. 25B is a cross-sectional view of the paper-sheet-aligning guide 41 taken along lines X-X shown in FIG. 25A.

According to the paper-sheet-aligning guide 41 when aligning the paper-sheets as shown in FIG. 25A, a state is such that the paper-sheets are mounted on the paper-sheet-aligning surface 41a of the paper-sheet-aligning guide 41 shown in FIG. 24A and the bundle of paper-sheets 3 composed of paper-sheets of almost 41 through 70 sheets is aligned. Further, in the paper-sheet-aligning guide 41 shown in FIG. 25B, the side edge 3b of the bundle of paper-sheets 3 is aligned by the paper-sheet-aligning surface 41a that has been set so that the inclined angle θ can be about 80 degrees and is aligned so as to be inclined at about 80 degrees that are similar to the inclined angle θ consisting it and the paper-sheet-mounting surface of the paper-sheet-mounting guide 46 mounting the bundle of paper-sheets 3. Further, the punched holes 3a of the bundle of paper-sheets 3 are also respectively aligned (deviated) so that an angle consisting it and the paper-sheet-mounting surface can be about 80 degrees, which is similar to the angle θ.

Next, a description will be given of the function example (part two) of the paper-sheet-aligning guide 41 with reference to FIGS. 26A and 26B.

FIG. 26A is a view showing an example of a state before an insertion of the spiral coil 11b having the middle diameter. The spiral coil 11b having the middle diameter shown in FIG. 26A passes through, from an arrow direction P1, the punched holes 3a of the bundle of paper-sheets 3 which are aligned having the inclination, with it rotating, the side edge 3b of the bundle of paper-sheets 3 being aligned by the paper-sheet-aligning surface 41a of the paper-sheet-aligning guide 41.

FIG. 26B is a view showing an example of a state after the insertion of the spiral coil 11b having the middle diameter. The spiral coil 11b having the middle diameter shown in FIG. 26B is a state where it passes through part of the way of the bundle of paper-sheets 3 (state before reaching the terminal thereof). It is to be noted that from the bundle of paper-sheets 3 shown in FIG. 26B, hatching of the sectional surface of the bundle of paper-sheets 3 shown in FIG. 26A is omitted in order to be made easy to see the passed-through state of the spiral coil 11b.

As shown in FIG. 26B, the angle of each of the punched holes 3a of the bundle of paper-sheets 3 having the inclination and the angle of the spiral coil 11 passed through the punched holes 3a are almost identical to each other. This enables a clearance between the spiral coil 11b and each of the punched holes 3a to be sufficiently kept, thereby allowing the spiral coil 11b to pass therethrough stably to prevent the spiral coil 11 from striking against a wall surface of the punched holes 3a of the bundle of paper-sheets 3.

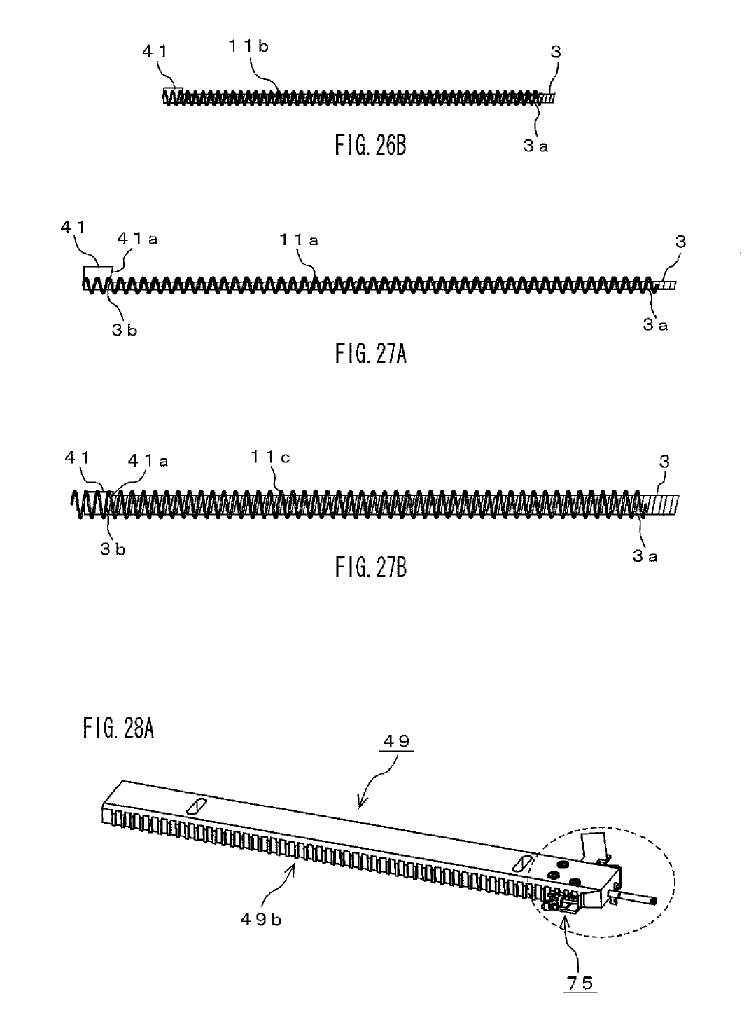

Next, a description will be given of function examples of the spiral coils 11a and 11c having the small and large diameters in the paper-sheet-aligning guide 41 when passing therethrough with reference to FIGS. 27A and 27B. The bundle of paper-sheets 3 shown in FIG. 27A is constituted of paper-sheets of 40 sheets or less in number of paper-sheets. The side edge 3b of the bundle of paper-sheets 3 is aligned by the paper-sheet-aligning surface 41a of the paper-sheet-aligning guide 41, which is formed so as to be inclined at about 80 degrees, and is set so that the angle consisting of it and a horizontal surface can be about 80 degrees. The punched holes 3a of the bundle of paper-sheets 3 are also aligned so that the angle consisting of it and a horizontal surface can be about 80 degrees. The spiral coil 11a shown in FIG. 27A is a state where the spiral coil 11a having the small diameter passes through part of the way of the bundle of paper-sheets 3. As shown in FIG. 27A, the angle of each of the punched holes 3a of the bundle of paper-sheets 3 having the inclination and the angle of the spiral coil 11a passed through the punched holes 3a are almost identical to each other.

The bundle of paper-sheets 3 shown in FIG. 27B is constituted of paper-sheets of almost 71 through 100 sheets in number of paper-sheets. The side edge 3b of the bundle of paper-sheets 3 is aligned by the paper-sheet-aligning surface 41a that is formed so as to be inclined at 80 degrees and is set so that the (inclined) angle consisting of it and a horizontal surface can be about 80 degrees. The punched holes 3a of the bundle of paper-sheets 3 are also aligned so that the angle consisting of it and a horizontal surface can be about 80 degrees. It is a state where the spiral coil 11c having the large diameter passes through part of the way of the bundle of paper-sheets 3. As shown in FIG. 27B, the angle of each of the punched holes 3a of the bundle of paper-sheets 3 having the inclination and the angle of the spiral coil 11c passed through the punched holes 3a are almost identical to each other.

Thus, by aligning the bundle of paper-sheets 3 obliquely, it is made possible to pass the forward end of the spiral coil 11 smoothly through the punched holes of the bundle of paper-sheets 3 to prevent the forward end of the spiral coil 11 from being caught by the punched holes of the bundle of paper-sheets 3. The clearance between each of the spiral coils 11a and 11c having the small and large diameters and each of the punched holes 3a can be sufficiently kept so that it is possible to pass the spiral coil 11a or 11c having the small or large diameter therethrough stably to prevent the forward end of the spiral coil from striking against a wall surface of each of the punched holes 3a of the bundle of paper-sheets 3. Of course, the inclined angle may alter in response to a thickness of the paper-sheets when aligning the bundle of paper-sheets.

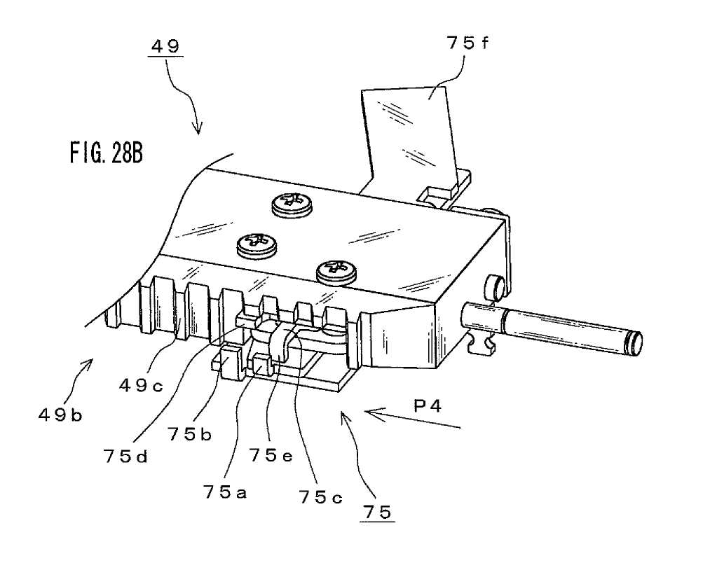

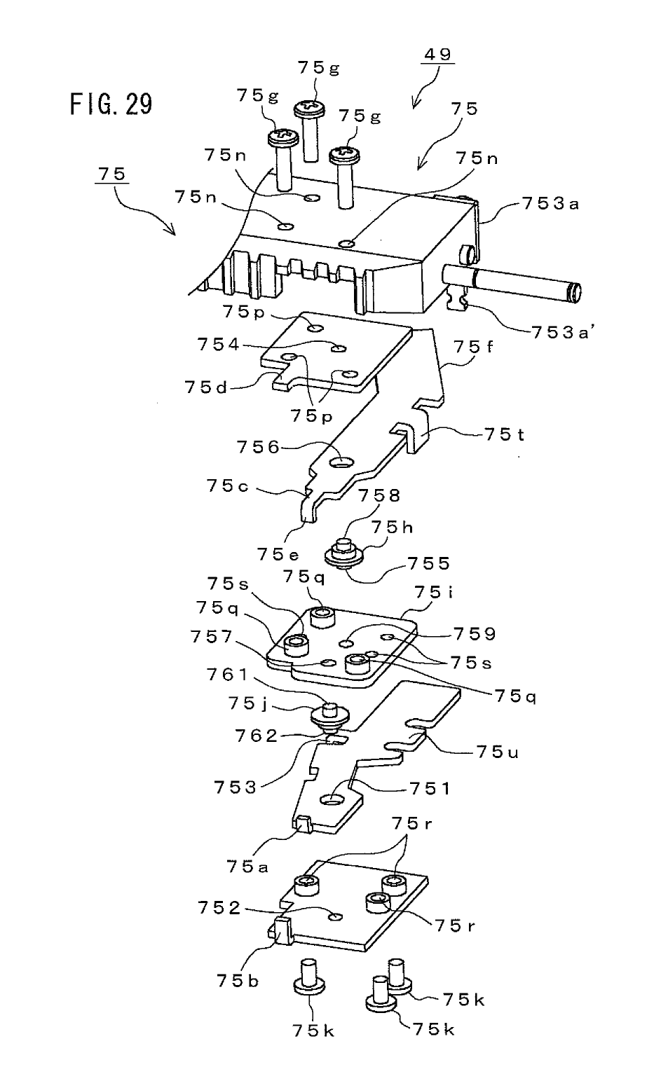

The following will describe a configuration example and an assembling example of the cutting-and-bending mechanism 75 with reference to FIGS. 28 and 29. FIG. 28A is a perspective view showing a configuration example of the cutting-and-bending mechanism 75. The cutting-and-bending mechanism 75 shown in FIG. 28A is provided at a one side (a coil-picking-up side) of the screw guide 49 and is designed so as to cut an end of the spiral coil 11 after the spiral coil 11 has passed through the punched holes 3a of the bundle of paper-sheets 3 and to bend it.

FIG. 28B is an enlarged view of the cutting-and-bending mechanism 75 indicated in a circle shown by dashed line in FIG. 28A. The cutting-and-bending mechanism 75 shown in FIG. 28B is configured to have a hitting-for-pinching portion 75a, a receiving-for-pinching portion 75b, a cutter-receiving portion 75d and a lever 75f. At a forward end of the lever 75f, a cutter 75c and a bending portion 75e are provided.

The receiving-for-pinching portion 75b and the cutter-receiving portion 75d are fixed on a main body of the screw guide 49 at predetermined positions thereof. In this example, the cutter-receiving portion 75d having a plate shape is fixed so as to face to a vertical direction with respect to the projections 49c of the screw guide 49. The receiving-for-pinching portion 75b having an L-shape is fixed so that a standing-up section of the receiving-for-pinching portion 75b is made parallel with the projections 49c. The lever 75f is movably attached to the main body of the screw guide 49 at predetermined positions thereof. The hitting-for-pinching portion 75a is attached so as to cooperate with the lever 75f. The hitting-for-pinching portion 75a and the receiving-for-pinching portion 75b have L-shapes.

The hitting-for-pinching portion 75a and the receiving-for-pinching portion 75b constitute an example of pinching part and hold the end of the spiral coil 11 with it being pinched. For example, by rotating the lever 75f to a predetermined direction while the spiral coil 11 passes through between the hitting-for-pinching portion 75a and the receiving-for-pinching portion 75b and moving the hitting-for-pinching portion 75a toward the fixed receiving-for-pinching portion 75b, the hitting-for-pinching portion 75a and the receiving-for-pinching portion 75b hold the end of the spiral coil 11 with it being pinched.

The cutter 75c and the cutter-receiving portion 75d constitute an example of coil-cutting part and cut a predetermined position of the pinched spiral coil 11. For example, by further rotating the lever 75f to the predetermined direction while the spiral coil 11 is pinched by the hitting-for-pinching portion 75a and the receiving-for-pinching portion 75b, the fixed cutter-receiving portion 75d and the cutter 75c provided at the forward end of the lever 75f cut the end of the spiral coil 11 with it being pinched.

The bending portion 75e is provided on an extension portion of the cutter 75c and bends the cut end of the spiral coil 11 to a predetermined direction. For example, by additionally rotating the lever 75f to the predetermined direction after the spiral coil 11 has been cut by the cutter 75c, the bending portion 75e pushes the cut end of the spiral coil 11 to a direction of an arrow P4 while the spiral coil 11 is pinched by the hitting-for-pinching portion 75a and the receiving-for-pinching portion 75b and bends it.

After it is bent, by rotating the lever 75f to the opposite direction thereof, moving the cutter 75c away from the cutter-receiving portion 75d and moving the hitting-for-pinching portion 75a away from the receiving-for-pinching portion 75b, the pinched and held spiral coil 11 is made free and becomes the stand-by state thereof. By such a cutting-and-bending mechanism 75, the end of the spiral coil 11 is processed.

Here, a description will be given of the assembling example of the cutting-and-bending mechanism 75 with reference to FIG. 29. According to the cutting-and-bending mechanism 75 shown in FIG. 29, three pieces of first pins 75g are first inserted into three holes 75n of the main body of the screw guide 49 and the pins 75g are also inserted into three holes 75p of the main body of the cutter-receiving portion 75d so that the main body of the cutter-receiving portion 75d is fixed to the main body of the screw guide 49.

To the main body of the fixed cutter-receiving portion 75d, the lever 75f is rotatably attached. In this example, a projection 758 of a first intermediate member 75h is inserted into an opening 754 provided at almost a middle of the main body of the cutter-receiving portion 75d and an opening 756 of the main body of the lever 75f so that they are rotatably connected. After the connection, the other projection 755 of this intermediate member 75h is inserted into an opening 759 of a fixation plate 75i and forward ends of the three pins 75g are inserted into three fixation sections 75q of the fixation plate 75i. Thus, the main body of the cutter-receiving portion 75d is fixed on the main body of the screw guide 49 and the main body of the lever 75f is rotatably fixed on the main body of the screw guide 49.

A projection 761 of a second intermediate member 75j is inserted into an opening 757 of the fixation plate 75i and the other projection 762 thereof is inserted into an opening 751 of the main body of the hitting-for-pinching portion 75a and an opening 752 of the main body of the receiving-for-pinching portion 75b. After the insertion thereof, three pieces of second pins 75k are inserted into three braced holes 75r of the main body of the receiving-for-pinching portion 75b and three holes 75s of the fixation plate 75i so that the main body of the receiving-for-pinching portion 75b is fixed on the fixation plate 75i. Thus, the main body of the hitting-for-pinching portion 75a is rotatably fixed on the fixation plate 75i with the intermediate member 75j being the rotation shaft thereof so that the cutting-and-bending mechanism 75 is assembled.

It is to be noted that a spring 75m, which will be described later, is attached to a spring-hooking portion 753 of the main body of the hitting-for-pinching portion 75a and an elastic force by the spring 75m allows any force for the rotation to be always applied to a predetermined direction. With a push-receiving portion 75u of the main body of the hitting-for-pinching portion 75a, a pushing portion 75t of the main body of the lever 75f is engaged. It is configured that based on such a configuration, by manipulating the lever 75f, the main body of the hitting-for-pinching portion 75a rotates with cooperation.

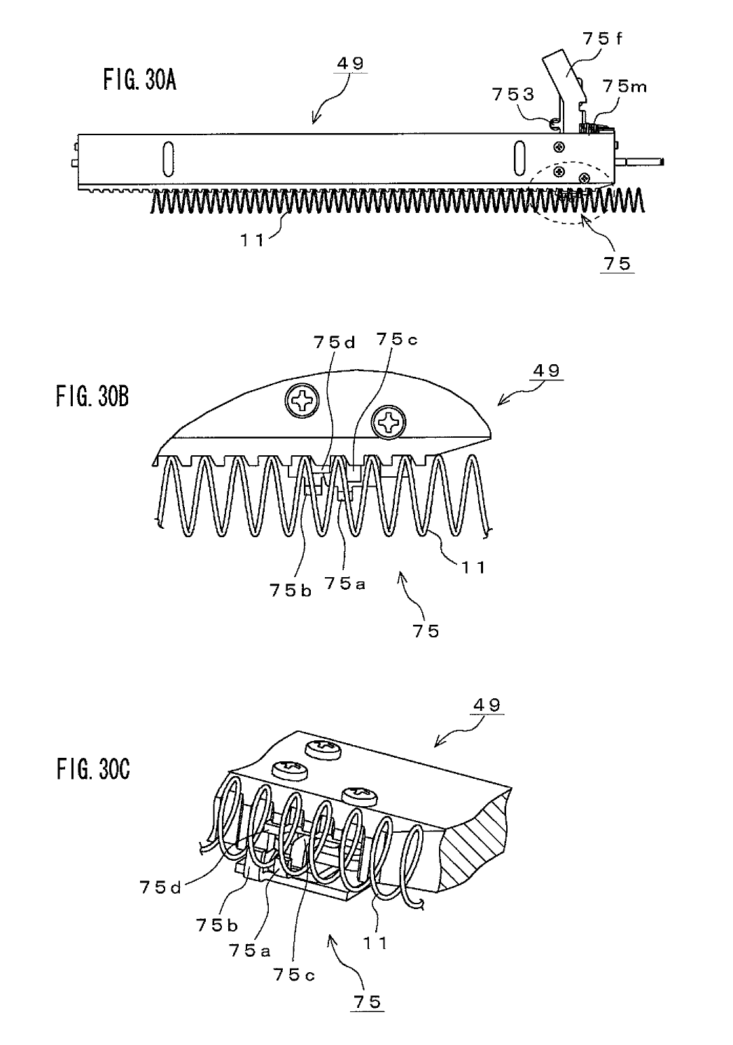

The following will describe operation examples of the cutting-and-bending mechanism 75 with respect to FIGS. 30 through 32. In this example, a description will be performed dividing it into three states such as a stand-by state of the cutting-and-bending mechanism 75, a cutting state thereof and a bending state thereof. It is to be noted that an end side of the spring 75m is attached to the spring-hooking portion 753 of the main body of the hitting-for-pinching portion 75a of the cutting-and-bending mechanism 75 and the other end side of the spring 75m is attached to a hooking portion 753a′ of a hooking plate 753a. An elastic force by the spring 75m allows any clockwise force to be always applied. The operations of the hitting-for-pinching portion 75a and the cutter 75c are adjusted by the lever 75f.

FIG. 30A is a top view showing an operation example of the cutting-and-bending mechanism 75 in the screw guider 49 at a period of stand-by time. The cutting-and-bending mechanism 75 shown in FIG. 30A is provided at an end of the screw guide 49 and stays in its stand-by state. In this example, a position of the lever 75f of the cutting-and-bending mechanism 75 is set to its initial position. The screw guide 49 shown in the figure guides the dispatched spiral coil 11.

FIG. 30B is an enlarged view showing an operation example of the cutting-and-bending mechanism 75 indicated in a circle shown by dashed line in FIG. 30A. According to the cutting-and-bending mechanism 75 shown in FIG. 30B, the pushing portion 75t of the lever 75f is engaged with the push-receiving portion 75u of the hitting-for-pinching portion 75a by tensile strength of the spring 75m so that the hitting-for-pinching portion 75a faces to a direction almost similar to that of the receiving-for-pinching portion 75b. At this moment, a space between the hitting-for-pinching portion 75a and the receiving-for-pinching portion 75b is around three times a diameter of a line of the spiral coil 11. The end of the spiral coil 11 is positioned between the hitting-for-pinching portion 75a and the receiving-for-pinching portion 75b.

The cutter 75c faces to a direction almost similar to that of the cutter-receiving portion 75d. In this example, a space between the cutter 75c and the cutter-receiving portion 75d is also set to be around three times the diameter of the line of the spiral coil 11. The end of the spiral coil 11 is positioned between the cutter 75c and the cutter-receiving portion 75d.

FIG. 30C is a perspective view showing an operation example of the cutting-and-bending mechanism 75 shown in FIG. 30B. In the cutting-and-bending mechanism 75 shown in FIG. 30C, the spiral coil 11 passes through around a middle of the standing-up section of the receiving-for-pinching portion 75b having the L-shape. Similarly, the spiral coil 11 passes through around a middle of the standing-up section of the hitting-for-pinching portion 75a having the L-shape. This enables the spiral coil 11 to be pinched and held by the receiving-for-pinching portion 75b and the hitting-for-pinching portion 75a. The spiral coil 11 also passes through near a base of the cutter-receiving portion 75d having a plate shape.

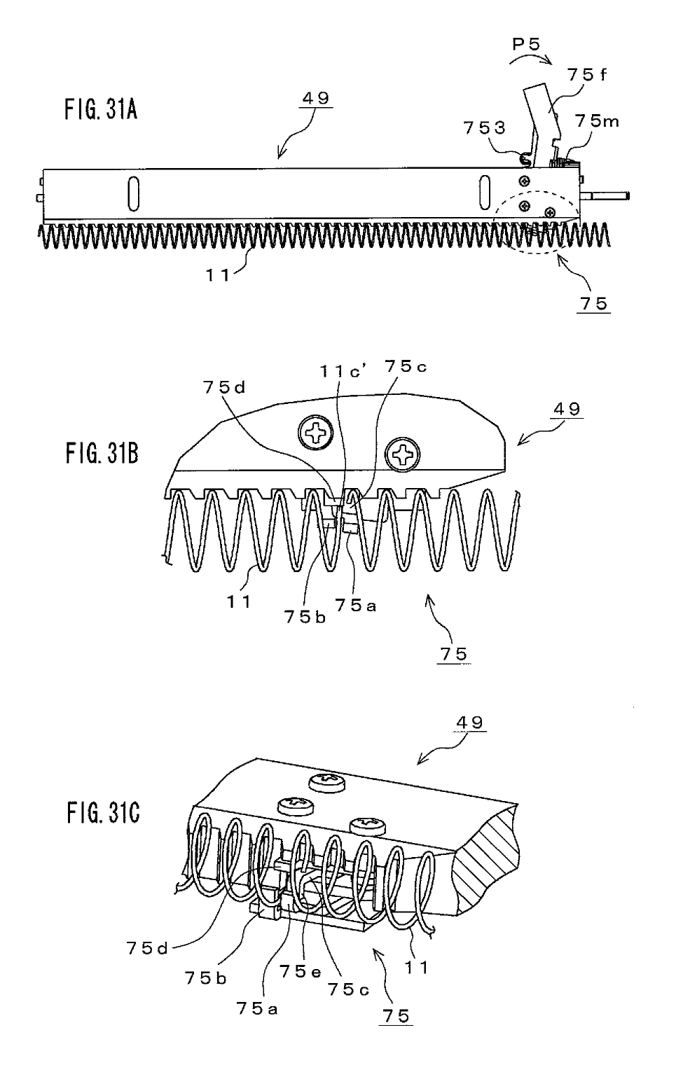

FIG. 31A is a top view showing an operation example of the cutting-and-bending mechanism 75 when cutting the coil. According to the cutting-and-bending mechanism 75 shown in FIG. 31A, by rotating the lever 75f from the initial position thereof shown in FIG. 30A to a direction of an arrow P5, it moves to its cutting position.

FIG. 31B is an enlarged view showing an operation example of the cutting-and-bending mechanism 75 indicated in a circle shown by dashed line in FIG. 31A. According to the cutting-and-bending mechanism 75 shown in FIG. 31B, by rotating the lever 75f to the direction of the arrow P5 (clockwise), the hitting-for-pinching portion 75a rotates clockwise cooperating with the lever 75f. In this example, an elastic force by the spring 75m hooked by the spring-hooking portion 753 of the main body of the hitting-for-pinching portion 75a allows any clockwise force to be always applied to the hitting-for-pinching portion 75a.

Accordingly, by rotating the lever 75f clockwise, the hitting-for-pinching portion 75a rotates clockwise with respect to the projection 762 of the intermediate member 75j shown in FIG. 29 as an axis thereof to become near the receiving-for-pinching portion 75b. By approaching the hitting-for-pinching portion 75a to the receiving-for-pinching portion 75b, the spiral coil 11 shown in FIG. 30B, which is positioned between the hitting-for-pinching portion 75a and the receiving-for-pinching portion 75b, is pinched by the hitting-for-pinching portion 75a and the receiving-for-pinching portion 75b as shown in FIG. 31B to be held. At this moment, the spiral coil 11 is pinched between the cutter 75c and the cutter-receiving portion 75d.

By further rotating the lever 75f clockwise with the spiral coil 11 being pinched and held by the hitting-for-pinching portion 75a and the receiving-for-pinching portion 75b, only the cutter 75c rotates clockwise and cuts the spiral coil 11 pinched between the cutter 75c and the cutter-receiving portion 75d. “11c′” in the figure is a cut end of the cut spiral coil 11.

FIG. 31C is a perspective view showing an operation example of the cutting-and-bending mechanism 75 shown in FIG. 31B. According to the cutting-and-bending mechanism 75 shown in FIG. 31C, the spiral coil 11 is pinched by the hitting-for-pinching portion 75a and the receiving-for-pinching portion 75b and the cutter 75c cuts the spiral coil 11 at a position away from the pinched position of the spiral coil 11 by about a quarter of the arc of the circle of the spiral coil 11.

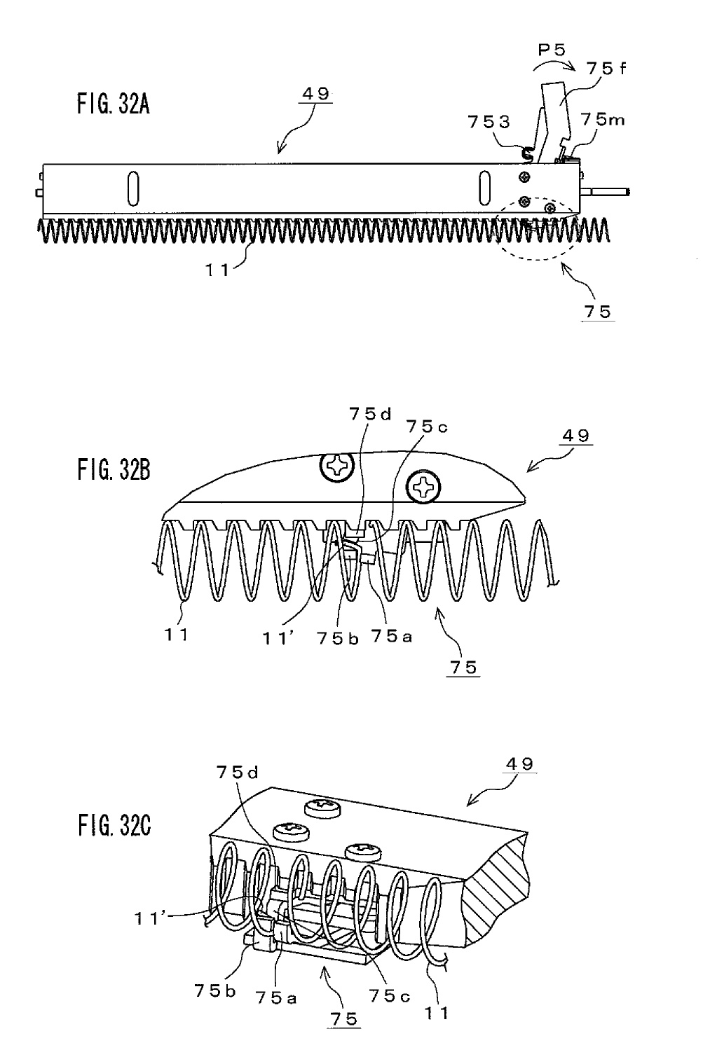

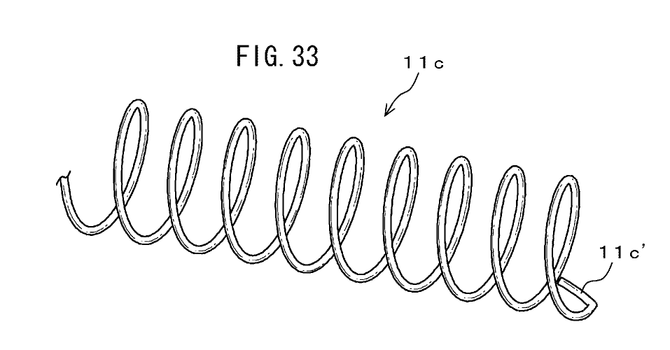

FIG. 32A is a top view showing an operation example of the cutting-and-bending mechanism 75 when bending the coil. According to the cutting-and-bending mechanism 75 shown in FIG. 32A, by further rotating the lever 75f from the cutting position thereof shown in FIG. 31A to a direction of an arrow P5, it moves to its bending position.

FIG. 32B is an enlarged view showing an operation example of the cutting-and-bending mechanism 75 indicated in a circle shown by dashed line in FIG. 32A. According to the cutting-and-bending mechanism 75 shown in FIG. 32B, the hitting-for-pinching portion 75a and the receiving-for-pinching portion 75b keep a state where the spiral coil 11 is pinched and held by the elastic force of the spring 75m hooked the spring-hooking portion 753 of the main body of the hitting-for-pinching portion 75a.

In this example, it is configured that the bending portion 75e rotates clockwise by additionally rotating the lever 75f clockwise and bends the cut end 11c′ of the cut spiral coil 11 pinched between the bending portion 75e and the receiving-for-pinching portion 75b from the base thereof inward the spiral coil 11 by about 90 degrees.

FIG. 32C is a perspective view showing an operation example of the cutting-and-bending mechanism 75 shown in FIG. 32B. According to the cutting-and-bending mechanism 75 shown in FIG. 32C, it is configured that the cut end 11c′ of the cut spiral coil 11 pinched between the hitting-for-pinching portion 75a and the receiving-for-pinching portion 75b is bent inward the spiral coil 11 by the bending portion 75e.

FIG. 33 is a partially enlarged perspective view showing a configuration example of the spiral coil 11c, an end of which has been processed. According to the spiral coil 11c, an end of which has been processed, shown in FIG. 33, it is configured that its cut end 11c′ is bent inward the spiral coil 11 by about one fifth of the arc of the circle of the spiral coil 11. This enables the end of the spiral coil 11 to be made well looked. This also enables the end of the spiral coil 11 to be prevented from catching clothes of a user. Of course, this enables the spiral coil 11 to be prevented from being slipped out of the bundle of paper-sheets 3.

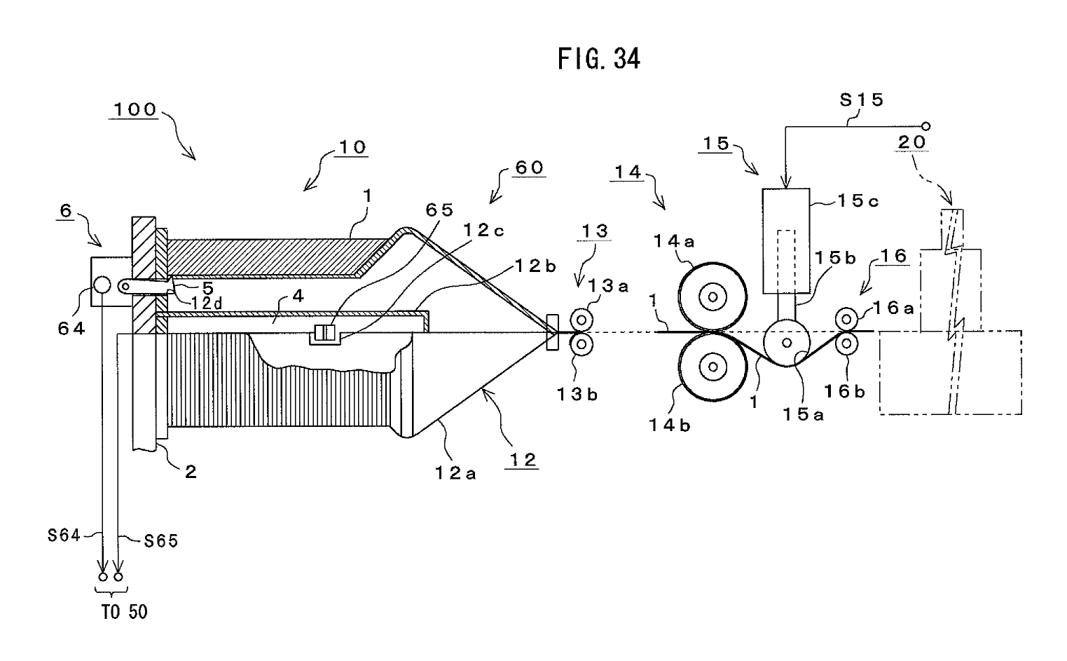

The following will describe a configuration example of a wire rod cartridge 10 and its peripheral mechanism in the paper-sheet-handling apparatus 100 with reference to FIG. 34. The wire rod cartridge 10 shown in FIG. 34 constitutes a function of a wire-rod-supplying part and is able to be mounted on the paper-sheet-handling apparatus 100 and supplies the wire rod 1 to the coil-forming mechanism 20. This example is a case where the wire rod cartridge 10 and the coil-forming mechanism 20 are laid out one item next to another along the advanced direction of the wire rod 1. Of course, a disposed position of the wire rod cartridge 10 with respect to the coil-forming mechanism 20 is not limited thereto.

The wire rod 1 (consumables) is wound on the wire rod cartridge 10. The wire rod 1 is wound so as to be, for example, multi-layered and formed in line with it keeping a predetermined pitch. It is configured that the wire rod cartridge 10 has a drum 12 on which the wire rod 1 is wound and a wire rod detection sensor 65 for detecting whether there is the wire rod or not is disposed in the drum 12. The wire rod detection sensor 65 may be attached to every drum 12 but is attached to a side of the paper-sheet-handling apparatus in order to make efforts to realize a cost reduction of the wire rod cartridge 10.

The drum 12 has a figure that is portable (can be carried). In this example, the drum 12 is provided with a bobbin 12a having a window portion 12c and a winding shaft 12b. The drum 12 has the bobbin 12a, an end of which has a cone-like shape. On the drum 12, for example, a vinyl-covered iron-core wire of around 1000 m is wound. A diameter of the wire rod 1 is around 0.8 mm.

The winding shaft 12b has a cubic shape combining rectangular shapes and a tubular shape (see FIG. 1) and is used when the wire rod 1 is wound on the bobbin 12a in a factory or the like so that after the drum has been mounted, the bobbin 12a is used with it being fixed without any rotation. The window portions 12c of the bobbin 12a and the winding shaft 12b are used when detecting whether there is the wire rod 1 or not.

In this example, an opening 12d that receives a lock portion 5 is provided at the other end of the bobbin 12a. The lock portion 5 is provided in a lock mechanism 6 installed in a side of the paper-sheet-handling apparatus 100. The lock mechanism 6 is attached to a predetermined board 2 of the paper-sheet-handling apparatus 100. It is configured that the lock portion 5 is engaged with the opening 12d for locking of the bobbin 12a and the drum 12 is fixed on the paper-sheet-handling apparatus 100. It is because the wire rod 1 is not naturally unwound from the drum 12 to use the bobbin 12a with it being fixed like this.

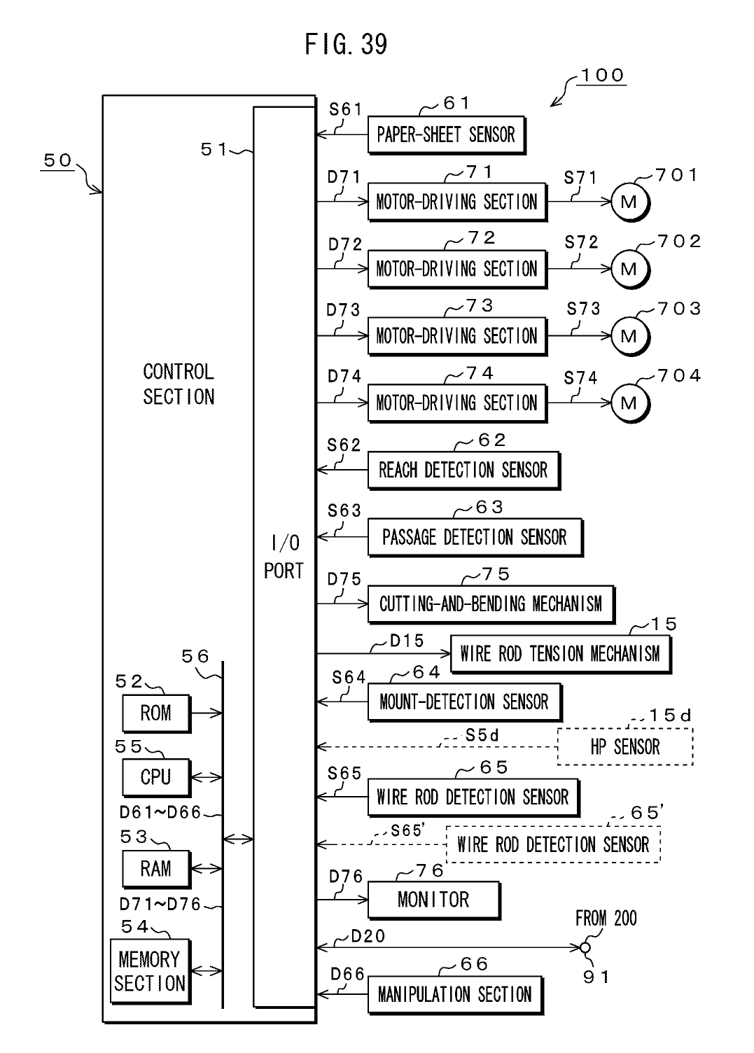

It is configured that a mount-detection sensor 64 is provided in the lock mechanism 6 and detects whether or not the wire rod cartridge 10 is mounted on the paper-sheet-handling apparatus 100 to output a mount-detection signal S64. The mount-detection signal S64 is output to the control section 50 shown in FIG. 39. A switching element or the like that detects which is on or off is used for the mount-detection sensor 64.

A wire rod detection sensor unit 60 that is disposed at a side of the paper-sheet-handling apparatus 100 is set inside the winding shaft 12b. The wire rod detection sensor unit 60 has a sensor case portion 4 mounted on the board 2. The sensor case portion 4 has, for example, a cubic shape that is one size smaller than the outside cubic shape of the winding shaft 12b reflecting the rectangular shapes and the tubular shape thereof. It is because the wire rod detection sensor unit 60 is inserted into the inside of the winding shaft 12b to use such a cubic configuration.

A wire rod detection sensor 65 constituting a function of a detection part is provided at the rectangular part of the wire rod detection sensor unit 60 and detects whether there is the wire rod 1 wound on the drum 12 or not to output a wire rod detection signal S65. The wire rod detection signal S65 is output to the control section 50. An optical sensor of a reflection or transmission type is used for the wire rod detection sensor 65. The wire rod detection sensor 65 is disposed at a position such that its light-emitting element and light-receiving element are seen from the window portions 12c of the bobbin 12a and the winding shaft 12b. It is because the detection whether there is the wire rod 1 wound on the drum 12 or not is performed to dispose the wire rod detection sensor 65 at this position.

It is to be noted that first position control rollers 13, wire-rod-drawing-out rollers 14, a wire rod tension mechanism 15 and second position control rollers 16 are provided at a downstream side of the drum 12. The position control rollers 13 are configured to have an upper roller 13a and a lower roller 13b and are set near a peak of the cone-line part of the drum 12. The wire rod 1 is made passed through between the upper roller 13a and the lower roller 13b. The position control rollers 13 are configured to control a dispatched position of the wire rod 1 drawn out of the drum 12.

The wire-rod-drawing-out rollers 14 are configured to have an upper roller 14a and a lower roller 14b and are set at an upstream side of the wire rod tension mechanism 15. The wire rod 1 is made passed through between the upper roller 14a and the lower roller 14b. The wire-rod-drawing-out rollers 14 operate to draw the wire rod 1 out of the drum 12. The wire rod tension mechanism 15 is configured to have a tension roller 15a, a driving arm 15b and a driving portion 15c and is set at a downstream side of the wire-rod-drawing-out rollers 14. The tension roller 15a is attached to the driving arm 15b. The tension roller 15a is driven by the driving portion 15c and operates to apply any tension to the wire rod 1 drawn out of the drum 12. The driving portion 15c operates to apply an operating force to the tension roller 15a based on a tension control signal S15. For the driving portion 15c, a solenoid, not shown, is used. It is because the wire rod 1 is prevented from being loose between the drum 12 and the coil-forming mechanism 20 to apply any tension to the wire rod 1.

The position control rollers 16 are set at a downstream side of the tension roller 15a. The position control rollers 16 are configured to have an upper roller 16a and a lower roller 16b and control an insertion position of the wire rod 1 for inserting it into the coil-forming mechanism 20. The peripheral mechanism between the wire rod cartridge 10 and the coil-forming mechanism 20 is configured by them.

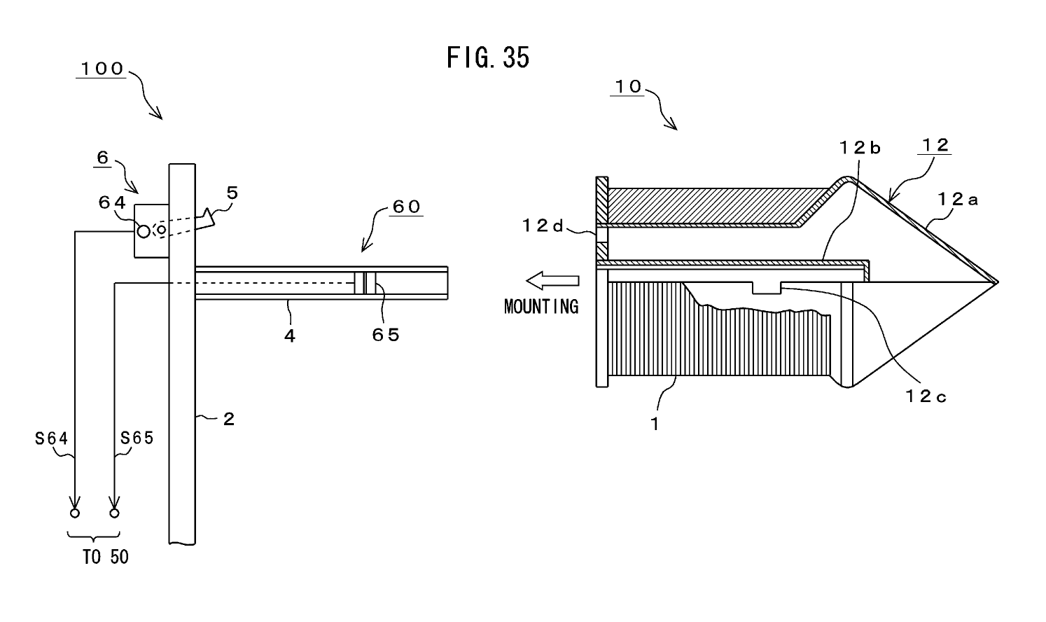

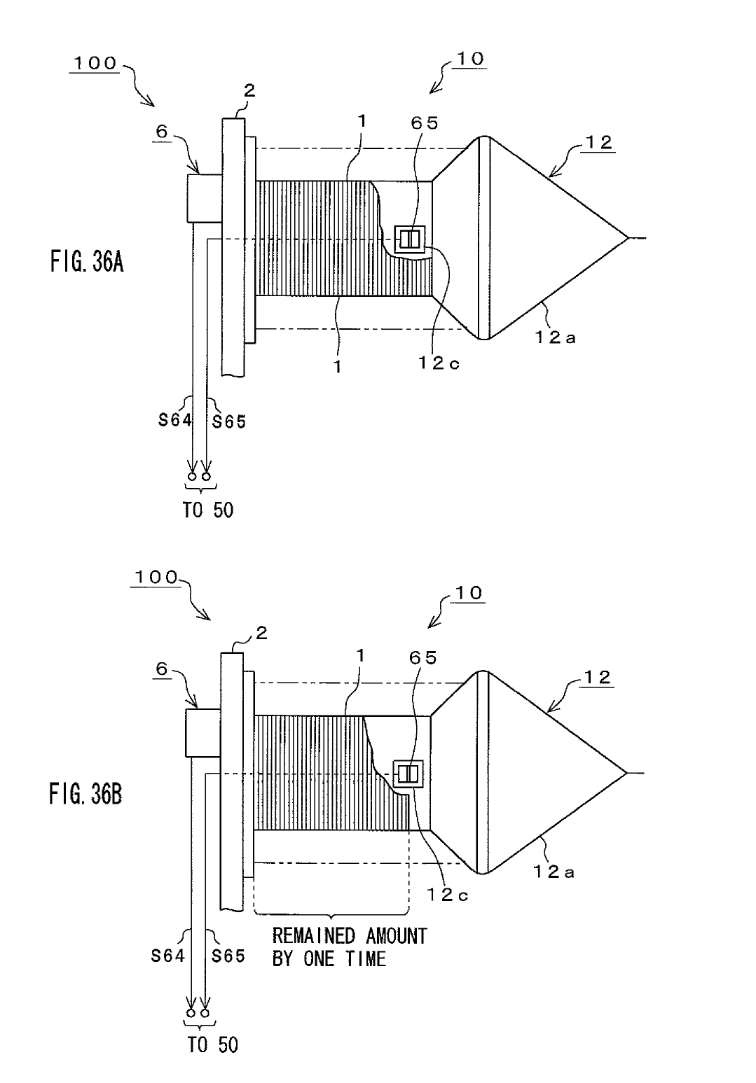

Here, a description will be given of amounting example of the wire rod cartridge 10 with reference to FIG. 35. To the wire rod cartridge 10 shown in FIG. 35, the one is applied in which the wire rod 1 is wound so as to be multi-layered and formed in line with it keeping a predetermined pitch. In this example, the mounting is performed so that the winding shaft 12b of the wire rod cartridge 10 and the sensor case portion 4 of the wire rod detection sensor unit 60 are aligned and the winding shaft 12b covers the wire rod detection sensor unit 60.

At this moment, when the lock portion 5 of the lock mechanism 6 installed in a side of the paper-sheet-handling apparatus 100 is aligned with the opening 12d of the bobbin 12a and the wire rod cartridge 10 is inserted into the sensor case portion 4, the lock portion 5 can be locked at the opening 12d and the light-emitting element and the light-receiving element of the wire rod detection sensor 65 can be disposed at a self-aligning aim under the window portions 12c of the bobbin 12a and the winding shaft 12b.

This enables the wire rod detection sensor unit 60 in a side of the paper-sheet-handling apparatus 100 to be set inside the winding shaft 12b of the wire rod cartridge 10. By using the wire rod detection sensor 65 of the wire rod detection sensor unit 60, it is possible to detect whether there is the wire rod 1 wound on the bobbin 12a or not.

The following will describe function examples of the wire rod detection sensor 65 in the wire rod cartridge 10 with reference to FIGS. 36A and 36B. According to the wire rod detection sensor 65 shown in FIG. 36A, it is designed that when there is the wire rod 1 on the drum 12, the wire rod detection signal (on signal) S65 of high level (hereinafter, referred to as “H level”) is output. In this case, for example, a state is such that the wire rod 1 is wound on the bobbin 12a so as to be layered more than one layer and formed in line with it keeping a predetermined pitch without any space and the window portion 12c of the bobbin 12a is covered by the wire rod 1. Under this state, light emitted from the light-emitting element of the wire rod detection sensor 65 is reflected by the wire rod lover the window portion 12c and is made incident onto the light-receiving element. Thus, the wire rod detection sensor 65 is kept on and keeps on outputting the wire rod detection signal S65 of H level.

According to the wire rod detection sensor 65 shown in FIG. 36B, it is designed that when there is no wire rod 1 on the drum 12, the wire rod detection signal S65 of low-level (hereinafter, referred to as “L level”) is output. In this case, a state is such that the wire rod 1 has been wound on the bobbin 12a so as to be layered by one layer but the wire rod 1 is progressively consumed so that there is no wire rod 1 stayed over the window portion 12c to expose the window portion 12c. Under this state, light emitted from the light-emitting element of the wire rod detection sensor 65 releases outside from the window portion 12c so that the light is not made incident onto the light-receiving element. Thus, it is configured that the wire rod detection sensor 65 is made off and outputs the wire rod detection signal S65 of L level. It is to be noted that logic of the signal showing whether there is the wire rod or not by the wire rod detection signal S65 may be reversal signals, for example, S65 of L level and S65 of H level.

In this example, a position at which the wire rod detection sensor 65 is installed may be preferably set to a part that can detect a state where a wire rod remains by a length such that the spiral coil 11c having maximum diameter of the coil that can be formed by the coil-forming mechanism 20 and having the length same as that of a width of paper-sheet can be formed. Although a used amount of the wire rod 1 is different based on the diameters of the coils, when such a position is set thereto, it is possible to prevent the wire rod 1 from being interrupted on the way of forming the coil and the binding processing from being suspended even if the wire rod 1 having a length such that the spiral coil 11c by one time can be formed remains on the drum 12.

Such a configuration of the wire rod detection sensor unit 60 enables a wire rod residual quantity display system to display that there is the wire rod 1 on the drum 12 by, for example, the wire rod detection signal S65 of H level outputted from the wire rod detection sensor 65. On the contrary, it enables the wire rod residual quantity display system to display that there is no wire rod 1 on the drum 12 by the wire rod detection signal S65 of L level outputted from the wire rod detection sensor 65.

Next, a description will be given of another disposition example of the wire rod cartridge 10 and a configuration example of another wire rod detection sensor 65′. In this example, a case is such that the wire rod cartridge 10 is disposed at a position that is perpendicular to the coil-forming mechanism 20 and the wire rod 1 drawn out of the wire rod cartridge 10 is guided so that the advanced direction thereof is bent by 90 degrees. Such a disposition of the wire rod cartridge 10 enables the paper-sheet-handling apparatus 100 to be designed so as to be vertically oriented.

Further, although a case in which the wire rod detection sensor unit 60 shown in FIG. 34 is provided in the drum 12 has been described, it is not limited thereto: a case in which it is provided outside the drum 12 is preferable. For example, the wire rod detection sensor 65′ is disposed on the wire rod tension mechanism 15 provided between the drum 12 and the coil-forming mechanism 20.

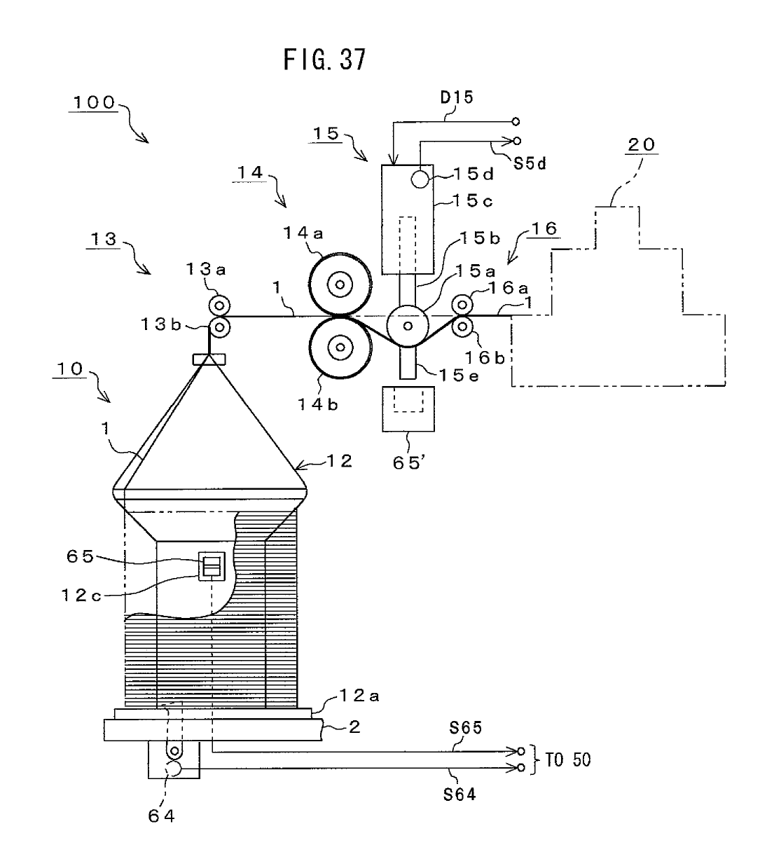

The wire rod detection sensor 65′ shown in FIG. 37 is added to the wire rod tension mechanism 15 and detects whether or not any tension is applied to the wire rod 1 drawn out of the drum 12 to output a wire rod detection signal S65′. For the wire rod detection sensor 65′, an optical sensor of transmission type is used.

In this example, a lower part of the driving arm 15b of the wire rod tension mechanism 15 shown in FIG. 34 is elongated and this elongated part is formed as a light shield portion 15e to the wire rod detection sensor 65′. The wire rod detection sensor 65′ is disposed at a predetermined position under the wire rod tension mechanism. For example, it is disposed at a lower part of the light shield portion 15e of the elongated driving arm 15b. Such a configuration of the wire rod detection sensor 65′ may detect whether or not there is the wire rod 1 drawn out of the drum 12 based on the tension (reactive force) of the wire rod in a wire-rod-carrying path.

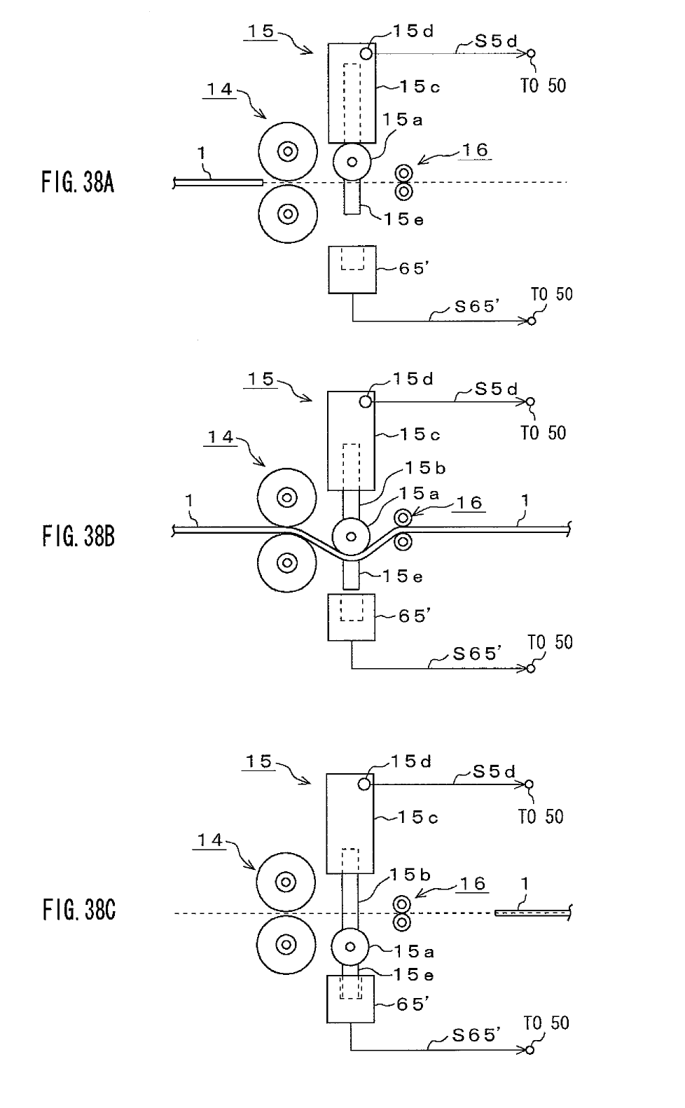

Next, a description will be given of a function example of the wire rod detection sensor 65′ with reference to FIGS. 38A to 38C. The wire rod tension mechanism 15 shown in FIG. 38A is a case where the tension roller 15a stays at its uppermost position (home position). In this case, a home position sensor (hereinafter, referred to as “HP sensor 15d”) provided at the wire rod tension mechanism 15 is made off to output, for example, an off signal S5d of L level. At this moment, the wire rod detection sensor 65′ is made on to output, for example, a wire rod detection signal S65′ of H level.

The wire rod tension mechanism 15 shown in FIG. 38B is a case where any tension is applied to the wire rod 1 through the driving portion 15c and the tension roller 15a. In this case, the tension roller 15a is balanced by the reactive force from the wire rod 1. In this case, the HP sensor 15d is made on to output, for example, an on signal S5d of H level. At this moment, the wire rod detection sensor 65′ is remained on to keep on outputting the wire rod detection signal S65′ of H level.

The wire rod tension mechanism 15 shown in FIG. 38C is a case where there is no wire rod 1 and the driving portion 15c makes the tension roller 15a fall down to its lowermost position. In this case, it is configured that the HP sensor 15d is made on but the light shield portion elongated from the driving arm 15b shields the light from the wire rod detection sensor 65′ because of no reactive force from the wire rod 1. Thereby, the wire rod detection sensor 65′ is made off to output a wire rod detection signal S65′ of L level.

Thus, by the wire rod cartridge 10 according to this invention, when the spiral coil 11 is formed by the wire rod 1 having a predetermined thickness and the paper-sheets are bundled and bound by the coil, the wire rod detection sensor 65 provided at the wire rod detection sensor unit 60 and the wire rod detection sensor 65′ provided at the wire rod tension mechanism 15 detect whether or not there is the wire rod 1 wound on the drum 12 of the wire rod cartridge 10 that is mounted on the paper-sheet-handling apparatus 100.

Therefore, it is possible to read whether there is the wire rod 1 on the drum 12 using an electric signal. In the above-mentioned example, it is designed that by the wire rod detection signal S65 of L level output from the wire rod detection sensor 65, the on signal S5d of H level of the HP sensor 15d and the wire rod detection signal S65′ of L level, it is made possible to acknowledge (notice) that there is no wire rod 1. This enables the coil-forming system, the binding system, the wire-rod-existence-and-nonexistence-displaying system or the like in the control system in the paper-sheet-handling apparatus 100 on which the wire rod cartridge 10 is mounted to be controlled based on the wire rod detection signal S65 or S65′ output from the wire rod detection sensor 65 or 65′.

The following will describe a configuration example of a control system of the paper-sheet-handling apparatus 100 with reference to FIG. 39. The paper-sheet-handling apparatus 100 shown in FIG. 39 is configured to have a control section 50, a paper-sheet sensor 61, a reach detection sensor 62, a passage detection sensor 63, the wire rod detection sensor 65, a manipulation section 66, motor-driving sections 71 through 74, the cutting-and-bending mechanism 75 and a monitor 76.

The control section 50 is configured to have an Input/Output (I/O) port 51, an Read Only Memory (ROM) 52, an Random Access Memory (RAM) 53 for working, a memory section 54, a Central Processing Unit (CPU) 55 and a system bus 56. The ROM 52 is connected to the CPU 55 via the system bus 56 and stores program data D52 for booting up the system that controls whole of the apparatus. The RAM 53 is connected to the CPU 55 via the system bus 56. It is designed that the RAM 53 temporarily stores program data D52, control commands when performing the binding processing based on various kinds of the diameters of the coils, and the like. It is configured that if a power supply is actuated, the CPU 55 reads the program data D52 out of the ROM 52 and extract it on the RAM 53, thereby booting up the system to control whole of the apparatus.

It is configured that to the system bus 56, in addition to the above-mentioned ROM 52, RAM 53 and CPU 55, the memory section 54 is connected and stores paper-sheet detection data D61, forward end detection data D62, forward-end-passage data D63, mounting-detection data D64, the wire rod detection data D65, manipulation data D66, motor control data D71 through D75, display data D76 and the like, in addition to any control data D20. For the memory section 54, Electric Erasable Program Read Only Memory (EEPROM) or Hard Disk Drive (HDD) is used.

The memory section 54 stores any control programs for the binding mechanism 40 or the like. In this example, when the system boots up, the CPU 55 reads the control programs out of the memory section 54 and extract them on the RAM 53. In the above-mentioned control programs, reference values for deciding a size of the spiral coil 11 based on a number of paper-sheets are set.

For example, as the reference values, the numbers of paper-sheets 40, 70, 100 and the like in the bundle of paper-sheets 3 are set. The memory section 54 respectively stores setting data of the section #Ø8 like an arc of a circle for forming the diameter of coil of 8 mm in response to the number of paper-sheets 40 in the bundle of paper-sheets 3; setting data of the section #Ø11 like an arc of a circle for forming the diameter of coil of 11 mm in response to the number of paper-sheets 70 in the bundle of paper-sheets 3; and setting data of the section #Ø14 like an arc of a circle for forming the diameter of coil of 14 mm in response to the number of paper-sheets 100 in the bundle of paper-sheets 3.

The CPU 55 reads the setting data corresponding to the thickness of the bundle of paper-sheets 3 and controls a selection mechanism 28′. In this example, the CPU 55 decides the diameter of the spiral coil 11 to be used based on these reference values and the information of the number of paper-sheets in the control data D20. The control data D20 is received from any high-ranking image-forming apparatus or the like.

The CPU 55 is connected to the manipulation section 66, via the I/O port 51, which is manipulated when starting up the binding process. In this example, two functions of a case where the paper-sheet-handling apparatus 100 is solely managed and used (hereinafter, referred to as “manual mode”) and a case where it comes under the control of the image-forming apparatus 200 such as a copy machine and a printer and integrally managed by any high ranking control system (hereinafter, referred to as “finisher mode”) are provided.

When performing the coil-binding processing in the manual mode, the manipulation section 66 is manipulated so as to output the manipulation data D66 on setting of the diameter of the coil, boot-up command and the like to the CPU 55 via the I/O port 51. As the diameter of the coil, any one of the sections #Ø8, #Ø11 and #Ø14 each like an arc of a circle is selected in response to the thickness of the bundle of paper-sheets 3 (fourth paper-sheet-handling apparatus).

When the paper-sheet-handling apparatus 100 performs the coil-binding processing in the finisher mode, the control data D20 such as information on the numbers of paper-sheets and information on a transfer report of paper-sheets is received from the high ranking control system. The paper-sheet-handling apparatus 100 has an input/output terminal 91. The input/output terminal 91 is connected to the I/O port 51. The above-mentioned image-forming apparatus 200 is connected to the input/output terminal 91. It is configured that the paper-sheet-handling apparatus 100 detects, for example, the number of paper-sheets from the control data D20 and automatically selects any of the diameters of the coils of 8 mm, 11 mm and 14 mm, which corresponds to the number of paper-sheets to set any one of the sections #Ø8, #Ø11 and #Ø14 each like an arc of a circle, so that the spiral coil 11 can be formed on the basis of the section #Ø8 like an arc of a circle or the like (third paper-sheet-handling apparatus).

The paper-sheet sensor 61 is connected to the I/O port 51. The paper-sheet sensor 61 outputs to the I/O port 51a paper-sheet-existence-or-nonexistence signal S61 obtained by detecting whether or not the bundle of paper-sheets 3 is mounted on the binding mechanism 40. The I/O port 51 is provided with an analog to digital converter, not shown, which converts the paper-sheet-existence-or-nonexistence signal S61 to the paper-sheet detection data D61. The paper-sheet detection data D61 is output from the I/O port 51 to the CPU 55 of the control section 50. The CPU 55 controls the coil-forming part 28 and the binding mechanism 40 after it has checked that there is the wire rod 1 on the wire rod cartridge 10.

In this example, a paper-sheet thickness detection sensor having a function to detect a thickness of the bundle of paper-sheets 3 may be applied to the paper-sheet sensor 61. For example, the paper-sheet thickness detection sensor is configured such that light-shielding slits are provided at predetermined position of the arm of the paper-sheet clamp 45 and plural optical sensors of transmission type for detecting cases where the bundle of paper-sheets 3 includes 40 sheets or less, 70 sheets or less and 100 sheets or less are disposed thereon.

The mount-detection sensor 64 is connected to the I/O port 51 and detects whether or not the wire rod cartridge 10 is mounted on the paper-sheet-handling apparatus 100 to output the mount-detection signal S64. The mount-detection signal S64 is converted to the mount-detection data D64 in the I/O port 51. The mount-detection data D64 is output from the I/O port 51 to the CPU 55. The mount-detection sensor 64 outputs, for example, the mount-detection data D64 of H level when the wire rod cartridge 10 is mounted thereon and outputs the mount-detection data D64 of L level when the wire rod cartridge 10 is not mounted thereon.

The wire rod detection sensor 65 other than the mount-detection sensor 64 is connected to the I/O port 51 and detects whether there is the wire rod 1 wound on the drum 12 or not to output the wire rod detection signal S65. The wire rod detection signal S65 is converted to the wire rod detection data D65 in the I/O port 51. The wire rod detection data D65 is output from the I/O port 51 to the CPU 55. The wire rod detection sensor 65 outputs, for example, the wire rod detection data D65 of H level when the wire rod remains and outputs the wire rod detection data D65 of L level when the wire rod does not remain.

The monitor 76 constituting a function of the display part other than the paper-sheet sensor 61, the mount-detection sensor 64 and the wire rod detection sensor 65 is connected to the I/O port 51. The CPU 55 receives the paper-sheet detection data D61, the mount-detection data D64 and the wire rod detection data D65 to control a display on the monitor 76. For example, the monitor 76 displays a message such that “the bundle of paper-sheets 3 is not mounted on the binding mechanism 40” based on the paper-sheet detection data D61 or “the wire rod cartridge 10 is not mounted” based on the mount-detection data D64 of L level or displays whether or not there is the wire rod 1 on the drum 12 based on the wire rod detection data D65.

In this example, it displays character information or the like for promote the mounting of the wire rod cartridge 10 based on the mount-detection data D64 of L level or displays character information or the like for promote the exchange of the wire rod cartridge 10 based on the wire rod detection data D65 of L level when the wire rod does not remain. This allows any shorts of the wire rod 1 (consumables) to be known through the mediation of no person (mechanically).

The CPU 55 is connected to the I/O port 51 to which the motor-driving sections 71 through 74 are connected. The CPU 55 decides the diameter of the spiral coil 11 to be used on the basis of the above-mentioned reference values and the information on the number of the paper-sheets in the control data D20 and then, controls the drives of the motor-driving sections 71 through 74 based on the decided result thereof.

In the motor-driving section 71 connected to the above-mentioned I/O port 51, from the three sections #Ø8, #Ø11 and #Ø14 each like an arc of a circle in the forming adaptor 28a of the coil-forming mechanism 20, any one section like an arc of a circle corresponding to the paper thickness is selected on the basis of the motor control data D71.

For example, the motor 701 is connected to the motor-driving section 71. The motor-driving section 71 generates a motor control signal (voltage) S71 from the motor control data D71 and outputs the motor control signal S71 to the motor 701. The motor 701 rotates counter-clockwise based on the motor control signal S71 to rotate the forming adaptor 28a for setting the diameter of the coil and select the semi-circle cut-away section #Ø8 like an arc of a circle or the like. The motor control data D71 is output from the control section 50 to the motor-driving section 71.

The motor-driving section 73 other than the motor-driving section 71 is connected to the I/O port 51 and sets the position of the spiral coil 11 in the binding mechanism 40 based on the motor control data D73. For example, the motor 703 is connected to the motor-driving section 73. The motor-driving section 73 generates a motor control signal (voltage) S73 from the motor control data D73 and outputs the motor control signal S73 to the motor 703. The motor 703 rotates the guide-switching cam 34b counter-clockwise to move the screw guide 49 to the direction that is perpendicular to the advanced direction of the coil. This movement is because the screw guide 49 is set corresponding to the diameter of the coil. The motor control data D73 is output from the control section 50 to the motor-driving section 73.

In this example, when the control data D20 from the high ranking control system indicates the setting of the position of the spiral coil 11a having the small diameter, the CPU 55 at least controls the feed roller 31 to move by the first distance d1 to the vertical direction and controls the screw guide 49 to move by the first distance d1' to a direction in which it comes close to the punched holes 3a of the bundle of paper-sheets 3.

When the control data D20 indicates the setting of the position of the spiral coil 11b having the middle diameter, it controls the feed roller 31 to move by the second distance d2 to the vertical direction and controls the screw guide 49 to move by the second distance d2′ to a direction in which the guide comes close to the punched holes 3a of the bundle of paper-sheets 3. When the control data D20 indicates the setting of the position of the spiral coil 11c having the large diameter, it controls the feed roller 31 to move by the third distance d3 to the vertical direction (d1>d2>d3). At the same time thereof, the CPU 55 controls the screw guide 49 to move by the third distance d3′ to a direction in which it comes close to the punched holes 3a of the bundle of paper-sheets 3 (d1′>d2′>d3′). This enables the positions of the feed roller 31 and the screw guide 49 to be adjusted after the clamping by the binding mechanism 40 based on the motor control data D73 (see FIG. 16B).

The motor-driving section 72 other than the motor-driving sections 71, 73 is connected to the I/O port 51 and rotates the upper and lower dispatching rollers 23a, 23b of the coil-forming mechanism 20 based on the motor control data D72. For example, the motor 702 is connected to the motor-driving section 72. The motor-driving section 72 generates a motor control signal (voltage) S72 from the motor control data D72 and outputs the motor control signal S72 to the motor 702. The motor 702 rotates counter-clockwise to rotate the lower dispatching roller 23b clockwise through the lower large diameter gear 24b and to rotate the upper dispatching roller 23a counter-clockwise through the large diameter gear 24a. The motor control data D72 is output from the control section 50 to the motor-driving section 72.

It is to be noted that the wire rod tension mechanism 15 is connected to the I/O port 51 which outputs tension control data D15 to the driving portion 15c thereof. The driving portion 15c controls the tension roller 15a based on the tension control data D15. The HP sensor 15d is provided in the wire rod tension mechanism 15 in response to the setting of the wire rod detection sensor 65 or 65′. When the wire rod detection sensor 65′ is installed in the paper-sheet-handling apparatus 100, the HP sensor 15d and the wire rod detection sensor 65′ are connected to the I/O port 51. It is configured that the HP sensor 15d outputs the on/off signal S5d to the I/O port 51 of the control section 50. In the I/O port 51, the on/off signal S5d is converted from analog to digital to become on/off data D5d which is output to the CPU 55.

The motor-driving section 74 other than the motor-driving sections 71 through 73 is connected to the I/O port 51. The motor-driving section 74 generates a motor control signal (voltage) S74 from the motor control data D74 and outputs the motor control signal S74 to the motor 704. The motor 704 rotates the spiral coil 11 in the binding mechanism 40 based on the motor control signal S74. For example, the motor 704 rotates the feed roller 31 counter-clockwise to rotate the spiral coil 11 clockwise. The motor control data D74 is output from the control section 50 to the motor-driving section 74.

In this example, the CPU 55 controls the binding speed of the spiral coil 11 by setting a rotation speed V1 of the spiral coil 11 dispatched from the coil-forming part 28 and a rotation speed V2 of the spiral coil 11 in the binding mechanism 40 to be V1≦V2. The rotation speed V1 is set in the motor-driving section 73 via the motor control data D73. The motor-driving section 73 controls the motor 702 in the coil-forming mechanism 20 to be the rotation speed V1 based on the motor control data D73.

The rotation speed V2 is set in the motor-driving section 74 via the motor control data D74. The motor-driving section 74 controls the motor 704 in the binding mechanism 40 to be the rotation speed V2 based on the motor control data D74. When the rotation speeds V1, V2 are thus set to be V1≦V2, it is possible to insert the spiral coil 11 smoothly so that the forward end of the spiral coil 11 inserted into a punched hole at an end of the bundle of paper-sheets 3 can reach a punched hole at the other end of the bundle of paper-sheets 3 without any jam on its way.

The reach detection sensor 62 constituting a function of a first detection part is connected to the I/O port 51. The reach detection sensor 62 detects reaching of the forward end of the spiral coil 11 in the binding mechanism 40 and outputs a forward end detection signal S62. The forward end detection signal S62 is converted to the forward end detection data D62 in the I/O port 51. The forward end detection data D62 is output from the I/O port 51 to the CPU 55.

The CPU 55 controls the motor-driving section 73 based on the forward end detection data D62 received from the I/O port 51. If such a reach detection sensor 62 is disposed in the binding mechanism 40, it is possible to carry out any stop control of the coil carriage when the forward end of the spiral coil 11 inserted into a punched hole at one end of the bundle of paper-sheets 3 reaches to the other end of the bundle of paper-sheets 3.

In this example, the passage detection sensor 63 constituting a function of a second detection part other than the reach detection sensor 62 is connected to the I/O port 51 and detects a passage of the forward end of the spiral coil 11 to output a forward-end-passage signal S63. The forward-end-passage signal S63 is converted to forward-end-passage data D63 in the I/O port 51. The forward-end-passing data D63 is output from the I/O port 51 to the CPU 55. The CPU 55 controls the motor-driving section 74 based on the forward-end-passage data D63 received from the I/O port 51. It is to be noted that in connection with the detection of the passage of the forward end of the spiral coil 11, a dispatched amount thereof may be detected by a number of revolution of the motor 704.

If such a passage detection sensor 63 is disposed in the binding mechanism 40, it is possible to carry out any slowdown control of the coil carriage before the forward end of the spiral coil 11 inserted into a punched hole at one end of the bundle of paper-sheets 3 has reached the other end of the bundle of paper-sheets 3.

The cutting-and-bending mechanism 75 other than the motor-driving sections 71 through 74 is connected to the I/O port 51 and operates to cut the spiral coil 11 in the binding mechanism 40 based on the cut control data D75. For example, it is configured that a motor, not shown, is provided in the cutting-and-bending mechanism 75 and the motor rotates to a predetermined direction so that the cutter can operate to cut the coil and bend the forward end and a tail end thereof. The cut control data D75 is output from the control section 50 to the cutting-and-bending mechanism 75.

Thus, in the paper-sheet-handling apparatus 100, the coil-forming device according to the invention is provided and the coil pitch of the spiral coil 11 may be limited so as to be a fixed pitch thereof when the bundle of paper-sheets 3 having a predetermined thickness is bound and the spiral coil 11 is formed from the wire rod 1 having a predetermined thickness so that it is possible to dispatch the spiral coil 11 having no changed pitch even if the diameter of the coil changes with good reproducibility.

In the binding mechanism 40, the bundle of paper-sheets 3 is bound by the spiral coil 11a or the like having a predetermined diameter of the coil and a fixed pitch, which is obtained from the coil-forming part 28. Accordingly, it is possible to select the spiral coil 11 having a desired diameter of the coil corresponding to the thickness when the pitch between the punched holes of the paper-sheet P is the same and the thicknesses of the bundles of paper-sheets 3 are different so that the binding processing using the spiral coil 11 may be performed with good reproducibility. This enables to be provided the finisher 100′ to which a coil-forming device having a simple configuration is applied. Further, the configuration of the coil-forming part 28 may be made simplified so that the whole of system may be made compact as well as the sections each like an arc of a circle are automatically switched so that it can be used together with the image-forming device 200 and any general office equipment such as a printer.

Further, according to the paper-sheet-handling apparatus 100, it is configured that the control section 50 that inputs diameter-of-coil-setting information for setting the diameter of the coil is provided and it controls the positions of the movable feed roller 31 and the screw guide 49 at a moving adjustable side. Accordingly, it is possible to move the feed roller 31 and the screw guide 49 at a moving adjustable side to the guided position of the spiral coil 11a or the like indicated by the diameter-of-coil-setting information. This enables the spiral coil 11a, 11b or 11c having different diameter 8 mm, 11 mm or 14 mm to pass through the punched holes 3a of the bundle of paper-sheets 3 stably.

Further, according to the paper-sheet-handling apparatus 100, it is configured that the paper-sheet-attaching pin 46d that limits to align the forward ends of respective paper-sheets in the bundle of paper-sheets 3 mounted on the paper-sheet-mounting base 46 and the paper-sheet-aligning guide 41 that limits to align the side edge 3b of each of the paper-sheets P, which has been limited by the paper-sheet-attaching pin 46d, in the bundle of paper-sheets 3 mounted on the paper-sheet-mounting base 46 are provided and the paper-sheet-aligning guide 41 includes the paper-sheet-aligning surface that has a predetermined inclination with respect to the surface of the paper-sheet-mounting base 46, on which the paper-sheets are mounted, so that the side edge 3b of the bundle of paper-sheets 3 is obliquely limited along the inclination of the paper-sheet-aligning surface. Accordingly, a shape of punched holes 3a of the bundle of paper-sheets 3 can alter from vertical one to oblique one so that it is possible to pass the spiral coil 11 or the like smoothly through the punched holes 3a of the bundle of paper-sheets 3, which have altered to the oblique one.

Further, according to the paper-sheet-handling apparatus 100, it is configured that the cutting-and-bending mechanism 75 is provided and the end of the spiral coil 11 or the like is pinched and held by the hitting-for-pinching portion 75a and the receiving-for-pinching portion 75b, and the pinched and held end of the spiral coil 11 is cut and bent to a predetermined direction. Accordingly, it is possible to the cutting-and-bending mechanism 75 at a position in which the spiral coil 11a starts passing through the punched holes 3a of the bundle of paper-sheets 3. It is also possible to perform the cutting-and-bending process on the end of the spiral coil 11a passed through the punched holes 3a thereof surely while the end thereof is held and fixed. This enables to be provided the finisher or the like that realizes a series of steps in processes from the coil-forming process to the coil-cutting process through the coil-binding processing within one case.

Further, on the paper-sheet-handling apparatus 100, the wire rod cartridge 10 according to the invention is mounted so that the CPU 55 can control the coil-forming mechanism 20 and the binding mechanism 40 based on the wire rod detection data D65 obtained from the wire rod detection sensor 65. Accordingly, it is possible to determine whether or not the binding processing can be continuously performed on the bundle of paper-sheets 3 by the spiral coil 11 as it stands based on the wire rod detection data D65 output from the wire rod detection sensor 65 or to inform a user of the exchange of the wire rod cartridge 10 or the like.

### Embodiment 1

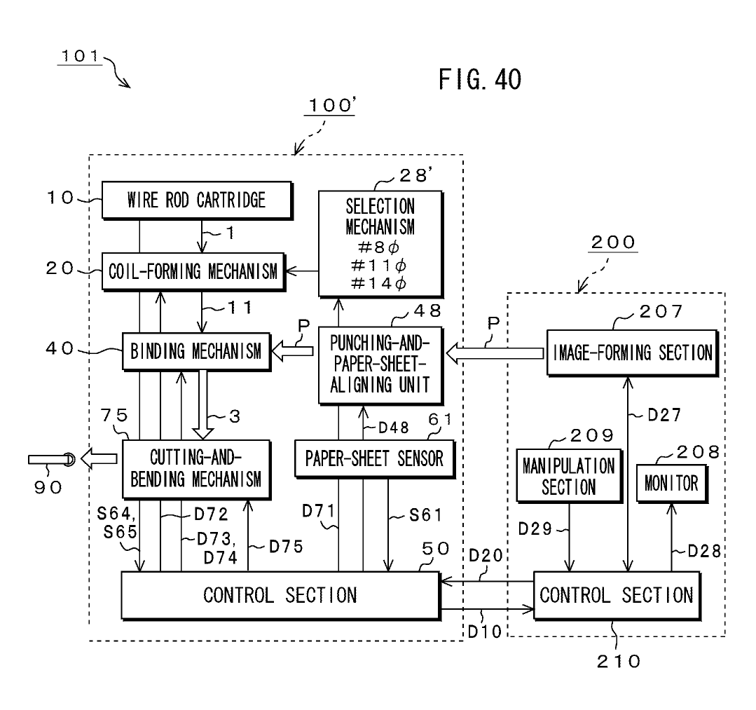

The following will describe a paper-sheet-handling method in an image-forming system 101 as a first embodiment of the invention with reference to FIG. 40. The image-forming system 101 shown in FIG. 40 is a binding processing system in which the finisher 100′ according to the invention and the image-forming apparatus 200 such as copy machine and a printer are provided; the paper-sheets P released from the image-forming apparatus 200 are bundled; the spiral coil 11 is formed from the wire rod 1 having a predetermined thickness; and the bundle of paper-sheets 3 is bound by the coil.

The image-forming apparatus 200 is such that images are formed on the predetermined paper-sheets P to release them in order to obtain the bundle of paper-sheets 3. The image-forming apparatus 200 is configured to have an image-forming section 207, a monitor 208, a manipulation section 209 and a control section 210. The image-forming section 207 is such that image control data D27 is received and a black-and-white image and/or a color image are formed on the predetermined paper-sheets P to release them. For the image-forming section 207, an image-forming unit of an electrophotographic system or an ink jet system is used.

The monitor 208 is such that display data D28 is received and image-forming conditions such as a density, a species of the paper-sheet, a number thereof and the like when forming the black-and-white image and/or the color image and existence or nonexistence of the request for the binding processing are displayed. The manipulation section 209 is manipulated so as to set the image-forming conditions and existence or nonexistence of the request for the binding process. Manipulation data D29 set by the manipulation of the manipulation section 209 or the like is output to the control section 210. For the manipulation section 209, numeric keys, a touch panel disposed on the monitor 208 or the like is used.

The control section 210 controls input/output of each of the image-forming section 207, the monitor 208, the manipulation section 209 and the control section 210. For example, the control section 210 receives the manipulation data D29 from the manipulation section 209 and outputs the image control data D27 to the image-forming section 207 to perform the image-forming control or outputs the display data D28 to the monitor 208 to perform the display control.

In this image-forming system 101, the control data D20 is output from the image-forming apparatus 200 to the finisher 100′. The control data D20 includes size information of the paper-sheet, number information of the carried paper-sheets, starting information of the paper-sheet carriage, carrying speed information of the paper-sheets and/or finishing information of the paper-sheet carriage and is such that it controls operation of the finisher 100′ in the image-forming apparatus 200.

The finisher 100′ (post-processing apparatus) constitutes a function of the first paper-sheet-handling apparatus and is configured to have the wire rod cartridge 10, the coil-forming mechanism 20, the selection mechanism 28′, the binding mechanism 40, a punching-and-paper-sheet-aligning unit 48, the control section 50, the paper-sheet sensor 61 and the cutting-and-bending mechanism 75. The finisher 100′ has the function of the paper-sheet-handling apparatus 100 as the embodiment of the invention, which has been described on FIGS. 1 through 39. To the punching-and-paper-sheet-aligning unit 48, the punch-processing unit in the paper-sheet-handling apparatus, which the applicant has filed in Japan (as Japanese Patent Application No. 2005-216562), and the binding-processing unit in the paper-sheet-handling apparatus, which the applicant has then filed in Japan (as Japanese Patent Application No. 2005-222215), can be applied.

In the finisher 100′, the wire rod cartridge 10 supplies the wire rod 1 to the coil-forming mechanism 20 and has an attachable and detachable shape with respect to the finisher 100′ (see FIG. 1). The selection mechanism 28′ receives the control data D20 from the image-forming apparatus 200 and operates to select any one diameter of the coil of 8 mm or the like corresponding to the thickness of the bundle of paper-sheets 3 from the three species of the sections #Ø8, #Ø11 and #Ø14 each like an arc of a circle for setting the diameter of the coil. At this moment, the paper-sheet-existence-or-nonexistence signal S61 obtained by detecting the existence or nonexistence of the bundle of paper-sheets 3 by the paper-sheet sensor 61 may be output to the control section 50 and the control section 50 may select any one diameter of the coil of 8 mm or the like corresponding to the thickness of the bundle of paper-sheets 3 from the three species of the sections #Ø8, #Ø11 and #Ø14 each like an arc of a circle for setting the diameter of the coil (the third paper-sheet-handling apparatus).

In the coil-forming mechanism 20, the wire rod 1 is pushed into the section #Ø8 like an arc of a circle or the like selected by the selection mechanism 28′ so that the spiral coil 11 becomes formed. In the punching-and-paper-sheet-aligning unit 48, the punched holes 3a are perforated for each of the paper-sheets P, in each of which an image has been formed, released from the image-forming apparatus 200 and they are aligned to become the bundle of paper-sheets 3. In the binding mechanism 40, the coil-binding processing is performed on the bundle of paper-sheets 3 aligned in the punching-and-paper-sheet-aligning unit 48 by means of the spiral coil 11 formed by the coil-forming mechanism 20.

In this image-forming system 101, when the spiral coil 11 is formed from the wire rod 1 having a predetermined thickness and the coil-binding processing is performed on the bundle of paper-sheets 3 by the coil 11, a first part step of selecting the section #Ø8, #Ø11 or #Ø14 like an arc of a circle includes a step of detecting the thickness of the bundle of paper-sheets 3 before the binding processing.

Further, before the binding processing, there is provided with a step of selecting any one section #Ø8, #Ø11 or #Ø14 like an arc of a circle corresponding to the thickness of the bundle of paper-sheets 3 from the three species of the sections #Ø8, #Ø11 and #Ø14 each like an arc of a circle for setting a diameter of the coil; a step of pushing the wire rod 1 into the selected section #Ø8, #Ø11 or #Ø14 like an arc of a circle to form the spiral coil 11a, 11b or 11c; and a step of performing the binding processing on the bundle of paper-sheets 3 by the formed spiral coil 11a, 11b or 11c. Controlling the finisher 100′ thus from the image-forming apparatus 200 in the image-forming system 101 allows the diameter of the spiral coil 11 to be automatically selected and allows the automatic coil-binding processing to be performed on the bundle of paper-sheets 3 corresponding to the thickness of the bundle of paper-sheets (fist control method).

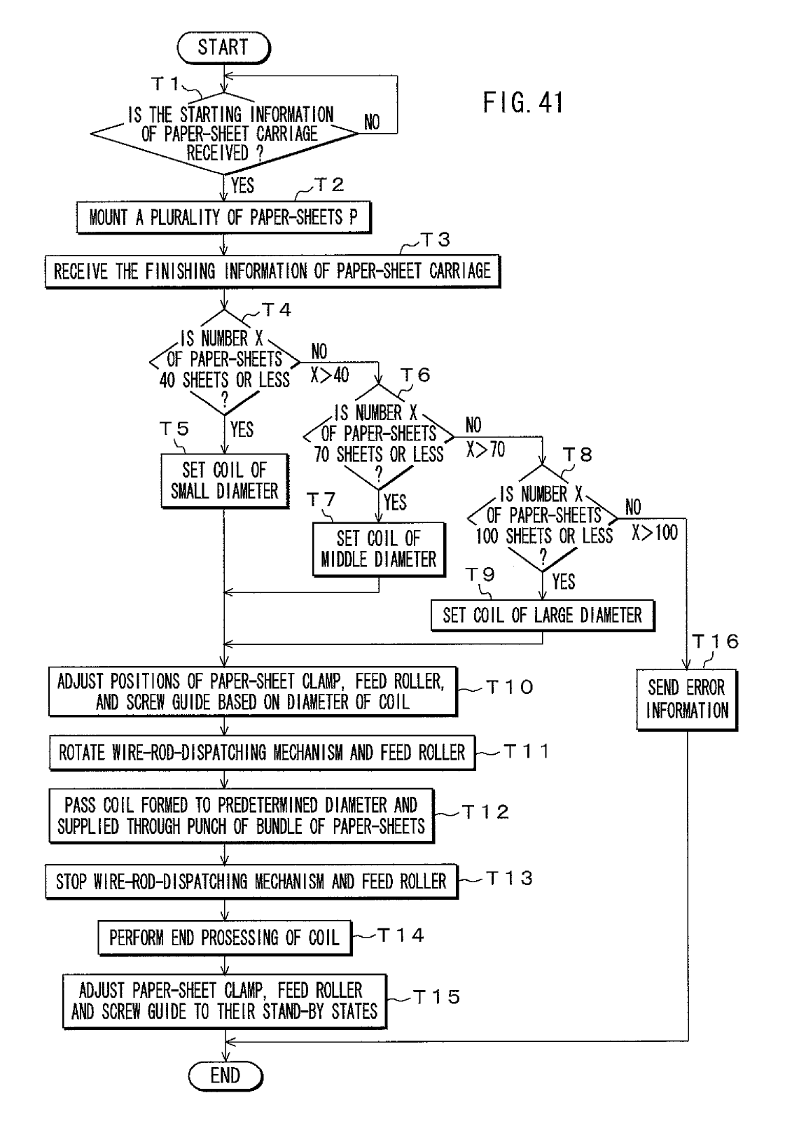

The following will describe an operation example of the paper-sheet-handling apparatus 100 in the image-forming system 101 with reference to FIG. 41. In this embodiment, power is applied to the control section 50 and the CPU 55 reads the control programs out of the memory section 54 to extract it to RAM 53. The CPU 55 controls the binding mechanism 40 to position the feed roller 31 shown in FIG. 20 to its home position HP (stand-by state). To the finisher 100′, the control section 210 of the image-forming apparatus 200 such as a printer, which is shown in FIG. 40, is connected. To the coil-forming mechanism 20, the wire rod cartridge 10 on which the wire rod 1 is wound is mounted.

Under a binding-processing condition of them, at a step T1 in a flowchart shown in FIG. 41, the CPU 55 of the finisher 100′ determines whether or not the starting information of the paper-sheet transfer to indicate a start of the binding processing is received from the image-forming apparatus 200. In this embodiment, the CPU 55 receives the control data D20 including the starting information of paper-sheet carriage through the input/output terminal 91 shown in FIG. 39. When receiving no control data D20, the CPU 55 again determines whether or not the control data D20 is received. When receiving the control data D20, the process shifts to a step T2.

At the step T2, the image-forming apparatus 200 forms an image on each of the predetermined paper-sheets P to transfer them to the finisher 100′. In the finisher 100′, it is configured that the punching-and-paper-sheet-aligning unit 48 perforates the punched holes 3a for each of the paper-sheets P and a plurality of the paper-sheets P is mounted on the paper-sheet-mounting base 46 in the binding mechanism 40 with them being aligned. For example, when the paper-sheets P supplied from the punching-and-paper-sheet-aligning unit 48 enter into the paper-sheet-mounting base 46, a multi-paddle like rotation member, not shown, is used to align the forward end and the side edge 3b of each of the paper-sheets P to the reference position. This rotation member forces each of the paper-sheets P to strike the forward end of each of the paper-sheets P each having the punched holes 3a to the paper-sheet-attaching pin 46d and to strike the side edge 3b of paper-sheet to the paper-sheet-aligning guide 41 so that the paper-sheets P can be aligned to the reference position, and then, the process shifts to a step T3.

At the step T3, the CPU 55 receives from the image-forming apparatus 200 the control data D20 including the finishing information of paper-sheet carriage, which indicates a finish of the paper-sheet carriage, and the information on the number of paper-sheets, which indicates a number of carried paper-sheets P, and the process shifts to a step T4. At the step T4, the CPU 55 determines whether the information on the number of paper-sheets of the control data D20 received at the step T3 indicates, for example, 40 sheets or less. At this moment, the CPU 55 compares the information on the number of paper-sheets received from the image-forming apparatus 200 with the reference value, 40, set in the control program stored on the memory section 54. After the comparison thereof, when it is determined that the information on the number of paper-sheets indicates the reference value, 40, or less, the process shifts to a step T5 where the setting of the position of the spiral coil 11a having the small diameter is performed.

At the step T5, the CPU 55 controls the selection mechanism 28′ to select the section #Ø8 like an arc of a circle for the small diameter and controls the motor-driving section 73 to bind the spiral coil 11a having the small diameter. At this moment, in the motor-driving section 71, any one section like an arc of a circle corresponding to the paper thickness is selected from the three sections #Ø8, #Ø11 and #Ø14 each like an arc of a circle in the forming adapter 28a of the coil-forming mechanism 20 based on the motor control data D71. For example, the motor-driving section 71 generates the motor control signal (voltage) S71 from the motor control data D71 and outputs the motor control signal S71 to the motor 701. The motor 701 rotates counter-clockwise based on the motor control signal S71 to rotate the forming adaptor 28a for setting the diameter of the coil and select the semi-circle cut-away section #Ø8 like an arc of a circle or the like (diameter-of-coil-selecting function).

Further, the CPU 55 also outputs the motor control data D73 for the small diameter to the motor-driving section 73. The motor-driving section 73 generates the motor control signal S73 for the small diameter of the coil based on the motor control data D73 received from the CPU 55 and outputs the motor control signal S73 to the motor 703 for the position adjustment and the process shifts to a step T10. At the step T10, the motor 703 adjusts the positions of the paper-sheet clamp 45, the feed roller 31 and the screw guide 49 based on the motor control signal S73 generated for the spiral coil 11a having the small diameter. In this embodiment, the motor 703 rotates a rotation shaft of the motor 703 by a predetermined amount thereof to rotate the guide-switching cams 34a, 34b (see FIG. 20) engaged with the rotation shaft. By the rotations of the guide-switching cams 34a, 34b, the positions of the feed roller 31, the screw guide 49 and the paper-sheet clamp 45, which are engaged with the guide-switching cams 34a, 34b, move from the home position HP shown in FIG. 20 to the set position of the spiral coil 11a having the small diameter shown in FIG. 21 (by the first distance d1).

For example, the feed roller 31 positioned at the uppermost of the vertical long opening 80b of the side surface plate 43b in the binding mechanism 40 moves from one end of the long cam opening 37b of the guide-switching cam 34b to the other end thereof to fall down so that it moves on a vertical direction from the uppermost of the vertical long opening 80b to the lowermost thereof. This enables the feed roller 31 to be set to a position where it comes into contact with the top surface of the spiral coil 11a having the small diameter.

By rotation of the guide-switching cam 34b, the screw guide 49 positioned at a right side of the horizontal long opening 82b with respect to the surface of the figure at the above-mentioned stand-by state shown in FIG. 20 moves from one end of the curved long cam opening 35b of the guide-switching cam 34b to the other end thereof to fall back (come close to the spiral coil 11a) so that it moves on a horizontal direction from the right side of the horizontal long opening 82b to the left side thereof (by the first distance d1′). This enables the screw guide 49 to be set to a position where it comes into contact with the front surface of the spiral coil 11a.

By the rotation of this guide-switching cam 34b, the paper-sheet clamp 45 positioned at the uppermost of the vertical long opening 38b at the above-mentioned stand-by state moves from the uppermost of the vertical long opening 38b to the lowermost thereof on an almost vertical direction because the linking rod 39 of the paper-sheet clamp 45 is fallen down by the outer circumferential cam surface 34d. This enables the paper-sheet clamp 45 to be set to a position where it clamps the bundle of paper-sheets 3 constituted of paper-sheets of 40 sheets or less. Next, the process shifts to a step T11.

At the step T11, the CPU 55 controls the wire-rod-dispatching mechanism 22 of the coil-forming mechanism 20 to rotate and controls the feed roller 31 of the binding mechanism 40 to rotate. For example, the motor-driving section 72 rotates the lower dispatching roller 23a and the upper dispatching roller 23b in the coil-forming mechanism 20 based on the motor control data D72.

In this embodiment, the motor-driving section 72 generates the motor control signal (voltage) S72 from the motor control data D72 and outputs the motor control signal S72 to the motor 702. The motor 702 rotates counter-clockwise to rotate the lower dispatching roller 23b clockwise through the lower large diameter gear 24b and to rotate the upper dispatching roller 23a counter-clockwise through the large diameter gear 24a (wire-rod-dispatching control).

Further, the CPU 55 outputs the motor control data D74 to the motor-driving section 74. The motor-driving section 74 generates the motor control signal S74 based on the motor control data D74 received from the CPU 55 and outputs the motor control signal S74 to the motor 704. The motor 704 rotates at a predetermined speed based on the motor control signal S74 output from the motor-driving section 74 to rotate the feed roller 31 through the pulley 36a, the driven pulleys 36b, 36c and the belt 36a, as shown in FIG. 1 and the process shifts to a step T12.

At this moment, the CPU 55 controls the binding speed of the spiral coil 11 by setting the rotation speed V1 of the spiral coil 11 dispatched from the coil-forming part 28 and the rotation speed V2 of the spiral coil 11 in the binding mechanism 40 to be V1≦V2. The rotation speed V1 is set in the motor-driving section 72 via the motor control data D72. The motor-driving section 72 controls the motor 702 in the coil-forming mechanism 20 to be the rotation speed V1 based on the motor control data D72. The rotation speed V2 is set in the motor-driving section 74 via the motor control data D74. The motor-driving section 74 controls the motor 704 in the binding mechanism 40 to be the rotation speed V2 based on the motor control data D74 (rotation speed control).

Next, at the step T12, the feed roller 31 and the screw guide 49 pass the spiral coil 11 formed to have a predetermined diameter and supplied from the coil-forming mechanism 20 through the punched holes 3a of the bundle of paper-sheets 3 with it being guided. For example, the feed roller 31 feeds the spiral coil 11a having the small diameter supplied from the coil-forming mechanism 20 to the punched holes 3a of the bundle of paper-sheets 3 mounted on the paper-sheet-mounting base 46 with it being rotated.

The fed spiral coil 11a passes through between the projections 49c of the guide projection portion 49b of the screw guide 49 shown in FIG. 19. At this moment, the spiral coil 11a is limited in its advanced direction by each projection 49c so that it passes through between the convex teeth 46b of the screw guide 46a (fixed side) of the paper-sheet-mounting base 46.

It is configured that the spiral coil 11a then passes through between the convex teeth 46b of the screw guide 46a and passes through the punched hole 3a. It is configured that after the passage trough the punched holes 3a, the spiral coil 11a is again limited in its advanced direction by the guide projection portion 49b so that it passes through between the convex teeth 46b of the screw guide 46a, and then passes through between the convex teeth 46b and passes the punched hole 3a. This enables the spiral coil 11a to pass through each of the punched holes 3a of the bundle of paper-sheets 3 securely.

In this embodiment, the forward-end-passage signal S63 is output from the passage detection sensor 63 to the I/O port 51. The forward-end-passage signal S63 is converted to the forward-end-passage data D63 in the I/O port 51. The forward-end-passage data D63 is output from the I/O port 51 to the CPU 55. The CPU 55 controls the motor-driving section 74 based on the forward-end-passage data D63 received from the I/O port 51 (coil-movement-slow-down control).

The CPU 55 detects the passage of the forward end of the coil after rotating the feed roller 31 and when the passage of the spiral coil 11a having the small diameter through the punched holes 3a of the bundle of paper-sheets 3 is complete, it outputs the motor control data D74 for stopping to the motor-driving section 74 and outputs the motor control data D73 for stand-by to the motor-driving section 73.

In this embodiment, the forward end detection signal S62 is output from the reach detection sensor 62 to the I/O port 51. The forward end detection signal S62 is converted to the forward end detection data D62 in the I/O port 51. The forward end detection data D62 is output from the I/O port 51 to the CPU 55. The CPU 55 controls the motor-driving section 72 based on the forward end detection data D62 received from the I/O port 51 (coil-movement-stop control).

Next, the process shifts to a step T13. At the step T13, the CPU 55 controls the motor-driving sections 72, 74 to stop the rotations of the wire-rod-dispatching mechanism 22 and the feed roller 31. For example, the CPU 55 outputs the motor control data D72 for stopping to the motor-driving section 72 and outputs the motor control data D74 for stopping to the motor-driving section 74, respectively.

The motor-driving section 72 generates the motor control signal S72 for stopping based on the motor control data D72 for stopping, which is received from the CPU 55, and outputs the motor control signal S72 to the motor 702. The motor-driving section 74 generates the motor control signal S74 for stopping based on the motor control data D74 for stopping, which is received from the CPU 55, and outputs the motor control signal S74 to the motor 704 for rotating the roller. These motors 702, 704 stop their rotations based on the motor control signals S72, S74 output from the motor-driving sections 72, 74. Thus, the rotations of the wire-rod-dispatching mechanism 22 and the feed roller 31 stop.

Next, the process shifts to a step T14 where an end processing of the spiral coil 11a is performed by the cutting-and-bending mechanism 75 in the screw guider 49 shown in FIG. 28A. For example, by rotating the lever 75f clockwise, the hitting-for-pinching portion 75a moves in close to the receiving-for-pinching portion 75b so that the hitting-for-pinching portion 75a and the receiving-for-pinching portion 75b hold the spiral coil 11a with it being pinched. At this moment, the spiral coil 11c is pinched between the cutter 75c and the cutter-receiving portion 75d.

Then, by further rotating the lever 75f clockwise while the spiral coil 11c is pinched by the hitting-for-pinching portion 75a and the receiving-for-pinching portion 75b, solely the cutter 75c rotates clockwise so that it cuts the spiral coil 11c pinched between the cutter 75c and the cutter-receiving portion 75d.

After the cutting, by additionally rotating the lever 75f clockwise, the cut end 11c′ of the spiral coil 11c pinched between the bending portion 75e and the receiving-for-pinching portion 75b is bent from the base thereof inward the spiral coil 11 by about 90 degrees. This enables the coil-binding booklet 90 to be realized. After such an end processing of the spiral coil 11a has been performed, the process shifts to a step T15. It is to be noted that the lever 75f is configured so as to operate by a cam, a motor, a solenoid and the like, which are not shown. Of course, when utilizing the manual mode, the lever 75f may operate by hand (see second embodiment).

Next, at the step T15, the CPU 55 controls the motor-driving section 73 to adjust the paper-sheet clamp 45, the feed roller 31 and the screw guide 49 to their stand-by positions. For example, the CPU 55 outputs the motor control data D73 for stand-by to the motor-driving section 73. The motor-driving section 73 generates the motor control signal S73 for stand-by based on the motor control data D73 and outputs the motor control signal S73 to the motor 703 for the position adjustment.

The motor 703 rotates the rotation shaft of the motor 703 by a predetermined amount thereof rightwards to rotate the guide-switching cams 34a, 34b engaged with the gear 33b of the rotation shaft leftwards. By the leftward rotations of the guide-switching cams 34a, 34b, the positions of the feed roller 31, the screw guide 49 and the paper-sheet clamp 45, which are engaged with the guide-switching cams 34a, 34b, return to their home positions HP (stand-by position) shown in FIG. 20 from the set position of the spiral coil 11a having the small diameter shown in FIG. 21 (the first distance d1) so that the processing to passing the spiral coil 11a through the bundle of paper-sheets 3 finishes.

Further, when it is determined that the information on the number of paper-sheets exceeds 40 and is not the reference value of 40 or less at the above-mentioned step T4, it is decide that the spiral coil 11a having the small diameter is not set and the process shifts to a step T6. At the step T6, the CPU 55 determines whether or not the information on the number of paper-sheets exceeds 40 sheets and is 70 sheets or less. For example, the CPU 55 compares the information on the number of paper-sheets with the reference value of 70 stored in the memory section 54. After the comparison thereof, when it is determined that the information on the number of paper-sheets is not more than the reference value of 70, the process shifts to a step T7 where the setting of the position of the spiral coil 11b having the middle diameter is performed.

Next, at the step T7, the CPU 55 controls the motor-driving section 73 to bind the spiral coil 11b having the middle diameter. In this embodiment, the CPU 55 outputs the motor control data D2 for the middle diameter to the motor-driving section 73. The motor-driving section 73 generates the motor control signal S73 for the middle diameter based on the motor control data D2 received from the CPU 55 and outputs the motor control signal S73 to the motor 703 for the position adjustment and the process shifts to a step T10. At the step T10, it adjusts the positions of the paper-sheet clamp 45, the feed roller 31 and the screw guide 49 based on the motor control signal S73 generated for the spiral coil 11 having the middle diameter.

In this embodiment, the motor 703 rotates the rotation shaft of the motor by a predetermined amount to rotate the guide-switching cams 34a, 34b (see FIG. 20) engaged with the rotation shaft. By the rotations of the guide-switching cams 34a, 34b, the positions of the feed roller 31, the screw guide 49 and the paper-sheet clamp 45, which are engaged with the guide-switching cams 34a, 34b, move from their home positions HP shown in FIG. 20 to the set position of the spiral coil 11b having the middle diameter shown in FIG. 22 (by the second distance d2). After the movement, the binding mechanism 40 receives the control of the CPU 55 so that the binding is performed by passing the spiral coil 11b through the punched holes 3a of the bundle of paper-sheets 3 via the above-mentioned steps T11 through T15.

Further, when it is determined that the bundle of paper-sheets 3 exceeds 40 sheets and the information on the number of paper-sheets is not the reference value of 70 or less at the above-mentioned step T6, it is decide that the spiral coils 11a, 11b having the small and middle diameters are not set and the process shifts to a step T8. At the step T8, the CPU 55 determines whether or not the information on the number of paper-sheets exceeds 70 sheets and is 100 sheets or less. For example, the CPU 55 compares the information on the number of paper-sheets with the reference value of 100 stored in the memory section 54. After the comparison thereof, when it is determined that the information on the number of paper-sheets is not more than the reference value of 100, the process shifts to a step T9 where the setting of the position of the spiral coil 11c having the large diameter is performed.

Next, at the step T9, the CPU 55 controls the motor-driving section 73 to bind the spiral coil 11c having the large diameter. In this embodiment, the CPU 55 outputs the motor control data D73 for the large diameter to the motor-driving section 73. The motor-driving section 73 generates the motor control signal S73 for the large diameter based on the motor control data D73 received from the CPU 55 and outputs the motor control signal S73 to the motor 703 for the position adjustment and the process shifts to a step T10. At the step T10, it adjusts the positions of the paper-sheet clamp 45, the feed roller 31 and the screw guide 49 based on the motor control signal S73 generated for the spiral coil 11c having the large diameter.

In this embodiment, the motor 703 rotates the rotation shaft of the motor 703 by a predetermined amount thereof to rotate the guide-switching cams 34a, 34b (see FIG. 20) engaged with the rotation shaft. By the rotations of the guide-switching cams 34a, 34b, the positions of the feed roller 31, the screw guide 49 and the paper-sheet clamp 45, which are engaged with the guide-switching cams 34a, 34b, move from their home positions HP shown in FIG. 20 to the set position of the spiral coil 11c having the large diameter shown in FIG. 23 (by the third distance d3). After the movement, the binding mechanism 40 receives the control of the CPU 55 so that the binding is performed by passing the spiral coil 11c through the punched holes 3a of the bundle of paper-sheets 3 via the above-mentioned steps T11 through T15. This enables the automatic binding processing on the bundle of paper-sheets 3 to be realized with the spiral coil 11c having the automatically selected diameter of the coil corresponding to the thickness of the bundle of paper-sheets 3.

It is to be noted that when it is determined that the information on the number of paper-sheets is not the reference value of 100 or less, namely, the information on the number of paper-sheets is the reference value of 101 or more, there is no spiral coil 11 having applicable diameter. In this case, the process shifts to a step T16 where the CPU 55 sends communication data D10 on error to the image-forming apparatus 200 via the input/output terminal 91 and the process is complete.

Thus, according to the image-forming system 101 as the first embodiment that is constituted using the paper-sheet-handling apparatus relating to the invention, the paper-sheet-handling apparatus 100 relating to the invention is provided so that it is possible to provide the image-forming system 101 which is provided with the finisher 100′ with coil diameter automatic selection function, which binds the paper-sheets P released from the image-forming apparatus 200 such as a copy machine and a printer and performs coil-binding processing by the spiral coil 11a or the like.

The finisher 100′ also receives from the image-forming apparatus 200 the control data D20 such as the size information of the paper-sheet, the number information of the carried paper-sheets, the starting information of the paper-sheet carriage, the carrying speed information of the paper-sheets and/or the finishing information of the paper-sheet carriage, binds the paper-sheets (recorded paper) P released from the image-forming apparatus 200 based on the control data D20 and forms the spiral coil 11 from the wire rod 1 having a predetermined thickness so that it is possible to perform the binding processing on the bundle of paper-sheets 3 by the coil 11. Accordingly, the image-forming system 101 including the coil-binding function, which is usable from the image-forming apparatus 200 to the finisher 100′ consistently by a general user, may be built.

Further, in the image-forming system 101, the communication data D10 is output from the finisher 100′ to the image-forming apparatus 200. The communication data D10 includes jam information, coil diameter information, cover-open information, detection information of wire rod cut waste and/or detection information of punched waste. Therefore, jam condition, a size of the diameter of the coil, cover-open condition, wire rod cut waste condition and/or punched waste condition in the finisher 100′ may be confirmed by visual inspection by the monitor 208 or the like of the image-forming apparatus 200. In the image-forming apparatus 200, the user may confirm the operation state of the finisher 100′.

### Embodiment 2

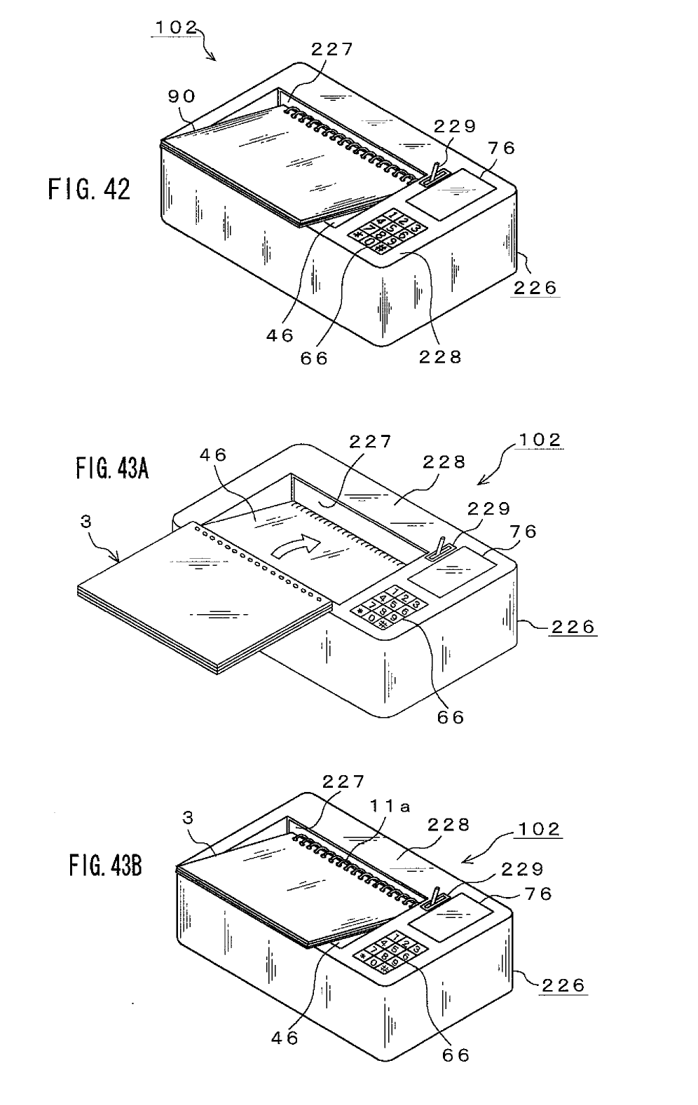

The following will describe a configuration example of a coil binder 102 as a second embodiment according to the invention with reference to FIG. 42. The coil binder 102 shown in FIG. 42 constitutes a function of fourth paper-sheet-handling apparatus and is such that the punching processing function and automatic cutting-and-bending function is omitted from the finisher 100′ shown in FIG. 40 and the manual mode is performed therein.

The coil binder 102 is the paper-sheet-handling apparatus that is applicable to the second image-forming system. In the second image-forming system, it is treated that the perforation is separately performed on paper-sheets P released from the image-forming apparatus 200 such as copy machine and a printer, which has been described in the first image-forming system 101, by a special or commercial puncher and the punched paper-sheets P are then bound and set on the coil binder 102.

The coil binder 102 has, for example, a plastic case 226. In the case 226, various kinds of functions such as the coil-forming mechanism 20, the binding mechanism 40 and the like, which have been described in FIGS. 1 through 39, are installed. A manipulation panel 228 is provided on a top surface of the case 226. On the manipulation panel 228, the paper-sheet-mounting base 46, the manipulation section 66, the monitor 76, a cutting handle 229 and the like are disposed. The paper-sheet-mounting base 46 is obliquely disposed so that it has a predetermined inclination angle as going toward an interior thereof with respect to the manipulation panel 228 and its terminal is configured so as to be a binding processing opening 227. In the binding processing opening 227, the feed roller 31 and the screw guide 49, which are not shown, are disposed.

The bundle of paper-sheets 3 binding the paper-sheets P, in each of which the punched holes 3a are perforated, are set on the paper-sheet-mounting base 46. The bundle of paper-sheets 3 is aligned so that a side thereof in which the punched holes 3a are perforated faces the binding processing opening 227. The manipulation section 66 is set so as to select any one section #Ø8, #Ø11 or #Ø14 like an arc of a circle corresponding to the thickness of the bundle of paper-sheets 3 from the three species of the sections #Ø8, #Ø11 and #Ø14 each like an arc of a circle for setting a diameter of the coil. For the manipulation section 66, a numeric keypad constituted of keys of “0” through “9”, “#” and “*”. Of course, it is not limited thereto: a selection button for selecting any one section #Ø8, #Ø11 or #Ø14 like an arc of a circle corresponding to the thickness of the bundle of paper-sheets 3 from the sections #Ø8, #Ø11 and #Ø14 each like an arc of a circle for setting a diameter of the coil may be provided.

The monitor 76 receives the paper-sheet detection data D61, the mounting-detection data D64 and the wire rod detection data D65 under the display control of the CPU 55 to perform any displays. For example, the monitor 76 displays that the bundle of paper-sheets 3 is not mounted on the binding mechanism 40 based on the paper-sheet detection data D61, displays that the wire rod cartridge 10 is not mounted based on the mounting-detection data D64 of L level, or displays existence or nonexistence of the wire rod 1 in the drum 12 based on the wire rod detection data D65.

The cutting handle 229 is provided, for example, on the manipulation panel 228 between an end of the binding processing opening 227 and the monitor 76 and a forward end thereof is engaged with the lever 75f of the cutting-and-bending mechanism 75 shown in FIG. 28. It is configured that the handle 229 is manipulated by the user after the spiral coil 11a or the like passes through the bundle of paper-sheets 3 and cuts a predetermined position of the spiral coil 11a. It is configured that when further pushing down the handle 229 to a predetermined direction, an end of the spiral coil 12a is bent (see FIGS. 30 through 33).

In this embodiment, in the control section 50 shown in FIG. 39, the first part step of selecting the section #Ø8, #Ø11 or #Ø14 like an arc of a circle includes a step of inputting an instruction of selecting any one section #Ø8, #Ø11 or #Ø14 like an arc of a circle corresponding to the thickness of the bundle of paper-sheets 3 from the plural species of the sections #Ø8, #Ø11 and #Ø14 each like an arc of a circle for setting a diameter of the coil. Controlling the coil binder 102 thus allows the diameter of the spiral coil 11 to be manually selected and allows the coil-binding processing to be realized on the bundle of paper-sheets 3 corresponding to the manual setting (second control method).

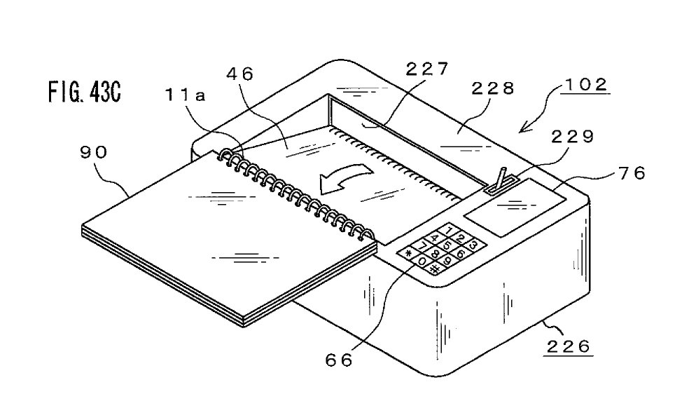

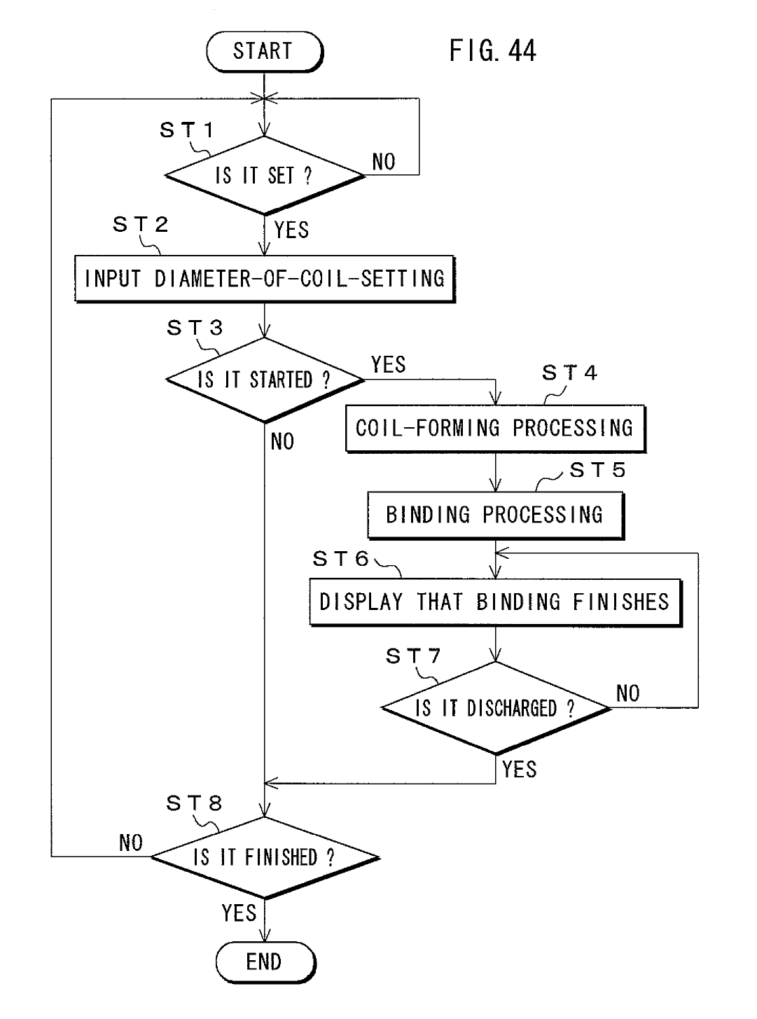

The following will describe a control method of the coil binder 102 with reference to FIGS. 43 and 44. In this embodiment, it is treated that the punched holes 3a are separately perforated on paper-sheets P by a special or commercial puncher and the punched paper-sheets P are then bundled and set on the coil binder 102 shown in FIG. 43A on the coil binder 102. It is assumption where the spiral coil 11 is then formed from the wire rod 1 having a predetermined thickness in the coil binder 102 shown in FIG. 43B and the binding processing is performed on the bundle of paper-sheets 3 by the spiral coil 11.

Under a binding-processing condition of them, at a step ST1 in a flowchart shown in FIG. 44, the control section 50 determines whether or not the bundle of paper-sheets 3 is set on the paper-sheet-mounting base 46. At this moment, the control section 50 compares the paper-sheet detection data D61 (the paper-sheet-existence-or-nonexistence signal S61) obtained from the paper-sheet sensor 61 shown in FIG. 39 with a threshold value for determining the signal level to detect whether or not the bundle of paper-sheets 3 is set. If the paper-sheet detection data D61 exceeds the threshold value, it is detected that the bundle of paper-sheets 3 is set.

Next at a step ST2, the control section 50 performs input processing of the diameter-of-coil-setting. At this moment, it is configured that the user manipulates the manipulation section 66 to select any one section #Ø8, #Ø11 or #Ø14 like an arc of a circle corresponding to the thickness of the bundle of paper-sheets 3 from the three species of the sections #Ø8, #Ø11 and #Ø14 each like an arc of a circle for setting a diameter of the coil. By this selection manipulation, the manipulation data D66 indicating the setting of the diameter of the coil is output from the manipulation section 66 to the CPU 55 through the I/O port 51.

Then, at a step ST3, the control section 50 waits for a start instruction. At this moment, the CPU 55 conducts any time limit input processing. The user manipulates the manipulation section 66 to input the start instruction (boot-up command). The manipulation section 66 outputs the control data D66 indicating the start to the CPU 55 through the I/O port 51.

Next, at a step ST4, the control section 50 conducts the coil-forming processing based on the control data D66. At this moment, in the coil-forming mechanism 20, the wire rod 1 is pushed down into the one section #Ø8 like an arc of a circle section or the like selected from the section #Ø8, #Ø11 or #Ø14 each like an arc of a circle by the manipulation section 66 so that the spiral coil 11a or the like is formed. The control section 50 conducts the wire-rod-dispatching control (see FIGS. 39 and 41).

Further, at a step ST5, the control section 50 conducts the binding processing. At this moment, in the binding mechanism 40, the binding processing is performed on the bundle of paper-sheets 3 by the spiral coil 11a formed by the coil-forming mechanism 20. The control section 50 conducts the rotation speed control, the coil-movement-slow-down control, the coil-movement-stop control and the like (see FIGS. 39 and 41). The bundle of paper-sheets 3 bound by the spiral coil 11a or the like becomes the booklet 90.

Then, at a step ST6, the control section 50 conducts the control to display that “the binding process finishes”. For example, the CPU 55 outputs the display data D76 to the monitor 76. The monitor 76 displays that “the binding process finishes” based on the display data D76. At the same time, a manipulation method of the handle 229 is displayed on the monitor 76. It is designed that the user manipulates the handle 229 with reference to the message or the like displayed on the monitor 76 to cut the predetermined position of the spiral coil 11a. It is designed that when the handle 229 is further pushed down to the predetermined direction, the end of the spiral coil 11a is bent (see FIGS. 30 through 33).

Next, at a step ST7, the control section 50 determines whether or not the booklet 90 is discharged from the paper-sheet-mounting base 46. At this moment, the control section 50 compares the paper-sheet detection data D61 (the paper-sheet-existence-or-nonexistence signal S61) obtained from the paper-sheet sensor 61 shown in FIG. 39 with a threshold value for determining the signal level to detect whether or not the bundle of paper-sheets 3 is discharged. If the paper-sheet detection data D61 is less than the threshold value, it is detected that the bundle of paper-sheets 3 has been discharged. The process then shifts to a step ST8.

It is to be noted that the start is not instructed at the step ST3 even if a period of set time has been elapsed, the process shifts to the step ST8 where the control section 50 determines whether or not the coil-binding processing finishes. For example, when detecting the power-off information, the coil-binding processing finishes. When detecting no power-off information, the process returns to the step ST1 where the above-mentioned processing is repeated following the processing of determining whether or not the bundle of paper-sheets 3 is set on the paper-sheet-mounting base 46.

Thus, in the coil binder 102 according to the second embodiment, there is provided the second paper-sheet-handling apparatus according to the invention and the second control method is applied thereto so that when forming the spiral coil 11a or the like from the wire rod 1 having the predetermined thickness and performing the binding processing on the bundle of paper-sheets 3 by the spiral coil 11a, it is possible to perform the binding processing on the bundle of paper-sheets 3 by the spiral coil 11a or the like having a diameter of the coil specified by the user corresponding to the thickness of the bundle of paper-sheets 3. Accordingly, it is possible to provide the coil-binding-processing system which is provided with the coil binder with coil diameter manual selection function, which bundles the paper-sheets P released from the image-forming apparatus 200 such as a copy machine and a printer and performs binding processing by the spiral coil 11a or the like. It is to be noted that although the above-mentioned cutting-and-bending mechanism 75 has been illustrated to have a configuration such that the cutting and bending of the spiral coil 11 are conducted in the same apparatus, it may have a configuration such that a mechanism for the cutting and a mechanism for the bending are separately provided as the independent mechanisms and may conduct them by different steps.

### INDUSTRIAL APPLICABILITY

The present invention is very preferably applied to a coil-binding apparatus, a finisher or the like, which forms the spiral coil from the wire rod having a predetermined thickness, makes a row of holes previously in each of the paper-sheets released from a copy machine, a printer or the like, and performs the binding processing on the bundle of paper-sheets bundling the paper-sheets by the spiral coil into the holes thereof.

1-26. (canceled)

27. A paper-sheet-handling apparatus that forms a spiral coil from a wire rod having a predetermined thickness and performs a binding processing on a bundle of paper-sheets by passing the spiral coil through the plural holes perforated on the bundle of paper-sheets, the apparatus comprising:
a coil-forming mechanism that forms the spiral coil for binding the bundle of paper-sheets from the wire rod drawn out of a wire-rod-supplying part; and
a binding mechanism that performs the binding processing on the bundle of paper-sheets by the spiral coil obtained from the coil-forming mechanism,
wherein the coil-forming mechanism contains:
a main body part that includes a wire rod insert port and a coil discharge port;
a wire-rod-dispatching part that dispatches the wire rod to a predetermined direction, the wire-rod-dispatching part being attached to the main body part;
a coil-forming part that includes plural species of the sections each like an arc of a circle for setting a diameter of the coil, is rotatably attached with respect to the main body part, is driven so as to select one section like an arc of a circle from the plural species of the sections each like an arc of a circle and forms the wire rod dispatched from the wire-rod-dispatching part into the spiral coil along the selected section like the arc of the circle; and
a pitch-adjusting mechanism that adjusts a pitch of the spiral coil formed by the selected section like the arc of the circle and discharged from the coil-discharging port, the pitch-adjusting mechanism being mounted near the coil discharge port of the main body part,
wherein in the coil-forming mechanism, the wire-rod-dispatching part dispatches the wire rod having the predetermined thickness from the wire rod insert port of the main body part to the selected section like the arc of the circle so that the wire rod comes into contact with the selected section like the arc of the circle; and
the pitch-adjusting mechanism adjusts a pitch of the spiral coil dispatched by the wire-rod-dispatching part, the pitch-adjusting mechanism being mounted near the coil discharge port of the main body part; and
wherein in the binding mechanism, the spiral coil adjusted in its pitch is received from the coil-forming mechanism to bind the bundle of paper-sheets.

28. The paper-sheet-handling apparatus according to claim 27, wherein the apparatus is provided with a cutting part that cuts, at a predetermined position, the spiral coil for the bundle of paper-sheets on which the binding mechanism performs the binding processing, the spiral coil being dispatched from the coil-forming mechanism.

29. The paper-sheet-handling apparatus according to claim 27, wherein the apparatus is provided with a linking part between the coil-forming mechanism and the binding mechanism, and
wherein the linking part limits lateral and vertical movements of the spiral coil having a predetermined diameter of the coil dispatched from the coil-forming mechanism corresponding to a configuration of the spiral coil to guide the spiral coil to the binding mechanism.

30. The paper-sheet-handling apparatus according to claim 28, wherein the cutting part is attached to a predetermined position in the binding mechanism; and
the cutting part has a cutting-and-bending function that bends an end of the spiral coil cut at the predetermined position.

31. The paper-sheet-handling apparatus according to claim 27, wherein the apparatus is provided with:
a driving part that rotates the spiral coil in the binding mechanism; and
a control part that controls the driving part,
wherein if a rotation speed of the spiral coil dispatched from the coil-forming mechanism is V1 and a rotation speed of the spiral coil in the binding mechanism is V2, the control part controls a binding speed of the spiral coil by setting the rotation speeds V1 and V2 thereof so as to be V1·V2.

32. The paper-sheet-handling apparatus according to claim 31, wherein the binding mechanism is provided with a first detection part that detects reaching a forward end of the spiral coil; and
the control part controls the driving part based on a forward end detection signal obtained from the first detection part.

33. The paper-sheet-handling apparatus according to claim 31, wherein the binding mechanism is provided with a second detection part that detects passing through a forward end of the spiral coil, at a side nearer at a side where the coil-forming mechanism is positioned than a side where the first detection part is positioned; and
the control part controls the driving part based on a passage detection signal obtained from the second detection part.

34. The paper-sheet-handling apparatus according to claim 27, wherein the apparatus is provided with:
a detection part that detects the bundle of paper-sheets and outputs information on the paper-sheets; and
a selection mechanism that selects one section like an arc of a circle corresponding to the thickness of the bundle of paper-sheets from the plural species of the sections each like an arc of a circle for setting a diameter of the coil, based on the information on the paper-sheets output from the detection part,
wherein the coil-forming mechanism pushes the wire rod into
the section like an arc of a circle selected by the selection mechanism to form the spiral coil.

35. The paper-sheet-handling apparatus according to claim 27, wherein the apparatus is provided with a manipulation mechanism that is manipulated so as to select one section like an arc of a circle corresponding to the thickness of the bundle of paper-sheets from the plural species of the sections each like an arc of a circle for setting a diameter of the coil; and
wherein the coil-forming mechanism pushes the wire rod into the section like an arc of a circle selected by the manipulation mechanism to form the spiral coil.

36. The paper-sheet-handling apparatus according to claim 27, wherein the apparatus is provided with:
a driving part that rotates the spiral coil in the binding mechanism; and
a control part that controls the driving part; and
wherein the control part carries out:
a step of selecting one section like an arc of a circle corresponding to the thickness of the bundle of paper-sheets from the plural species of the sections each like an arc of a circle for setting a diameter of the coil;
a step of pushing the wire rod into the selected section like an arc of a circle to form the spiral coil; and
a step of performing the binding processing on the bundle of paper-sheets by the spiral coil.

37. The paper-sheet-handling apparatus according to claim 36, wherein the step of selecting the section like an arc of a circle includes a sub-step of detecting the thickness of the bundle of paper-sheets before the binding processing or a sub-step of inputting an instruction for selecting one section like an arc of a circle corresponding to the thickness of the bundle of paper-sheets from the plural species of the sections each like an arc of a circle for setting a diameter of the coil.

38. The paper-sheet-handling apparatus according to claim 27, wherein the apparatus is provided with an image-forming device that forms an image on each predetermined paper-sheet and releases the paper-sheets on which the image is formed, in order to obtain the bundle of paper-sheets; and
wherein an image-forming system is configured to perforate a plurality of holes on each of the paper-sheets released from the image-forming device and to bundle the paper-sheets to form the bundle of paper-sheets, to select one section like an arc of a circle corresponding to the thickness of the bundle of paper-sheets from the plural species of the sections each like an arc of a circle for setting a diameter of the coil based on the information on the paper-sheets obtained by detecting the bundle of paper-sheets, to push the wire rod having a predetermined thickness into the selected section like an arc of a circle to form the spiral coil, and to perform the binding processing on the bundle of paper-sheets, on each of which plural holes are perforated, by the coil.

39. The paper-sheet-handling apparatus according to claim 27, wherein the apparatus is provided with an image-forming device that forms an image on each predetermined paper-sheet and releases the paper-sheets on which the image is formed, in order to obtain the bundle of paper-sheets; and
wherein an image-forming system is configured to perforate a plurality of holes on each of the paper-sheets released from the image-forming device and to bundle the paper-sheets to form the bundle of paper-sheets, to select one section like an arc of a circle corresponding to the thickness of the bundle of paper-sheets from the plural species of the sections each like an arc of a circle for setting a diameter of the coil, to push the wire rod having a predetermined thickness into the selected section like an arc of a circle to form the spiral coil, and to perform the binding processing on the bundle of paper-sheets, on each of which plural holes are perforated, by the coil.

40. A coil-forming device comprising:
a main body part that includes a wire rod inserts port and a coil discharge port;
a wire-rod-dispatching part that dispatches the wire rod to a predetermined direction, the wire-rod-dispatching part being attached to the main body part;
a coil-forming part that includes plural sections each like an arc of a circle for setting a diameter of the coil and a selection mechanism that is set so as to select one section like an arc of a circle from the plural sections each like an arc of a circle and forms the wire rod dispatched from the wire-rod-dispatching part into the spiral coil along the selected section like the arc of the circle; and
a pitch-adjusting mechanism that adjusts a pitch of the spiral coil formed by the selected section like the arc of the circle and discharged from the coil-discharging port, the pitch-adjusting mechanism being mounted near the coil discharge port of the main body part,
wherein the wire-rod-dispatching part dispatches the wire rod having the predetermined thickness from the wire rod insert port with the wire rod coming into contact with the selected section like the arc of the circle.

41. The coil-forming device according to claim 40, wherein the device includes a pitch adjustment and correction section that corrects the pitch of the spiral coil adjusted by the pitch-adjusting mechanism corresponding to tensile strength of the wire rod having the predetermined thickness.

42. The coil-forming device according to claim 40, wherein the pitch-adjusting mechanism is provided with plural species of dispatching guide parts each for adjusting the pitch corresponding to the diameters of the coils.
